(19) United States
(12) Patent Application Publication
(10) Pub. No.: US 2021/0357927 A1
(43) Pub. Date: Nov. 18, 2021

(54) TRANSACTION AUTHENTICATION SYSTEM AND RELATED METHODS

(71) Applicant: BlockRules Ltd, Fremont, CA (US)

(72) Inventors: David Ben Kita, Fremont, CA (US); David Charles Williams, Fremont, CA (US); Dhruva Deepak Kulkarni, Fremont, CA (US); Mateusz Wojciech Pospieszny, Fremont, CA (US); Pramod Madabhushi, Fremont, CA (US)

(21) Appl. No.: 17/276,807

(22) PCT Filed: Sep. 17, 2019
(86) PCT No.: PCT/US19/51594

§ 371 Date: Mar. 16, 2021

Related U.S. Application Data
(60) Provisional application No. 62/732,491, filed on Sep. 17, 2018.
(60) Provisional application No. 62/783,093, filed on Dec. 20, 2018.

(51) Int. Cl. G06Q 20/38; G06Q 20/40; H04L 9/32

(52) U.S. Cl. CPC G06Q 20/3825; G06Q 20/38215; H04L 2209/38; H04L 9/3213; H04L 2209/56; G06Q 20/405

(57) ABSTRACT

Methods and systems are provided authenticating transactions on a token contract. A transaction rule compliance engine that utilizes stored user information to ensure that transactions of tokens associated with the token contract comply with defined ruleset. A curation system maintains the stored user information on the token contract or elsewhere on the blockchain system.

### CROSS-REFERENCES TO PRIORITY AND RELATED APPLICATIONS

This application claims the benefit of, and is a non-provisional of, U.S. Provisional Patent Application No. 62/723,491, filed Sep. 17, 2018, entitled “Transaction Authentication System and Related Methods” and U.S. Provisional Patent Application No. 62/783,093, filed Dec. 20, 2018, entitled “Transaction Authentication System and Related Methods”, the disclosures of which are herein incorporated by reference in their entirety.

### FIELD OF THE INVENTION

The present disclosure generally relates to computing systems. The disclosure relates more particularly to apparatus and techniques for authentication systems interacting with blockchain networks to effect control over blockchain transactions that might be executed by a blockchain network or stored on a blockchain ledger.

### BACKGROUND

A distributed ledger is a ledger implemented on a network of computers, which may be geographically distributed, wherein each member computer supports one or more computational node each of which may execute one or more computational process and communicates with computational nodes on other member computers of the network using cryptographic controls in order to support and manage a distributed ledger. A node could be understood to be implemented as a computational node. The distributed ledger may contain records of processed blockchain transactions and be distributed in such a manner that copies of all or part of the ledger can exist at various nodes in the computer network.

The blockchain transactions might be grouped sequentially into collections called blocks. For ease of computationally verifying that a given copy of the distributed ledger is authentic, the distributed ledger might be stored as a blockchain, wherein validation of one block of the blockchain (within a statistically probable certainty) can occur only if all of the earlier blocks are valid and are unaltered from their original form existing at the time those blocks were added to the blockchain. In this blockchain scheme, users may use one or more nodes to post blockchain transactions containing references to transfers of value or information and once those blockchain transactions are grouped into a block and that block is accepted onto the blockchain, the blockchain transactions would become permanently recorded in that nodes would not accept altered blocks to replace the original blocks that were previously added to the blockchain.

The programming of the nodes may be such that one node would not accept a blockchain transaction or block from another node if that blockchain transaction or block appeared to be altered from the original. Alteration could be detected if each blockchain transaction and/or block were secured using a cryptographic protocol that would make it statistically impossible for a party to make an alteration and still have the blockchain transaction and/or block validate when it is cryptographically checked.

A blockchain can be represented in computer memory as a cryptographically-linked, ordered list of blocks and need not be bounded. Each block might contain blockchain transaction data about one or more blockchain transactions, a cryptographic hash of a previous block, and other metadata, such as a blockchain transaction timestamp. Generally, a blockchain uses a cryptographic hash that is both deterministic, in that for any given block or set of blocks, there is one valid hash value that can be easily verified, and irreversible, in that it is not possible to fabricate an original block that matches a specific hash value without expending an impractical amount of computational resources.

Since the hash serves as a fingerprint of sorts for a block, and since any alteration of the block would result in a different hash, if the hash of a block is included in the data that is hashed in a later block, a node can easily check whether any of the blocks in a blockchain have been altered. As a result, a blockchain is resistant to data modification since the precise contents in any block can be verified at any time against the cryptographic hash contained in the subsequent block, such that a block cannot be retroactively changed without altering all subsequent blocks.

A distributed blockchain can be implemented on multiple nodes, wherein a node might be an instance of blockchain processing code executed on a computer and able to communicate with other nodes. The nodes may be geographically separated. In a typical implementation, each instance maintains a copy of the blockchain. Instances might communicate through a peer-to-peer network in order to maintain the integrity of the blockchain and obtain updates, such as new blockchain transactions or new blocks. In some cases, a consensus scheme might be used in advance to decide which version of the blockchain is authoritative in case of any discrepancy. Such consensus schemes are typically designed to favor the longest or most popular version of the blockchain. After validation, each node might operate under the assumption that its copy of the blockchain is the authoritative version without having to constantly run verification. In this manner, operations applied to one instance would be considered authoritative if queried by any other instance as long as that operation is encoded on a validated copy of the blockchain. A public distributed blockchain (PDB) is a distributed blockchain supported collaboratively by the general public, in that almost any interested party can install and operate a node on their own computing equipment and configure their node to communicate with other nodes on the blockchain network. Since an interested party can join such a public distributed blockchain network at will, such a blockchain is considered publicly available and publicly accessible. Although a central authority might be needed to establish a set of rules under which the PDB is modified and maintained (and perhaps provide the computer code needed for implementation), once launched, control of the PDB can be passed to a (presumably large) community of public users who set up nodes and follow the established rules. A properly implemented PDB that enjoys sizable and worldwide participation is practically impervious, as a whole, to unauthorized manipulation by any one party.

Before a node adds a block to the blockchain, the node should verify the blockchain transactions that are grouped into that block. In some distributed blockchain systems, the process of creating a block might include a requirement that the node perform some nontrivial computational process so that it is difficult for a node to freely generate possibly bogus blocks to add to the blockchain. The nontrivial computational process might involve a cryptographic or mathematical problem that is difficult to solve but where it is relatively easy to verify that a proffered solution is indeed a correct solution. As part of block generation, besides solving associated cryptographic or mathematical problems, the node should process all blockchain transactions that are to be grouped into the block to ensure that each blockchain transaction is valid.

In the more general case, a blockchain virtual machine (BVM) can be considered a computing environment that is encoded as blockchain transaction data on a distributed blockchain. The environment might be implemented by node hardware that is programmed to instantiate the BVM and execute instructions that the BVM comprises. The BVM might be referred to by the data that represents or defines the BVM aside from any hardware that might instantiate it. A BVM may be considered a Turing-complete state machine, including a plurality of smart contracts, each of which may comprise one or more set of computer instructions and/or preserved data that is stored on the blockchain and accessible to the smart contract in that a node executing the BVM can access the preserved data as state variables when executing a smart contract of the BVM. A smart contract acts as a contract among parties in that the data of the smart contract provides constraints that are observed by nodes processing the smart contract, wherein those constraints in effect may represent terms of contractual arrangements between parties to transactions involving that smart contract.

A BVM can use the creation of validated blocks as a method for maintaining a self-consistent, singular global state of the BVM across all nodes running the BVM. Because a BVM is implemented as part of a blockchain system, the execution of each computer instruction can be cryptographically verified. In addition, since a BVM is stored on, and executed from, a distributed blockchain, instruction execution is secure, transparent, and decentralized. Unlike a traditional distributed blockchain, which may need to be rewritten and redeployed for each new application, a single BVM can support a number of independent applications that can be deployed at any date after the BVM is initiated and that are executable using the BVM. Each such application is written in computer code such that it can be introduced and executed on the computing environment provided by the BVM. It is often useful to consider the BVM as a general-purpose computing platform that is decentralized, transparent, and verifiable, but it should be understood that it is often implemented on computing nodes in a distributed computing system performing computations that perform the operations of the BVM.

In order to perform its functions, each application of a BVM can respond to messages that originate outside the BVM, for example from a node that is passing on input obtained from a human user, either representing themselves or an organization, or from another computer executing preassigned instructions, such as a conventional computer service. Each message might be encoded with an address that corresponds to a unique identity of the source of the message. Some messages are cryptographically signed to ensure that the address cannot be forged. This is generally achieved by utilizing a cryptographic method such that a message can be readily and correctly signed by someone with knowledge of a secret key, password or passphrase(s), such that the message signature is easily verified by others, and such that the message cannot be correctly signed by someone without providing the secret key, password or passphrase(s). Thus, an application implemented on a BVM can use the address of the signed messages it receives to verify the identity of its users. In some BVMs, messages that cause, or could potentially cause, the state of the BVM to change must be incorporated into the blockchain ledger in order for the state and the blockchain ledger to remain consistent. Such messages may be considered to be blockchain transactions, even though the message is not necessarily associated with the transfer of any value, such as when it is not a financial transaction in a conventional sense.

As mentioned above, smart contracts, which are each identified by a unique address on the BVM, can be implemented by, and represented by, ordered sets of machine-readable instructions associated with data stored on the blockchain and accessible to the smart contracts. These smart contracts, whether enacted on their own, or working together with one another, can be used to perform one or more operations on the blockchain, including the enforcement of certain provisions as stipulated by a set of rules, including, for example, the terms of a non-digital contract. As such smart contracts can in principle be used to effectively control the ownership or transfer between parties of digital currencies or assets, including securities issued by an issuing party. In other blockchain environments, the smart contract may be embedded in the virtual machine environment through special blockchain transactions. After embedding the smart contract in the virtual machine environment, nodes operating as part of the blockchain network can evaluate blockchain transactions which reference the smart contract or directly invoke a portion of the smart contract in the form of one or more code functions calls. The smart contract processing might take in digital information as input, digitally process the information according to the rules of the smart contract, and digitally execute any actions as required by the terms and conditions of the smart contract.

Smart contracts can be implemented on a BVM of a blockchain system and can be executed at a node of a BVM as a collection of executable code and stored data in order to digitally enforce the provisions of an associated set of rules, including, for example, terms of a non-digital contract, provided the necessary digital information is available to the system executing the instructions of the smart contract. As an example, smart contracts can be used to determine whether an asset should go to a person (receiver) or should be returned to the person from whom the asset originated (sender).

Messages may be, in effect, sent by one smart contract to another. A message is associated with an address of a smart contract that initiated the message. An effect of sending a message from one smart contract to another smart contract is that the state data of the “receiving” smart contract could be changed, by a processor, to reflect the effects of the sent message, so that when the receiving smart contract is executed, it is executed with knowledge of, and in response to, the effects of the sent message. In this fashion, users or processes outside the BVM may send blockchain transactions to an intermediate smart contract that then performs further blockchain transactions on their behalf by sending additional messages. When the intermediate contract is under the exclusive control of one party, blockchain transactions that originate at the address of the intermediate contact are identified with the party that controls it.

The financial laws and regulations applicable to the ownership and transfer of securities can vary depending on jurisdiction and are generally subject to regulation by regional and national financial regulatory bodies, such as the Securities Exchange Commission of the United States and the Financial Conduct Authority of the United Kingdom. How these laws and regulations apply generally depends on how the individuals or organizations involved are characterized. For the purposes of enforcing these laws and regulations according to a defined ruleset, individuals or organizations are characterized using a finite set of relevant attributes. Examples of relevant attributes for an individual may include the country of residency, the country of citizenship, the possession of certain individual certifications or licenses, and if the individual is deemed to have sufficient financial sophistication to be excluded from certain investor protections (the latter sometimes referred to as “accredited” or “qualified”). Relevant attributes for an organization may follow a similar pattern. Examples of relevant attributes for an organization may include the country of incorporation, the country of operations, and the possession of certain business certifications or licenses. The exact set of attributes needed to characterize individuals or organizations in order to authenticate potential transactions with respect to applicable financial laws and regulations for a particular security can depend on the regulatory jurisdictions involved, the parties, and which financial laws and regulations apply to the particular security in question.

There is a need for a system that enforces legal or contractual restrictions associated with securities transactions in a computationally efficient manner.

### SUMMARY

Embodiments may encompass security or other transaction authentication systems for use with a distributed computing system that performs computational processes to validate financial transactions involving the ownership or transfer of a security. A transaction authentication system might include a transaction rule compliance engine comprising computer instructions, implemented on the distributed computing system with a distributed ledger, that interacts with one or more smart contracts, for authenticating one or more requested token transactions, wherein a requested token transaction is a financial transaction between one or more sender holder addresses and a one or more receiver holder addresses, wherein authentication of requested token transactions is determined on the distributed computing system in accordance with a defined ruleset, wherein the defined ruleset includes at least one rule governing token ownership and allowed token transactions, wherein the senders and the receivers are referred to as “Parties” or “Participants,” and wherein each party of the transaction has an associated address.

A transaction authentication system might also include a curation system, comprising one or more curation computing systems, that is configured to receive attributes derived from the registration information of registered users, identify these registered users with their corresponding holder addresses, generate transaction authentication data for each registered user, and write this transaction authentication data to the distributed ledger as part of one or more blockchain transactions. The computer instructions of the transaction rule compliance engine might include transaction authentication logic that operates on the transaction authentication data associated with each participating registered user of a requested transaction, via the transaction authentication logic, in order to validate or authenticate, according to a defined ruleset, the ownership or transfer of a token based on holder addresses of each transaction participant, wherein the transaction rule compliance engine is contained in one or more smart contracts and the transaction authentication data is accessible to these one or more smart contracts.

The transaction authentication data might comprise at least one transaction eligibility criterion for each registered user. The transaction authentication data might comprise at least one attribute bitmask for each registered user, wherein the attribute bitmask includes a sequence of at least one attribute bits representing, for a registered user, information for a collection of categories associated with the registered user, wherein each category is based on one or more common binary attributes of registered users that represent a subset of, or derived from, registration information and according to a defined ruleset. In one embodiment, a membership attribute bitmask includes a sequence of at least one attribute bits representing membership of a registered user in, or assignment of the registered user to, an element of a collection of categories based on the registered user's binary attributes. In another embodiment, a permissive (restrictive) attribute bitmask includes a sequence of at least one attribute bits representing, for a registered user, the collection of categories with which the registered user is permitted (not permitted) to transact, according to a defined ruleset.

The transaction rule compliance engine might be configured to authenticate a given transaction by performing at least one bitwise Boolean operation between at least one attribute bitmask of a first registered user and at least one attribute bitmask of a second registered user. In one embodiment, an attribute bitmask of a first registered user might be a membership attribute bitmask and an attribute bitmask of a second registered user might be a permissive (or restrictive) attribute bitmask, or vice-versa.

In some embodiments, the bitwise Boolean operation is a bitwise AND operation. In some embodiments, the transaction rule compliance engine is configured to authenticate a given transaction by performing at least one bitwise Boolean operation between at least one attribute bitmask of a first registered user and at least two attribute bitmasks of a second registered user. In one embodiment, an attribute bitmask of a first registered user might be a membership attribute bitmask and one of the two attribute bitmasks of a second registered user might be a permissive attribute bitmask and the other a restrictive attribute bitmask.

In some embodiments, the transaction rule compliance engine is configured to authenticate a given transaction by performing at least one bitwise Boolean AND operation between a first attribute bitmask of the first registered user and a first attribute bitmask for the second registered user to generate a first results bitmask, performing at least one bitwise Boolean AND operation between the first attribute bitmask of the first registered user and a second attribute bitmask of the second registered user to generate a second results bitmask, and finally performing at least one bitwise Boolean operation between the first results bitmask and the second results bitmask, wherein the first attribute bitmask of the first registered user is a membership attribute bitmask, the first attribute bitmask of the second registered user is a permissive attribute bitmask, and wherein the second attribute bitmask of the second registered user is a restrictive attribute bitmask.

In some embodiments, wherein the transaction authentication data comprises at least one transaction eligibility criterion for each registered user, the transaction rule compliance engine is configured to authenticate a given transaction by performing at least one bitwise Boolean operation between at least one attribute bitmask of a first registered user and at least one attribute bitmask of a second registered user to generate a first result intermediate, performing at least one Boolean operation on at least one transaction eligibility criterion of at least on registered user to generate a second result intermediate, and performing at least one Boolean operation on the first result intermediate and the second result intermediate. In one embodiment, an attribute bitmask of a first registered user might be a membership attribute bitmask and an attribute bitmask of a second registered user might be a permissive (or restrictive) attribute bitmask, or vice-versa.

The transaction rule compliance engine might be configured to authenticate a given transaction by performing at least one bitwise Boolean operation between at least one attribute bitmask of a first registered user and at least one attribute bitmask of a second registered user to generate at least one result intermediate, wherein the at least one result intermediate comprises a results bitmask organized into predefined intervals of sequences of attribute bits, and wherein the transaction rule compliance engine generates a digital result by further performing at least one bitwise Boolean operation on each sequence of attribute bits within each predefined interval of the results bitmask to generate at least one interval result for each interval, and then performing at least one logical operation on at least one interval result.

The curation system might update transaction authentication data by generating new transaction authentication data and submitting a new curation data transaction to the distributed ledger, in response to a change in registration information or status of one or more registered users, in response to one or more registered user requests, in response to a request by the issuer of the security token, in response to changes to the defined ruleset, and/or other triggers, such as an external event or a certain condition being met.

A method of authenticating token transactions might be used with a distributed computing system that performs computational processes to validate one or more token transactions at a plurality of nodes of the distributed computing system. The method might comprise validating a set of addresses for one or more potential senders of a token transaction, validating a set of addresses for one or more potential receivers of a token transaction, generating transaction authentication data for validated addresses of a subset of (or all) registered users in accordance with a defined ruleset, wherein the defined ruleset governs token ownership and allowed token transactions, storing the transaction authentication data via a curation data transaction on a distributed ledger of the distributed computing system, and then operating on the transaction authentication data for each participant in a transaction, wherein the transaction authentication data is stored on the distributed ledger, with program code for transaction authentication logic as part of the transaction rule compliance engine, which might be embedded in one or more smart contracts stored on the distributed computing system, to authenticate requested token transactions.

Based on a result of the transaction authentication logic operating on the transaction authentication data associated with each participant of a requested transaction and stored on the distributed ledger, the transaction rule compliance engine might be configured to reject the requested transaction or allow the requested transaction. Based on a rejection or allowance of the requested transaction, the transaction rule compliance engine might be also configured to record the rejection or allowance on the distributed ledger.

In general, executable logic and data in a BVM for one type of operation can be stored in multiple smart contracts that refer to each other. For authenticating transactions, in some embodiments, the transaction authentication data and transaction authentication logic may be accessed by or executed on one or more smart contracts separate from the token contract (sometimes referred to as a compliance contracts), and applied by reference by the token contract to authenticate token transactions. In other embodiments, the transaction authentication data may be accessed by or stored in one smart contract and the transaction authentication logic executed on another smart contract, and both are applied by reference by the token contract to authenticate token transactions. In some embodiments, the transaction authentication data and/or transaction authentication logic, represented in one or more contracts, may be used, in whole or in part, for more than one token contract, conditioned on compatibility with the defined rulesets of the corresponding tokens.

The transaction authentication data for a registered user might comprise at least one transaction eligibility criterion for each registered user. In one embodiment, the transaction authentication data for a registered user might comprise at least one membership attribute bitmask for the registered user, wherein the membership attribute bitmask comprises a sequence of at least one bitmap integer, each comprising at least one binary attribute bit, representing, for a registered user, membership in or assignment to an element of a set of categories based on one or more binary attributes of the registered user derived from registration information and according to a defined ruleset. In another embodiment, the transaction authentication data for a registered user might comprise at least one permissive (or restrictive) attribute bitmask for the registered user, wherein the permissive (or restrictive) attribute bitmask comprises a sequence of at least one bitmap integer, each comprising at least one binary attribute bit, characterizing or indicating, for a registered user, with which categories according to a defined ruleset a registered user is permitted or allowed (or forbidden or not allowed) to transact. In another embodiment, the transaction authentication data for a registered user might include both a membership attribute bitmask and a permissive (or restrictive) attribute bitmask. In another embodiment, the transaction authentication data for a registered user might include a membership attribute bitmask, a permissive attribute bitmask, and a restrictive attribute bitmask.

In a related embodiment, the transaction rule compliance engine can authenticate a transaction between a validated holder address of a sender and a validated holder address of a receiver by applying transaction authentication logic in the form a sequence of one or more bitwise AND, OR, NOT, and/or XOR operations applied to each constituent bitmap integer of a membership attribute bitmask with one or more constituent bitmap integers of a permissive attribute bitmask, and then performing a logical AND, OR, NOT, and/or XOR operations on each of the various results of the bitwise operations to arrive at a final result, wherein a nonzero result signifies that the transaction should be allowed, provided other transaction eligibility criteria, if present, are satisfied, otherwise the transaction should be prohibited.

In another related embodiment, the transaction rule compliance engine can authenticate a transactions between a validated holder address of a sender and a validated holder address of a receiver by applying transaction authentication logic in the form a sequence of one or more bitwise AND, OR, NOT, and/or XOR operations applied to each constituent bitmap integer of a membership attribute bitmask with one or more constituent bitmap integers of a restrictive attribute bitmask, and then performing a logical AND, OR, NOT, and/or XOR operations on each of the results of the bitwise operations to arrive at a final result, wherein a zero result signifies that the transaction should be allowed, provided other transaction eligibility criteria, if present, are satisfied, otherwise the transaction should be prohibited.

In yet another related embodiment, wherein the transaction authentication data for a registered user includes a membership attribute bitmask, a permissive attribute bitmask, and a restrictive attribute bitmask, the transaction rule compliance engine can apply a final logical AND between the first aforementioned result for the membership and permissive attribute bitmasks and the NOT of the second aforementioned result for the membership and restrictive attribute bitmasks, in order to achieve a final result, wherein a nonzero result signifies that the transaction should be allowed, provided other transaction eligibility criteria, if present, are satisfied, otherwise the transaction should be prohibited.

In another embodiment, the transaction authentication data for a registered user might also include a global stop bitmask, which can be applied in one or more bitwise AND, OR, and/or XOR operations with one or more of the attribute bitmasks associated with a registered user, and if the result of the one or more bitmask operations is nonzero, could be used to indicate that a token transaction should not be allowed (or conversely allowed).

In one embodiment, instead of the transaction authentication data for a receiver comprising at least one membership attribute bitmask, the transaction authentication data of a receiver may comprise a category node, corresponding to a category, fundamental or composite, to which the receiver is assigned based on their relevant binary attributes, according to a defined ruleset, in a directed graph comprising a plurality of category nodes and directed edges, wherein the presence of a directed edge in the graph between two category nodes signifies that a transaction is allowed between validated holder addresses of registered users associated with the source category node of the directed edge and validated holder addresses of registered users associated with the destination category node of the same directed edge. In another embodiment, instead of the transaction authentication data for a sender comprising at least one permissive (or restrictive) attribute bitmask, the transaction authentication data of a sender may comprise a category node, corresponding to a category, fundamental or composite, to which the sender is assigned based on their relevant binary attributes according to a defined ruleset, in the same directed graph that contains the category node associated with the receiver.

In one embodiment, according to such a directed graph of category nodes, transactions are to be allowed by the transaction rule compliance engine, if and only if, according to the defined ruleset, there is a directed edge between the category node to which the sender of the transaction is assigned (sender node) and the category node to which the receiver of the transaction is assigned (receiver node), wherein the sender node is the source node for the directed edge and the receiver node is the destination node for the directed edge. Similarly, if there is no such directed edge from the sender node to the receiver node, then the transaction rule compliance engine prohibits the transaction.

In one embodiment, featuring the use of such a directed edge graph, a curation system constructs a directed edge graph based on relevant attributes of registered users from their registration information and according to a defined ruleset, and then the transaction rule compliance engine retrieves the transaction authentication data for the sender and the transaction authentication data for the receiver of the potential transaction, in order to determine the corresponding sender and receiver nodes, which could potentially be one and the same, and then, the operations of the transaction authentication logic are reduced to a simple lookup or other procedure to ascertain if there is the appropriate directed edge between the corresponding sender and receiver nodes for the transaction under scrutiny, without possibly the need for various bitwise or other logical operations, besides consideration of additional various transaction eligibility criteria, which may still prohibit a transaction even if the appropriate directed edge is found in the directed graph.

In a further embodiment, the construction of the directed edge graph is performed by the curation system by first building an initial fundamental directed graph, and applying a sequence of merge operators to pairs of category nodes of the directed graph, whether fundamental or composite, to form new composite category nodes, satisfying specific conditions in order to comply with the defined ruleset, until no more merges are possible and a final reduced directed graph is constructed.

In one embodiment, in order that the curation system maintain the transaction authentication data stored on the blockchain ledger as current, or reasonably so, the curation system can write updates to transaction authentication data, or additional details or contract elements, for one or more registered users, onto the blockchain ledger, thereby generating new transaction authentication data for one or more registered users. In some embodiments, the curation system performs relevant updates in response to one or more of the following factors: changes in registration information or status of one or more registered users, one or more registered user requests, a request by the issuer of the security that the token represents on the blockchain system, changes to the defined ruleset, such as with changes to applicable securities laws and regulations in one or more relevant jurisdictions, and/or other triggers, such as an external event or a certain condition being met.

In some embodiments, the updates to the transaction authentication data are conducted by the curation system at regular time intervals. In other embodiments, the updates to the transaction authentication data are conducted by the curation system soon after one or more of the previously cited factors occur. In many embodiments for a nontrivial defined ruleset, changes in a registered user's country of residency or accreditation status would warrant an update by the curation system of the transaction authentication associated with their one or more holder addresses. In some embodiments, the curation system can update the transaction authentication data by directly rearranging, updating and/or altering a registered user's attributes. In some embodiments, as new users are registered by the curation system, the curation system can write transaction authentication for each of these new registered users to the blockchain ledger within an expected time interval, so that afterwards these new registered users may be able to potentially participate in transactions with other existing registered parties. In some embodiments, the curation system can alter or replace one or more smart contracts in order to update or replace the transaction authentication logic of the transaction rule compliance engine.

Modifications to transaction authentication data and/or transaction authentication logic allow the curation system to revoke the ability for a registered user to participate in a transaction and also to accommodate changes in binary attributes that may, according to the defined ruleset, affect the other parties with which a registered user is now allowed to transact. In another embodiment, the curation system can alter the transaction authentication data of a registered user in order to place a hold on activity associated with one of their holder addresses if the registered user communicates a loss of control over the holder address, such as a lost, stolen, or forgotten private key. In another embodiment, the curation system can alter the transaction authentication data of some (or all) registered users in order to accommodate a recent change in applicable securities laws or other legal requirements, thus directly altering the defined ruleset, and potentially the meaning of one or more binary attributes. Such embodiments can be used for the curation system to be able to adjust to relevant changes in conditions as necessary so that the transaction rule compliance engine can operate as originally intended even after initial deployment.

While many embodiments are described that involve a blockchain system with a BVM, other embodiments are described for maintaining the functions of the transaction rule compliance engine, according to a defined ruleset, in a computer system outside of the BVM, by interacting with one or more nodes of the blockchain system and/or the curation system, in order to access relevant transaction authentication data. In some embodiments, transaction authentication data for each potential transaction participant is obtained or refreshed at fixed time intervals of a specified schedule. In other embodiments, a subset of transaction authentication data is obtained at regular time intervals, where the subset is chosen in such a manner as to maintain the correct or current state of the transaction authentication data for each potential transaction participant in the computer system outside of the BVM. In other embodiments, transaction authentication data is obtained, in total or in part, at the request of an operator. Further embodiments describe application to matching buy and sell orders on an off-chain computer system (such as on a stock exchange order book system) that integrates the functionality of a transaction rule compliance engine corresponding to a defined ruleset for a security to be traded.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 illustrates a block diagram of a system for authentication of transactions for a token contract according to a defined ruleset.

FIG. 2 illustrates a method for executing a transaction involving security tokens on a token contract implemented on a blockchain.

FIG. 3 illustrates a method using a curation system for curating transaction authentication data for a registered user stored on a token contract running on a blockchain.

FIG. 4 illustrates a block diagram of a system for replicating some of the functions or features of a transaction rule compliance engine in a computing system, perhaps executed outside of a BVM or on another BVM.

FIG. 5 illustrates a method for matching buy and sell orders and validating matched orders on a computing system that integrates a transaction rule compliance engine.

FIG. 6 illustrates transaction authentication operations; FIG. 6A illustrates an exemplary operation on transaction authentication data by the transaction rule compliance engine resulting in a permissive transaction. FIG. 6B illustrates an exemplary operation on transaction authentication data by the transaction rule compliance engine resulting in a rejected transaction.

FIG. 7 illustrates transaction authentication operations that refer to a directed graph representation of permitted transactions, where each node is corresponds to a category and each directed edge represents a permitted transaction.

FIG. 8 illustrates a method for reducing a directed graph via merging category nodes. Two examples of directed graph reduction are denoted with FIGS. 8A and 8C representing different input initial directed graphs, involving fundamental category nodes, and FIGS. 8B and 8D representing the different output reduced directed graphs, involving at least one composite category node, respectively for each input initial directed graph.

FIG. 9 illustrates a more complex, exemplary set of operations of transaction authentication logic employed by a transaction compliance rule engine on transaction authentication data represented by various bitmasks.

FIG. 10 illustrates a computer system that can be employed to implement examples of the systems and methods disclosed in FIGS. 1-9.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods provided can be used with blockchain systems to provide a transaction authentication system that is decentralized, transparent, and compliant with a defined ruleset. For example, an issuing party can stipulate the defined ruleset in order to enforce laws or regulations governing the ownership or trading of securities, represented by a token, or other allowed transactions between parties on a smart contract, such as a token contract. The defined ruleset can also be used to enforce other restrictions, or requirements between the issuer of the token and token holders, or between token holders. For example, tokens being sold by an issuing party for a token contract can have specific limitations regarding who (or what receiving party or entity) may initially purchase them, or separate limitations regarding secondary trading, especially if they correspond to a regulated security or other assets with contractual obligations.

To enforce compliance with a defined ruleset, the systems and methods provided herein can provide tools, such as a curation system, to curate transaction authentication data stored for each registered user on a blockchain using relevant registration information from a set of registered users, wherein the term “registered user” can refer to either current token holders or to potential token holders interested in purchasing or acquiring a nonzero quantity of a token, and are a subset of current (or potential future) users of the distributed computing system. Registration information can include, but is not limited to, a name, address, contact information, country of citizenship and country of residence for individuals, and countries where the registering user meets requirements for accredited or qualified status.

It should be appreciated that a current or potential token holder is an entity controlling one or more holder addresses and either owns, or is interested in purchasing or acquiring, a nonzero amount of a token associated with the token contract. The curation system can collect registration information for a given current or potential registered user, as necessary, before the initiation of any token transaction, including a token sale or transfer. Thereafter, the curation system can pre-generate transaction authentication data associated with one or more holder addresses of each registered user for storage on the token contract, one or more separate smart contracts, such as compliance contract(s) discussed below, another location on the blockchain system, or any combination thereof, according to a defined ruleset governing token ownership and allowed transactions, before the initiation of any token transaction, including a token sale or transfer, involving a registered user. The curation system can store the transaction authentication data associated with one or more holder addresses of each registered user on the token contract, one or more separate smart contracts, such as compliance contract(s) discussed below, another location on the blockchain system, or a combination thereof on the distributed ledger of the blockchain system, by submitting one or more curation data transactions that are hashed and verified by one or more nodes as part of their function of generating, propagating, and verifying blocks of blockchain transactions. The transaction authentication data then may also be made accessible to other smart contracts executed on the BVM for later use, including those smart contracts that are part of a transaction rule compliance engine for authenticating a transaction involving a token.

In order to store or update transaction authentication data “on” the token contract, one or more separate smart contracts, such as compliance contract(s) discussed below, another location on the blockchain system, or any combination thereof, the transaction authentication data is integrated as part of a data structure of a curation data transaction that is processed by blockchain nodes operating on the distributed computing system. For example, a blockchain node might hash and subsequently verify hashes, as part of its function of generating, propagating, and verifying blocks of blockchain transactions. A blockchain node that is tasked with, or otherwise begins, processing a blockchain transaction referencing a token contract and perhaps other associated smart contracts, such as the compliance contract(s) discussed below, to determine what a transaction involving the token requires, whether it has been altered in some unauthorized way, or what steps to take, etc., can, in some embodiments, evaluate, read, parse or otherwise operate on elements of the token contract and the transaction authentication data that is associated with, integrated into, or referenced by the token contract or other aforementioned smart contracts. In those embodiments, from that available data the blockchain node can then determine whether the token contract as seen by that blockchain node is valid, or use that processing to determine a blockchain node's future actions, such as deciding to propagate the token contract, act on parts of the token contract or token transactions referencing the token contract, convey that the token contract appears to be manipulated and should be considered invalid, etc.

The transaction rule compliance engine, perhaps executed by a blockchain node or otherwise, can refer to the transaction authentication data for each participant in a token transaction and apply appropriate transaction authentication logic, designed to enforce the restrictions and rules of the defined ruleset, to the, typically pre-generated, transaction authentication data in order to determine whether to authorize (or deny) the transaction. A transaction rule compliance engine can be implemented as program code or a set of computer instructions stored and executed on the blockchain system as part of the token contract or in another location of the blockchain system, such as part of one or more separate smart contracts, which are herein referred to as compliance contracts, or a combination thereof. In those embodiments where the transaction rule compliance engine is stored separate from the token contract, the addresses of the associated compliance contracts are known to the token contract and can be referred to when necessary to call the transaction rule compliance engine in order to authorize (or deny) a requested token transaction received by the token contract. This structure supports multiple tokens, each token having its own token contract, each token contract of which references one or more compliance contracts. In another embodiment, the transaction rule compliance engines associated with a plurality of different tokens can use the same set, of compliance contract(s), or a subset thereof, wherein each token contract references the appropriate compliance contract(s).

The system described herein can utilize a curation system, comprising one or more curation computing systems, implemented outside of the BVM, and a transaction rule compliance engine, implemented on the BVM, to enforce a defined ruleset governing token ownership and allowed transactions for a token contract. The system can perform this function by maintaining transaction authentication data for one or more holder addresses of each registered user, on the blockchain ledger. The curation system stores the transaction authentication data on the token contract, the compliance contract(s), or another place on the distributed ledger by submitting one or more curation data transactions.

In order to characterize registered users according to a defined ruleset governing the ownership or transfer of a particular security, their registration information is parsed and examined by the curation system to assign values from a set of relevant attributes associated with the defined ruleset. Based on their attribute values, the curation system then assigns a registered user to one of a number of categories, which represents their capacity to possess a token or their ability to participate in a transaction involving a token with other registered users. These category assignments of each registered user, and perhaps also data representations of categories of other registered users with which each registered user is allowed (or not allowed) to participate in a transaction involving a token, and one or more values associated with various transaction eligibility criteria (as discussed below) for each registered user, are then incorporated into each registered user's transaction authentication data and associated with one or more of their holder addresses, generally before a transaction involving the registered users is to be authenticated.

In one embodiment, the transaction authentication data may be anonymized by the curation system, with a registered user's registration information, including their personal or private information, not being visible on the blockchain ledger as part of their associated transaction authentication, and only the relevant attributes associated with a registered user's one or more holder addresses and pursuant to category assignment and data representations of categories of other registered users with which the registered user is allowed (or not allowed) to transact (and other potential eligibility criteria; as discussed below) can be examined on the blockchain ledger.

The number and types of attributes, along with their potential values, to be considered for characterizing registered users is stipulated according to a defined ruleset for governing token ownership and allowed transactions, in order to enforce applicable regulations and securities laws for the set of registered users. In one embodiment, registered users could comprise individuals or organizations under one or more legal and/or regulatory jurisdictions. In another embodiment, relevant attributes for an individual may include country/countries of residency, country/countries of citizenship, country/countries in which the individual pays taxes, the possession of certain individual certifications or licenses, if the individual is deemed to be accredited or qualified in an applicable jurisdiction, if the individual is a broker, if the individual is designated as qualified institutional buyer (i.e., QIB), and if the individual is affiliated with the issuer of the token. In another embodiment, relevant attributes for an organization may include country/countries of business operations, country/countries of organization or incorporation, country/countries in which the organization pays taxes, the possession of certain business certifications or licenses, if the organization is a brokerage firm, custodian, or other regulated financial institution, and if the organization is the issuer of the token or otherwise affiliated with the issuer of the token. In yet another embodiment, the set of possible attributes for an individual or organization may include other attributes relevant to the fulfillment by the individual or organization of one or more regulatory requirements stipulated by the defined ruleset for one or more types of potential transactions.

In one embodiment, the intended set of potential holders of a defined ruleset could be limited to a subset of all registered users possessing a certain set of predetermined attributes. In most embodiments, in order to evaluate a transaction according to a nontrivial defined ruleset, all relevant attributes associated with the defined ruleset are identified in advance for each participant of the transaction. In one embodiment, provided the relevant regulations and laws, from which the defined ruleset is derived, still apply and if all attributes associated with the defined ruleset can be identified for all participants involved with the transaction ahead of time, the defined ruleset and the associated attributes could be then used by the transaction authentication system to authorize (or deny) transactions involving a token.

Attributes associated with a defined ruleset governing ownership and allowed transactions for a token representing a security according to applicable financial laws and regulations may be of various types. In some embodiments, each attribute may be expressed as a numerical value. In particular, in some embodiments, these numerical values may be Boolean values of true and false, i.e., binary attributes. In other embodiments, each attribute may be expressed as an alphanumeric string. In yet other embodiments, each attribute may be an enumerated type. In yet other embodiments, each attribute may represent a range of numerical values. In still other embodiments, the set of attributes may comprise a mixture of any of the aforementioned types.

In general, non-binary attributes may be further divided or reduced into an ordered set of binary attributes, each of which has two Boolean values: true or false. For example, for registered users that are members of an intended set of potential holders limited to five countries of residency, the attribute associated with country of residency can be divided into five binary attributes, one for each country. Some attributes, such as the ownership of a specific license or the accredited or qualified status of an individual investor, are already binary.

For a given set of binary attributes there exists a set of all possible permutations. This set of possible permutations has a size of two raised to the power of the number of binary attributes. Because each registered user can be represented by the values of their binary attributes, each registered user belongs to only one member of the set of all possible permutations. Each such distinct permutation or combination of binary attributes can thus be viewed as a single fundamental category to which the registered user is assigned. It is possible that multiple registered users may be assigned to the same fundamental category. On the other hand, not all permutations or fundamental categories will be applicable. For example, the set of all fundamental categories for registered users will generally not span the set of all possible permutations, as some permutations of binary attributes are not occupied by any registered user, and thus no registered user is assigned to the corresponding unoccupied fundamental category. In other examples, the value of one binary attribute in a permutation may preclude certain values of one or more other binary attributes, thereby restricting valid permutations and hence the corresponding fundamental categories. In yet other examples, the value of one binary attribute in a permutation may require certain values of one or more other binary attributes, thereby again restricting valid permutations and hence fundamental categories.

In some embodiments, according to a defined ruleset it may be more efficient to combine certain binary attributes together via Boolean arithmetic (referred to herein as “combined” binary attributes, as opposed to the original base, “simple” binary attributes) to form new additional permutations, sometimes of potentially different length, that can be viewed as composite categories to which registered users are assigned. For example, consider that a certain type of license “X” might be available to citizens of country “A” but not to citizens of country “B”. Likewise, a certain type of license “Y” might be available to citizens of country “B” but not to citizens of country “A”. Therefore, no person may have both binary attributes of “has license X” and “is citizen of B” to be true. Nor may any person have both binary attributes of “has license Y” and “is citizen of A” to be true. In such situations it may be possible to combine some binary attributes for a different, perhaps more efficient or more compact, characterization of individuals or organizations without changing the result of the transaction rule compliance engine applied to a transaction.

For example, rather than associate separate binary attributes with ownership of license “X” and license “Y” for citizens of countries “A” and “B”, instead new combined binary attributes of “citizen of A with license X”, “citizen of A without license X”, “citizen of B with license Y”, and “citizen of B without license Y” could be designated. Hence, now there is no need to consider the case of citizens of “B” with or without license “X” and vice-versa for citizens “A” with or without license “Y”, as they are not applicable. Though in this example, the length of the new redefined permutations is the same as before, there are now fewer of them (four fewer) that need to be considered. Going one step further, instead two new combined binary attributes of “has license and citizen of A” and “has license and citizen of B” could be designated, with two more redefined as “no license and citizen of A” and “no license and citizen of B”. Now if the first new combined binary attribute is true, then provided there are no other licenses applicable to citizens of country “A”, then it implies ownership of license “X”, and if the second is true, then it implies ownership of license “Y”.

In this example, while the length of the permutations remains the same, the number of permutations of binary attributes is again fewer. However, using this second scheme for combining binary attributes could be more efficient than the first when extending to the case of many countries of citizenship and only one type of license corresponding to each country. Again, the previously described new four combined “specific license-citizenship” binary attributes or the following alternative two combined “implied license-citizenship” binary attributes will generate permutations that can be viewed as composite categories as opposed to the original fundamental categories, wherein all simple binary attributes were considered independent of one another.

In yet another example, consider a registered user who is an individual with dual citizenship, for example, a citizen of both the United States and Ireland. This registered user would then have nonzero values for the binary attributes for citizenship in the US and in Ireland. While this registered user could be assigned to one fundamental category corresponding to one of the distinct 2^{N} permutations (where N is the number of binary attributes), the defined ruleset may stipulate that a transaction involving a dual citizen of the U.S. and Ireland can only transact with registered users who are citizens from other countries who could otherwise transact with registered users who are citizens solely of the U.S. and with registered users who are citizens solely of Ireland, provided other additional binary attributes, such as countries of residence, accredited/qualified status, etc., do not prohibit the transaction according to same defined ruleset.

As with this example, it might be more practical to define a combined binary attribute of “dual citizen of U.S. and Ireland” with values of true and false, and redefine the simple binary attributes related to citizenship of the U.S. and citizenship of Ireland, as “citizen solely of U.S.” and “citizen solely of Ireland”. Now, there would be one additional binary attribute for a total of N+1 binary attributes and the new combined attribute for U.S. and Ireland dual citizenship would generate new permutations that do not correspond to one of the original 2^{N} permutations, i.e., composite (instead of fundamental) categories. In some cases, the combination of binary attributes and their corresponding permutations or composite categories may simplify application of a nontrivial defined ruleset by either reducing or redefining the number of permutations. Other scenarios involving characteristics of a registered user, such as one involving potential dual country of residency or another involving more than one country in which taxes are to be paid, can be treated in a similar fashion by combining binary attributes via Boolean arithmetic and hence composite categories.

A convenient method of enumerating categories, whether fundamental or composite, is to use binary arithmetic in which each fundamental or composite category is associated with a unique bitmap integer for which each bit of this bitmap integer is assigned to a specific binary attribute. In some embodiments, the bitmap integer may be unsigned. In some embodiments, the bitmap integer may comprise 1, 8, 16, 32, 64, 128 or 256 bits. In other embodiments, the bitmap integer may comprise a different number of bits, and perhaps even more than 256 bits. In another embodiment, each category, whether fundamental or composite, is instead associated with a collection of bitmap integers, each of which is comprised of bits representing the values of a binary attribute, wherein the number, size, and ordering of the individual bitmap integers of the collection is made in accordance with the requirements of the transaction authentication logic for a defined ruleset.

Generally, a defined ruleset governing ownership and allowed transactions of a token that covers registered users of an intended set of potential holders can always be extended to a new defined ruleset covering the entire set of all possible registered users by defining a new additional binary attribute that represents membership in the intended set of potential holders. According to the new extended defined ruleset, this new binary attribute can be checked and, as a result, transactions involving registered users outside the intended set of potential holders would be prohibited. This new defined ruleset does not necessarily represent an interpretation of the regulations or securities laws for the entire set of all possible registered users, but instead ensures that by default, those registered users that are not supported by the original defined ruleset, i.e., not part of the intended set of potential holders, are prohibited from participating in transactions involving the security.

In one embodiment, the transaction authentication data can include one or more data representations of a set of categories, wherein each category may be fundamental or composite, and wherein the categories are derived from a set of binary attributes corresponding to a defined ruleset, to which the curation system assigns registered users, based on information received during registration. In a similar embodiment, the transaction authentication data can include one or more data representations of the set of binary attributes corresponding to a defined ruleset for a set of registered users, based on information received by the curation system during registration. The transaction authentication data can also include additional criteria that represent transaction eligibility criteria under a defined ruleset for registered users to participate in a transaction on the token contract. The curation system can assign some of these additional transaction eligibility criteria for one or more holder addresses of each registered user based on their corresponding registration information, while others may be globally assigned.

The transaction rule compliance engine also can include transaction authentication logic that operates on the, typically pre-generated, transaction authentication data of transaction participants, so that the applicable financial laws and regulations for a transaction of a security represented by a token, potentially involving one or more jurisdictions, are enforced so that only those transactions permitted under a defined ruleset are authenticated and can then be executed by the token contract. In one embodiment, based on a result of the transaction authentication logic operating on the transaction authentication data associated with one or more holder addresses of each participant of a requested transaction and stored on the distributed ledger of a blockchain system, whether on the token contract, one or more compliance contracts, another location, or a combination thereof, the transaction rule compliance engine might be configured to reject the requested transaction or allow the requested transaction. In another embodiment, based on whether the requested transaction is rejected or allowed, the transaction rule compliance engine might be also configured to record that the transaction was rejected or allowed on the distributed ledger, along with appropriate descriptor data including, but not limited to, blockchain timestamp, participating holder addresses, type of transaction, and other relevant token transaction information.

A token might be a voucher implemented in a BVM that represents something of value, such as goods or services or future revenue, currency, or a unit of exchange. A specific class of token is typically implemented in an associated BVM application as a blockchain ledger entry that assigns a numerical quantity to individual addresses representing a current quantity of the thing of value represented by the tokens allocated to each address. Such tokens may then be transferred from one address to another by the BVM performing computational operations and recording the associated changes of state on the blockchain ledger. The rules for how such tokens are created, disposed of, assigned, and traded are embedded in the implementation of the associated BVM application, and as such, can have the same characteristics of transparency and verifiability that are associated with the BVM as a whole. Tokens may represent securities interests, such as, but not limited to, shares of equity, units of debt, or contractual rights to a dividend or royalty. In such cases these tokens might be referred to as “securitized tokens” or “security tokens.”

Token contracts are a type of smart contract that can result in enforcement of operations that record and perform actions with already existing tokens, generate or issue new tokens, and execute various transactions involving tokens. The individual or organization that is responsible for issuing the securities associated with a token is referred to as the token issuer. The issuer is generally responsible for publicly identifying the address of the token contract associated with the issued security and would be involved, directly or indirectly through a third party, with the implementation of the token contract. An individual or organization that has a nonzero balance of tokens is referred to as a current token holder or token holder. A token holder might normally associate their holdings with one or more addresses under their control. An address under the exclusive control of a current or potential token holder (current or potential holder for short) might be referred to as a “holder address”. A holder address is therefore associated with a single and specific current or potential token holder, whether it be an individual or organization.

In order to authenticate transactions between individuals or organizations according to a defined ruleset governing the ownership or transfer of a particular security, it is generally necessary to identify the relevant attributes of the individuals or organizations who possess the security in question (i.e., current holders) and/or the relevant attributes of the individuals or organizations that might possess the security if the transaction is permitted (i.e., potential holders). For transactions that involve multiple parties, it would generally be necessary to identity the relevant attributes of each party involved.

For a security represented as a token on a BVM, it is generally desired, and in many cases perhaps required, to implement controls on the ownership and transfer of the token on the same BVM. Such controls would include a defined ruleset for governing token ownership and allowed transactions in order to enforce applicable regulations and laws. A system to authenticate transactions involving a token could involve querying each participant involved in the transaction to retrieve their set of attributes, which are used to characterize their ability to participate in a transaction with other members of the intended set of potential holders and are associated with the defined ruleset, and then employing one or more smart contracts, executing on the BVM, to apply appropriate authentication logic that operates on the relevant attribute information for each participant in order to determine if a transaction is allowed or prohibited, wherein said authentication logic is specified according to the defined ruleset. A system to authenticate transactions involving a token could identify the relevant attributes of each party participant involved with the transaction based on their associated holder address. This association of address and relevant attributes may need to be established in advance so that the appropriate authentication logic could be correctly applied in due course.

To one skilled in the art, it will be appreciated, upon reading this disclosure, that current implementations of token contracts, in order to control transactions or authorize users, frequently rely on lists of authorized holder addresses (“whitelists”) or are configured to be required to consult off-blockchain resources (such as “oracles”). They generally lack mechanisms for authenticating transactions via smart contracts executed entirely on the blockchain for nontrivial defined rulesets, without utilizing off-chain resources, thereby limiting the use of token contracts for applications having legal or contractual restrictions, such as for a token representing a security. It should also be appreciated that current implementations of BVMs typically require payment for their use, often with the amount of payment increasing with the amount of computer processing required to perform a transaction, or with the amount of data required to be stored in the token contract.

A requested transaction between a requested sender and a requested receiver of tokens can be authenticated when the transaction authentication logic of the transaction rule compliance engine operates upon the transaction authentication data of the requested sender of tokens and the transaction authentication data of the requested receiver of tokens and generates a permitted result according to the defined ruleset. For example, consider a defined ruleset with provisions regarding the transfer of a token from one party (such as the seller or the sender) to another party (such as the buyer or the receiver), then in one embodiment the output of the transaction authentication logic operating on the relevant transaction authentication data for both parties is a Boolean value (true or false) denoting that the transfer is allowed (or prohibited) and the transaction authentication engine then acts on this output Boolean value to execute (or deny) the transfer between the two parties.

Transactions of a token may involve one or more senders and/or one or more receivers. In the case that there is one sender and one receiver then there is only one transaction to consider as to whether it is allowed or not according to the defined ruleset. In the case that the sender and receiver are in fact the same registered user then this represents a simple balance transfer of a nonzero amount of a token from one holder address to another (both owned/operated by the same entity) and, unless strictly constrained by the defined ruleset, is expected to be allowed, provided the registered user has not had one or both of the participating addresses locked, their registration information has not expired, or the transfer is disallowed by one or more other transaction eligibility criteria. In some cases there may be one sender transacting with or transferring a nonzero amount of a token (possibly in different amounts) to multiple receivers. In some such embodiments, it would be expected that the overall transaction is only allowed if and only if all constituent pairings of the one sender to each receiver is allowed for the amount specified for each pairwise transaction.

An example may be a sender who is transferring a nonzero amount of a token as part of a trade with another registered user (i.e., the receiver) but also must transmit some other quantity of the token as a commission fee to a holder address operated by an authorized or registered third party organization that is facilitating the trade (i.e., exchange, broker, custodian, etc.). In other cases, multiple senders may be transferring a nonzero amount of the token to one receiver. In some embodiments, each pairwise transaction may be considered separable in that some may be allowed according to the defined ruleset and others may not be allowed, and only the allowed ones are enacted. In other embodiments, all pairwise transactions must be allowed according to the defined ruleset, otherwise the entire overall transaction is prohibited and none of the pairwise transactions are enacted. This pairwise approach to transaction authentication can be extended to transactions involving both multiple senders and multiple receivers. Herein, the applicable pairs may be referred to as sender-receiver pairs.

In one embodiment, the curation system can allow the transaction authentication data associated with a registered user to be updated after registration, so as to be kept current after either a change in registration information, upon the registered user's request, a change in circumstances relevant to the defined ruleset, or a change in one or more rules in a defined ruleset governing token ownership and allowed transactions for a token contract.

In one embodiment, the transaction authentication logic operates directly on the relevant binary attributes, according to a defined ruleset, of each registered user who is a participant in the transaction in order to generate an authentication result. In one embodiment, the one or more data representations of binary attributes incorporated into the transaction authentication data are selected so that the transaction authentication data of each registered user is compatible with the sequence of operations of the transaction authentication logic. In another embodiment, the transaction authentication logic operates on the assigned fundamental or composite categories, or combination thereof, of each registered user who is a participant in the transaction derived from their relevant binary attributes according to a defined ruleset. In one embodiment, the one or more data representations of categories incorporated into the transaction authentication data are selected so that the transaction authentication data of each registered user is compatible with the sequence of operations of the transaction authentication logic.

As discussed previously, in one embodiment, a category to which the sender (or receiver) is assigned, whether fundamental or composite, can be represented by a collection of bitmap integers, each comprised of a finite number of attribute bits wherein each attribute bit of a bitmap integer represents a binary attribute of the sender (or receiver), whether directly associated with the defined ruleset or indirectly via the combination of one or more binary attributes via Boolean arithmetic. In one embodiment, each bitmap integer of the collection for the assigned category of the sender (or receiver) is a result of mapping of the binary attributes of the sender (or receiver) to a finite sequence of attribute bits that is ordered and formatted according to the requirements of the sequence of operations of the transaction authentication logic to be enacted on the transaction authentication data of each of the transaction participants. In another embodiment, the number, size, and ordering of the individual bitmap integers of the collection is also made according to the requirements of the sequence of operations of the transaction authentication logic to be enacted on the transaction authentication data of each of the transaction participants.

In some embodiments, a single binary attribute, whether or not a combination of binary attributes, may be mapped to more than one of the collections of bitmap integers for the sender (or receiver). In another embodiment, instead of the collection of bitmap integers for the sender representing a category to which the sender is assigned, a subset (or all) of the individual attribute bits of each bitmap integer of the collection for the sender instead represent the binary attributes of receivers to which the sender is allowed to transact, whether the binary attributes are directly associated with the defined ruleset or indirectly via the combination of one or more binary attributes via Boolean arithmetic. In yet another embodiment, instead of the collection of bitmap integers for the sender representing a category to which the sender is assigned, a subset (or all) of the individual attribute bits of each bitmap integer of the collection for the sender instead represent the binary attributes of receivers to which the sender is not allowed to transact, whether the binary attributes are directly associated with the defined ruleset or indirectly via the combination of one or more binary attributes via Boolean arithmetic.

In one aspect, a transaction that can take place on a blockchain system might be gated by a smart contract in that a node of a blockchain system would not process the transaction and/or indicate that it is allowed unless conditions of the smart contract that constrains the transaction are met. The transaction might involve a number of participants, as few as one (a self-dealing transaction), two, or more than two. Where there is a transfer of tokens or value, one or more of the participants might be designated as senders from which the tokens or value are transferred from, and one or more of the participants might be designated as receivers to which the tokens or value are transferred to. Each participant would have at least one category into which they are assigned, which might be represented by a bitmap stored as a binary string of some number of bits. A defined ruleset might indicate one or more rules for what kinds of transactions are allowed as between particular categories of participants. A node, in processing a transaction, might have transaction authentication logic programmed to only allow or inject a transaction if a processing of the bitmaps of each of the participants, according to the defined ruleset, logically outputs a valid value, indicating that the transaction can happen.

In one embodiment, the operations of the transaction authentication logic applied to the transaction authentication data of the sender and of the receiver include a series of tests or digital operations applied to each of the one or more bitmap integers of the collection associated with the sender and each of the one or more bitmap integers of the collection associated with the receiver, with the results of the tests being Boolean values of true or false. In another embodiment, some of the tests may involve one or more bitmap integers of the collections associated with a participant and a preassigned bitmap integer that may be independent of the participant. In yet another embodiment, the preassigned bitmap integer may be a global bitmap integer with a specifically chosen value, perhaps in order to interrogate the value of one or more attribute bits of one or more bitmap integers of the participant (a sender or a receiver) in order to make an assessment for the test. In one embodiment, the results of each test may be further combined using a set of logical expressions conducted by the transaction authentication logic to provide a final determination of whether a transaction between the sender and receiver is allowed or not allowed.

In one embodiment, tests on bitmap integers can be implemented as a sequence of bitwise operations, in which the result of each bitwise operation is passed to the next one in sequence, until a final result, itself a bitmap integer, is achieved. Each result, including the final result, could be interpreted as false (no bits remain that are set to “1”) or true (at least one bit remains set to “1”). In some embodiments, the sequence of bitwise operations could include a bitwise AND between two bitmap integers. In some embodiments, the sequence of bitwise operations could include a bitwise OR between two bitmap integers. In some embodiments, the sequence of bitwise operations could include a bitwise XOR with two bitmap integers. In some embodiments, the sequence of bitwise operations could include a bitwise NOT.

Employing bitwise operators can improve computational efficiency by applying a logical rule (AND, OR, XOR, or NOT) on many binary attributes, represented by attribute bits in the bitmap integers, simultaneously and consistently in a single operation. For example, the binary attributes corresponding to country of citizenship of a receiver can be mapped to attribute bits in a “citizenship” bitmap integer in which each bit corresponds to a specific country. Citizenship in country A might be determined by the value of the second bit, citizenship of country B might be determined by the value of the third bit, and citizenship of country C might be determined by the value of the fourth bit. To test the citizenship for any of country A, B, or C, one can perform the binary AND with a preassigned bitmap integer with bits 2, 3, and 4 set. If the result is nonzero, this means that the receiver is a citizen of at least one of country A, B, or C. In another example, the binary attributes corresponding to the citizenship of the sender can be mapped to attribute bits in a second similar citizenship bitmap integer. If the binary AND with the citizenship bitmap integer of the sender and the citizenship bitmap integer of the receiver produces a result that is zero, this means that the sender and receiver do not have a country of citizenship in common.

In one embodiment, the number, N, of bitmap integers associated with the sender and the receiver for testing by the transaction authentication logic are the same. In another embodiment, if there are N bitmap integers in the collection for the sender and the collection for the receiver, the transaction authentication logic may as part of its sequence of tests, iterate over a subset (or all) of the N² combinations of bitmap integers between the two collections in a predetermined order according to the requirements of the transaction authentication logic. In yet another embodiment, the bitmap integers associated with the sender and receiver for testing by the transaction authentication logic are ordered such that each bitmap integer of the sender is tested against a single corresponding counterpart in the receiver that has the same place in the ordering of the collections, wherein N ordered pairs of bitmap integers are tested in sequence by the transaction authentication logic. In another embodiment, the length of the bitmap integers (in number of bits) is the same for all bitmap integers of the sender and receiver. In yet another embodiment, though the number and ordering of the bitmap integers is the same for the collections of the sender and receiver, irrespective of whether the length of the bitmap integers are the same or instead different between some or all of the bitmap integers associated with the sender or receiver, the two collections of bitmap integers, one for the sender and one for the receiver, are aligned in that the bitmap integers of the sender and receiver have the same ordering and the length of each bitmap integer in the collection for the sender is the same as its corresponding ordered counterpart bitmap integer in the collection for the receiver.

In yet another embodiment, the alignment is achieved for a chosen ordering of the bitmap integers of the collections of the sender and receiver, by extending out (by padding or otherwise) “0” (or “1”) valued bits for each bitmap integer of the sender and receiver to a chosen uniform length. In another embodiment, wherein the number of bitmap integers of the collection for the sender (Nₛ) is greater than that of the collection for the receiver (Nᵣ), i.e., Nₛ>Nᵣ, the transaction authentication logic may as part of its sequence of tests, iterate over a subset (or all) of the Nᵣ×Nₛ combinations of bitmap integers between the two collections in a predetermined order according to the requirements of the transaction authentication logic, and vice-versa where Nᵣ>Nₛ. In another embodiment, wherein the number of bitmap integers of the collection for the sender (Nₛ) is greater than that of the collection for the receiver (Nᵣ), i.e., Nₛ>Nᵣ, an ordering of the bitmap integers of the sender might be chosen such that the first Nᵣ bitmap integers of the sender are tested against a single corresponding counterpart in the receiver that has the same place in the ordering of the first Nᵣ bitmap integers of both collections, in that Nᵣ ordered pairs of bitmap integers are tested in sequence by the transaction authentication logic, and vice-versa where Nᵣ>Nₛ.

Additional computing systems outside of the BVM can implement the transaction rule compliance engine's features if access is provided to the transaction authentication logic and, likely pre-generated, transaction authentication data. In some cases, it would also be desirable for the additional computing systems outside of the BVM to synchronize with the state of transaction authentication data on the BVM at a predetermined regular interval, to provide for potential updates, via the curation system, of the transaction authentication associated with the one or more holder addresses of one or more registered users. For example, an operator of a stock exchange may desire to include the functions of the transaction rule compliance engine within the computing systems that execute the stock exchange's order book and/or order matching system(s), and perhaps to synchronize the relevant transaction authentication data for each potential trade participant on a twice daily basis. In another example, a broker may desire to include the functions of the transaction rule compliance engine with their computing systems for establishing the validity of orders from their clients, perhaps on an hourly basis. In some embodiments, the broker or the stock exchange order book system enriches the stock exchange orders with an associated holder address or customer identifier that indexes to an associated holder address. During order matching, the exchange order book system retrieves the transaction authentication logic and/or relevant transaction authentication data for each potential trade participant either from reading a node of the blockchain system itself or by reading the data from another computing system in communication with both the blockchain system and the order book system. The order book system then executes the functions of the transaction rule compliance engine for potential trades as part of its order matching operations, allowing trades to proceed if the transaction authentication logic operating on the transaction authentication data of each of the trade participants returns a value indicating an allowed match that is compliant with the defined rules set governing ownership and allowed transactions for the security and rejecting trades when the transaction authentication logic returns a value indicating a disallowed match according to the defined ruleset. In this manner, the features of the transaction rule compliance engine and its reliable maintenance on a blockchain system can be applied to conventional (non-blockchain) computing systems such as in a stock or securities exchange order book system.

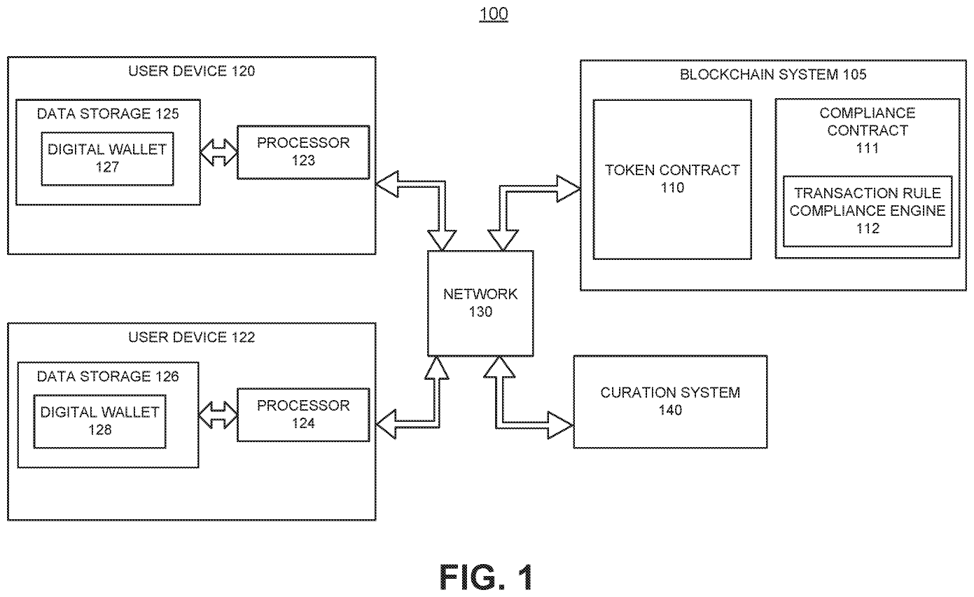

FIG. 1 shows a block diagram of a system 100 for authenticating transactions involving tokens according to a defined ruleset governing token ownership and allowed transactions for a token contract. The system 100 includes a blockchain system 105, which may be a BVM, implementing a token contract 110, a plurality of user computing devices 120 and 122, and a curation system 140 that interacts with each of the plurality of user computing devices 120 and 122 and the blockchain system 105 via a network 130 (e.g., the Internet or an intranet). It will be appreciated that the blockchain system 105 can implement more than one token contract 110. Each of the plurality of user computing devices includes respective hardware processors 123 and 124 operatively connected to electronic data storage 125 and 126, such as volatile or non-volatile memory.

In FIG. 1, the electronic data storage 125 and 126 at each of the plurality of user computing devices 120 and 122 stores a digital wallet 127 and 128. A digital wallet 127 and 128 can be a data structure used to store associated data on common or dedicated electronic data storage (e.g., RAM, or a hard-drive). In certain embodiments, dedicated hardware devices, such as a hardware security module (HSM), can be used to store information associated with the digital wallets 127 and 128. In certain exemplary embodiments, the digital wallet 127 and 128 can be stored on a dedicated storage hardware that is implemented externally and in communication with the system 100 for at least a time necessary to complete a blockchain transaction (e.g., via a communication link or local bus connection).

Each digital wallet 127 and 128 can be implemented as software instructions executed by a hardware processor, or specifically designed hardware, that stores information that allows an individual to make electronic commerce transactions that use, for example, a blockchain. Each digital wallet 127 and 128 can include or store a data structure that holds a private key and one or more BVM addresses that are a product of the private key. Other users can utilize these addresses to send blockchain transactions to the BVM associated with a stored address, which can then be used to perform authorized actions on the blockchain. The BVM addresses might be holder addresses, such as sender holder addresses and/or receiver holder addresses.

In some systems, authority for such transactions can be conveyed by signing messages with a digital signature generated from a private key corresponding to an appropriate holder address. In certain exemplary embodiments, each digital wallet 127 and 128 may be configured to send blockchain transactions to the BVM with a stored address only after users provide a private key or other identifier by direct manual input, for example, from a keyboard, by spoken instructions, or using a device that identifies a specific biometric marker.

Multiple computational nodes can implement the token contract 110, and each node can operate to validate transactions submitted to the token contract. Generally, only one of the nodes needs to receive a transaction at an address on the blockchain system 105, whether the address is an external address or a smart contract running on the BVM and controlled by an external address, to begin execution of an authorized action on the BVM. Once an instance of the token contract 110 at one node receives a blockchain transaction it can propagate the blockchain transaction to other nodes within the blockchain system 105. Each node that is part of the blockchain system 105 can also keep a copy or a portion of the blockchain in memory that is local to the corresponding node.

In FIG. 1, the blockchain system 105 additionally implements a set of compliance contracts 111 (comprising one or more compliance contracts) that further include a transaction rule compliance engine 112 that can verify that a given transaction complies with a defined ruleset. To this end, the curation system 140 can use information provided by registered users to generate and maintain transaction authentication data for each registered user on the token contract 110, the set of compliance contracts 111, another location on the blockchain system, or any combination thereof, that the transaction rule compliance engine 112 can then utilize for its analysis. The blockchain system 105 can implement more than one of the set of compliance contracts 111. In various embodiments with a plurality of token contracts 110, token contracts 110 can refer to a single set of compliance contracts, provided each of the plurality of token contracts 110 have the same corresponding defined ruleset for governing the ownership and allowed transactions involving the different tokens corresponding to each token contract. In various embodiments with a plurality of compliance contracts in the set of compliance contracts 111, one or more of the set of compliance contracts 111 can maintain variant sets of transaction authentication data and transaction authentication logic. In another embodiment, the token contract 110 has the transaction rule compliance engine 112 integrated into the token contract 110 program code itself.

In a simple case, the set of compliance contracts 111 may comprise a compliance contract for enforcing an appropriate defined ruleset during issuance of a security token and another compliance contract for enforcing an appropriate defined ruleset during secondary trading. For example, if a token issuer wants to issue a security token in multiple jurisdictions, one or more compliance contracts could be deployed on the BVM for enforcing compliance rules such as allowing issuance of security tokens to individuals only with accredited or qualified status in one jurisdiction, not allowing issuance of tokens to citizens or residents of a certain country, etc. Another one or more compliance contracts could then be deployed on the BVM for enforcing restrictions on trading of the security tokens issued to individuals belonging to a certain jurisdiction, such as not allowing current or potential token holders to buy or sell security tokens from individuals who are residents of another jurisdiction until after a one year holding period expires. More compliance contracts can be deployed as necessary for enforcing other compliance rules pertaining to a given security token.

In one embodiment, transaction authentication data can include one or more data representations of categories, whether fundamental or composite, to which the curation system 140 can assign each registered user derived from each registered user's relevant attributes from their registration information according to a defined ruleset. In a similar embodiment, transaction authentication data may include one of more data representations of binary attributes of registered users. In another embodiment, transaction authentication data for each registered user can include one or more data representations of categories of other registered users, whether fundamental or composite, with which the registered user is allowed (or not allowed) to transact, according to a defined ruleset. In a similar embodiment, transaction authentication data for each registered user may include one of more data representations of binary attributes of other registered users with which the registered user is allowed (or not allowed). Transaction authentication data for each registered user can comprise additional transaction eligibility criteria applicable to the registered user. After associating transaction authentication data with a registered user, the curation system 140 can assign, or the registered user can specify, a holder address to be associated with that register user, which will be referred to herein as a “validated holder address.”

In some embodiments, a registered user may have one or more validated holder addresses. Specifically, the curation system 140 can curate the transaction authentication data for the transaction rule compliance engine 112 by generating transaction authentication data for one or more validated holder addresses, uploading the validated holder addresses and associated transaction authentication data to the token contract 110, the set of compliance contracts 111, another location on the blockchain system, or any combination thereof, and maintaining/updating the transaction authentication data as required.

The curation system 140 can store and update the transaction authentication data for each of a subset (or the entire set) of registered users on the token contract 110, the set of compliance contracts 111, another location on the blockchain system 105, or any combination thereof, by submitting one or more curation data transactions.

The curation system 140 can transform a subset (or all) of the registered user information provided by the registered user associated with one or more validated holder addresses into transaction authentication data for the registered user derived from the registered user's relevant binary attributes according to a defined ruleset and can provide the token contract 110 and the transaction rule compliance engine 112 with transaction authentication data for the registered user that is in a format compatible with efficient use on the blockchain system 105.

For example, while certain information about a registered user is required at the time of registration in order to satisfy various “Know Your Customer/Anti Money Laundering” (i.e., KYC/AML) verification requirements, including, but not limited to, name, physical address and contact information, such personal information should not be exposed to the distributed ledger of the blockchain, and is not necessary to characterize registered users for the purposes of the transaction rule compliance engine according to the defined ruleset. Instead other registration information such as, for an individual, their country of residency, country of citizenship, accredited or qualified status, etc. is used to characterize registered users for the purposes of the transaction rule compliance engine according to the defined ruleset.

For example, when a user enters required information for registration, perhaps for, among other purpose, KYC/AML verification, the curation system 140 can collect the entered registration information and associate it to the registered user's validated holder addresses. In some embodiments, another party, such as a human agent, can verify the registration information and return an approval or rejection of the registration information to the curation system 140, based on completing the registration process and various other requirements such as those associated with KYC/AML verification. The curation system 140 then can generate the transaction authentication data from the registration information according to a defined ruleset and associate it to the registered user's one or more validated holder addresses. In one embodiment, the curation system 140 then can store the one or more validated holder addresses and the registered user's associated transaction authentication data on the distributed ledger of the blockchain system 105 on the token contract 110, the set of compliance contracts 111, another location of the blockchain system 105, or any combination thereof. In one typical embodiment, the curation system 140 generates the transaction authentication data for each registered user and writes it to the distributed ledger of the blockchain system 105 on the token contract 110, the set of compliance contracts 111, another location of the blockchain system 105, or any combination thereof, prior to the transaction rule compliance engine receiving a request to authenticate a potential transaction involving the registered users. In another embodiment, the curation system 140 can store the one or more validated holder addresses and the registered user's associated transaction authentication data independent of blockchain system 105, potentially in a different format, and typically again before a request to authenticate a potential transaction.

In one implementation, a validated holder address and associated transaction authentication data for a registered user can be submitted via an application program interface (API) associated with the blockchain. The token contract 110, the set of compliance contracts 111, another location on the blockchain system 105, or any combination thereof, can maintain this transaction authentication data for all validated holder addresses associated with users who have previously registered with curation system 140, as a key/value mapping, although other data structures are possible and are encompassed by the present disclosure as alternative embodiments. These validated holder addresses can be an external address, controlled directly by a private key, or a smart contract running on the BVM and controlled by an external address.

In one embodiment, the curation system 140 can maintain transaction authentication data for each registered user on the blockchain in a format so as to anonymize any registered user information beyond their validated holder address, so that no personal or private information of any registered user is exposed on the distributed blockchain ledger. In one embodiment, a collection of transaction authentication data for a set of registered users can include one or more data representations of categories, whether fundamental or composite, to which the curation system 140 can assign each registered user as derived from each registered user's relevant attributes according to a defined ruleset and the associated transaction authentication logic, specified for the token contract 110 or the set of compliance contracts 111, or a combination thereof, wherein the data representations of categories comprise one or more bitmasks, sets, maps and/or other data structures. In a similar embodiment, a collection of transaction authentication data for a set of registered users may include one of more data representations of binary attributes of for each registered user, wherein the data representation of binary attributes are comprised of one or more bitmasks, sets, maps and/or other data structures. In another embodiment, a collection of transaction authentication data for a set of registered users can include one or more data representations of categories of other registered users, whether fundamental or composite, with which the each registered user is allowed (or not allowed) to transact, according to a defined ruleset, wherein the data representations of the categories are comprised of one or more bitmasks, sets, maps and/or other data structures. In a similar embodiment, a collection of transaction authentication data for a set of registered users may include one of more data representations of binary attributes of other registered users with which each registered user is allowed (or not allowed) to transact, according to a defined ruleset, wherein the data representation of binary attributes are comprised of one or more bitmasks, sets, maps and/or other data structures.

In another embodiment, the transaction authentication data for each registered user can also include additional various transaction eligibility criteria, such as, for example, an expiration date for the user's registration information, a maximum allowed transaction size, which can be zero, and one or more lock status variables, possibly Boolean in nature, that can be used to indicate that a transaction is prohibited for the contract as a whole, or for a given validated holder address, including for sending tokens, for receiving tokens, or for both. The transaction authentication data for each registered user can also include a hash code or common address, which can be used, for example, to identify common ownership of the sending and receiving validated holder addresses so as to facilitate transfers of tokens between validated holder addresses belonging to a single entity.

In some embodiments, the curation system 140 can store on the blockchain system 105 a copy of a registered user's transaction authentication data independently associated with each of the registered user's validated holder addresses despite their common ownership. In additional embodiments, the curation system 140 can store on the blockchain system 105 a single instance of a registered user's transaction authentication data with an associated user identifier hash or common address and a list of validated holder addresses associated with the user identifier hash or common address, thereby avoiding redundant storage of a registered user's transaction authentication data on the blockchain system 105.

In a simple case, the attributes or other details of each registered user might represent a small dataset. For example, if the set of registered users span only six countries of residence, six countries of citizenship, and a binary investor attribute reflecting accredited and non-accredited status, then each registered user can be characterized by a total of thirteen binary attributes for a total of 2¹³ or 8,192 possible permutations.

If a registered user must have one and only country of residency and similarly, one and only one country of citizenship, and true or false for accredited, then the number of binary attribute permutations (and hence fundamental categories) reduces to only 72. Note that 72 is the number of the full Cartesian product of the three aforementioned sets of size six, six, and two, respectively. Then consider a 72×72 connection matrix with the 72 fundamental categories of potential senders as rows and the 72 fundamental categories of potential receivers as columns, which represents which sender fundamental categories are allowed to transact with which receiver fundamental categories, wherein a value of “1” (“0”) for an element of the 72×72 connection matrix indicates that senders assigned to the fundamental category (corresponding to the element's row index) and receivers assigned to the fundamental category (corresponding to the element's column index) are allowed (not allowed).

In practice, in some implementations there are likely to be enough attributes represented by the set of registered users that individual assessment or analysis of every possible distinct combination between two potential holders might be computationally unwieldy, in terms of memory storage and/or computational processing on the blockchain or the cost of writing the necessary data to a BVM, herein referred as a computational footprint.

Consider another example, wherein the connection matrix might be a very sparse matrix, such as might be the case when considering, for example, 200 countries of residence and 200 countries of citizenship where most of those countries either do not have constraints on transactions between their citizens or residents and others, or conversely do not allow their citizens or residents to participate in token transactions on a blockchain system. Such a connection matrix would also likely be sparse with the constraint that a registered user, whether a sender or receiver may have only nonzero binary attribute values for a limited number of countries of citizenship or residency, perhaps only one, for each of the two attribute types (such as one country of citizenship and one country of residency).

For efficient handling, binary attributes might be grouped together to define a new combined binary attribute such that registered user need only be identified as a member of some grouping of registered users via shared or similar binary attributes. For example, instead of having to track which of 200 countries of residence a registered user is subject to the jurisdiction of according to a defined ruleset via method 200 distinct simple binary attributes reflecting residency, it might only be necessary to track which of a few regions or groupings of countries of residence the registered user is associated, wherein each region or grouping of countries of residence is represented by a combined binary attribute.

As an example, a resident of a country in the EU (e.g., Germany, France, Sweden, Italy, etc.) could be assigned to a grouping representing all member countries of the EU, provided that all residents of EU member countries, have the same capacity to own, or ability to transact in, a token with other registered users. In this example, the plurality of simple binary attributes for being a resident of individual EU member nations could be compacted or grouped into one combined binary attribute for being a resident of one or more EU member nations.

The process of grouping of binary attributes to form one or more combined binary attributes can be accomplished by a series of Boolean arithmetic operations. Alternatively, as another example, due to potential variation in laws regarding blockchain financial instruments across states in the US, a US resident may also be assigned to a grouping of US states based on their state of residency wherein each grouping includes one or more US states with the same provisions governing token ownership and allowed transactions according to a defined ruleset. In either example, using the new groupings of countries (or states) of residency, results in a new set of combined binary attributes, and hence composite categories to which senders or receivers may be assigned by the curation system 140.

There are many such arrangements of groupings based on binary attributes that are possible to form combined binary attributes, not only for a binary attribute like “is resident of country A” but for other binary attributes as well. Furthermore, these arrangements of groupings based on binary attributes could be generalized to any subset of the Cartesian product of all sets of binary attributes. In some embodiments, the selection of which subsets of the Cartesian product of all possible sets of binary attributes to form new combined binary attributes via various groupings is made with regards to reducing the number of resultant composite categories, and perhaps thereby reducing the computational footprint while still fulfilling the requirements of the defined ruleset.

The transaction authentication data for a registered user and their associated validated holder addresses can also include a set of one or more categories, derived from attributes for the registered user and associated with a defined ruleset, to which the registered user is assigned. In one embodiment, wherein the set of attributes characterizing a registered user according to a defined ruleset have been reduced to, or otherwise represented in terms of, a set of binary attributes, the collection of values of the associated binary attributes for a registered user are a fundamental category, i.e., one of the 2^{N} possible binary permutations (where N is the number of binary attributes), to which the registered user is assigned, and will also be referred to herein as a fundamental attribute mapping. In another embodiment, if certain simple binary attributes are combined together via Boolean arithmetic, then the collection of values of the new set of combined binary attributes for a registered user are a composite category, i.e., one of a new set of permutations, sometimes of potentially different length than those associated with fundamental categories, to which the registered user is assigned, and will also be referred to herein as a composite attribute mapping. For the sake of brevity, both fundamental mapping and/or composite attribute mapping might be referred to as “attribute mapping”.

In another embodiment, an attribute mapping, whether fundamental or composite, may comprise one or more bitmap integers. In yet another embodiment, the collection of bitmap integers that represent an attribute mapping may be considered as a single ordered collection of attribute bits, referred to herein as an attribute bitmask. In other embodiments, the collection of bitmap integers that represent an attribute mapping may be represented by set of attribute bitmasks. In some embodiments, registered users are assigned to the same attribute mapping with the same attribute bitmask. In other embodiments, there may be many attribute mappings, fundamental or composite, to which no registered user is assigned from a set of registered users.

In another embodiment, an attribute mapping, whether fundamental or composite, may represent a fundamental or composite category, to which a registered user is assigned or belongs to (a “membership” attribute mapping), wherein a membership attribute mapping represents a collection of binary attributes, whether combined or simple, that characterize the registered user according to the defined ruleset, and comprises one or more bitmap integers, thereby constituting a “membership” attribute bitmask.

In another embodiment, an attribute mapping, whether fundamental or composite, may represent a collection of binary attributes, whether combined or simple, that characterize or indicate a set (possibly empty) of registered users, with corresponding validated holder addresses, assigned to a collection of categories, according to a defined ruleset, to which a registered user is allowed to transact involving a token (a so-called “permissive” attribute mapping), wherein a permissive attribute mapping comprises one or more bitmap integers, thereby constituting a so-called “permissive” attribute bitmask. In yet another embodiment, an attribute mapping, whether fundamental or composite, may represent a collection of binary attributes, whether combined or simple, that characterize or indicate a set (possibly empty) of registered users, with corresponding validated holder addresses, assigned to a collection of categories, according to a defined ruleset, to which a registered user is not allowed to transact involving a token (a so-called “restrictive” attribute mapping), wherein a restrictive attribute mapping comprises one or more bitmap integers, thereby constituting a so-called “restrictive” attribute bitmask. Herein, for the purpose of describing the invention, membership (or alternatively “member”) attribute mappings and bitmasks are considered to be the “dual of” or “dual to” permissive (or restrictive) attribute mappings and bitmasks, in that they could be counterparts to another in an operation of the transaction authentication logic. On the other hand, two membership attribute mappings (and their corresponding bitmasks) are not a dual to one another. Similarly, permissive and restrictive attribute mappings (and their corresponding bitmasks) are not dual to one another, nor are two permissive or two restrictive attribute mappings (and their corresponding bitmasks).

In one embodiment, a permissive (or restrictive) attribute bitmask can be constructed by taking the union (i.e., logical OR) of the individual attribute bitmasks of each fundamental or composite category with which a register user is allowed (or not allowed) to transact. For example, returning to the previously described example, where there are six binary attributes for country of citizenship, six binary attributes for country of residency, and one binary attribute for accredited status, and requiring that a registered user must be a citizen of one and only one country, a resident of one and only one country, and either accredited or non-accredited, there will again be 72 fundamental categories to which registered users will be assigned.

Now suppose that the first country of residency binary attribute is “resident of an EU member nation”, and the other country of residency binary attributes in order, from second to sixth, are “resident of the U.S.”, “resident of Singapore”, “resident of country X”, “resident of Japan”, and “resident of Canada”. Furthermore, suppose that residents of an EU member nation are allowed to transfer a nonzero amount of a token to the validated holder addresses of residents of Singapore, Japan and Canada, but not the U.S. or country “X”.

Continuing the same example, assume that the first country of citizenship binary attribute is “citizen of an EU member nation”, and the other country of citizen binary attributes in order, from second to sixth, are “citizen of US”, “citizen of Singapore”, “citizen of country X”, “citizen of Japan”, and “citizen of Canada”. Furthermore, suppose that citizens of an EU member nation are allowed to transfer a nonzero amount of a token to the validated holder addresses of residents of US, Singapore, Japan and Canada, but not of country “X”. And finally, there is a single binary attribute for “is accredited”. Then according to the defined ruleset described for this example, a registered user who, for example, is a non-accredited citizen and resident of an EU member nation, may transfer a nonzero amount of a token to the validated holder addresses of registered users who are not-country “X” citizens and residents of either a EU member state, Singapore, Japan, or Canada, irrespective of their accreditation status.

Continuing with this same example, the membership attribute bitmask of this registered user could be represented as a single bitmap integer with the value of 1000001000000, wherein the first six bits denote country of citizenship, and being a citizen of the EU, the first bit is assigned a “1”, and the next six bits denote country of residency, and being a resident of the EU, the seventh bit is assigned a “1”, and being non-accredited, the thirteenth and final bit is set to zero. Now consider a possible permissive attribute bitmask for such a registered user. For this example, the permissive attribute bitmask of a registered user who is a non-accredited citizen and resident of an EU member nation, may be a single bitmap integer with a value of 11101110101111, wherein the first six bits represent the union of the allowed countries of citizenship binary attributes for this registered user, the next six bits represent the union of the allowed country of residency binary attributes for this registered user, and the last two bit are both set to “1”, since, so far in this example, the accreditation status of other registered users potentially involved in a transaction does not affect the ability of this registered user to transact with them via their validated holder addresses.

The last two bits in the permissive attribute bitmask denote that this registered user can transact with the validated holder addresses of other registered users who are accredited (thirteenth bit set to “1”) or who are non-accredited (the last bit set to “1”). Note, the fourth bit is zero, because this registered user cannot transact with validated holder addresses of country “X” citizens regardless of other factors, and the eight and tenth bits are zero because this registered user cannot transact with the validated holder addresses of residents of the U.S. or country “X”. Since the membership attribute bitmasks of other registered users will likely be also a length 13 bitmap integer, in this example, and the permissive attribute bitmask is a bitmap integer of length 14, it may be necessary to pad the membership attribute bitmasks with a fourteenth bit set to “1”, as needed to align with the length 14 bitmap integers representing the various permissive attribute bitmasks of others, as required by the sequence of operations performed by the transaction authentication logic of the transaction rule compliance engine. Similarly, a restrictive attribute bitmask for this registered user may be a single bitmap integer with a value of 00010001010000, wherein the bits that are set to “1” reflect that this registered user cannot transact with validated holder addresses of either country “X” citizens, U.S. residents, or country “X” residents.

In this example, the transaction authentication associated with one or more validated holder addresses is anonymized for the registered user, in that, besides the validated holder addresses themselves, the various attribute bitmasks, though derived from the registered user's registration information, which may contain one or more data elements that are personal or private, by the curation system 140 and according to the defined ruleset, do not themselves contain personal or private information, such as name, physical address, contact information, social security (or equivalent) number, e-mail address, etc.

In one embodiment, there may be one or more bitmap integers which form an attribute bitmask. In another embodiment, the number of bitmap integers which form an attribute bitmask may depend on the number of different types of binary attributes. Continuing with the same example, according to these embodiments, the number of bitmap integers that constitute the membership, permissive attribute bitmasks, and restrictive attribute bitmasks, is three based on there being three types of binary attributes: country of citizenship, country of residency, and being accredited. For example, the membership attribute bitmask of a registered user, who is a non-accredited citizen and resident of an EU member nation, could then be represented by three bitmap integers with values of 100000 (reflecting citizenship attributes), 100000 (reflecting residency attributes), and 0 (reflecting accreditation), of length six, six, and one bit(s), respectively, or in the case of padding a fourteenth bit with a “1” for alignment purposes, three bitmap integers with binary values of 100000 (reflecting citizenship attributes), 100000 (reflecting residency attributes), and 01 (reflecting accreditation with padding), of length six, six and two bits, respectively. Similarly, according to the same embodiment, the permissive attribute bitmask, could be represented as three bitmap integers with binary values of 111011, 101011, and 11, of length six, six and two bits, respectively, each corresponding to the same respective attribute types as with the three bitmap integers representing the membership attribute bitmask. Similarly, according to the same embodiment, the restrictive attribute bitmask, could be represented as three bitmap integers with binary values of 000100, 010100, and 00, of length six, six and two bits (assuming padding with a fourteenth bit), respectively, each again corresponding to the same respective attribute types as with the three bitmap integers representing the membership attribute bitmask (or permissive attribute bitmask).

Now consider extending this same example to encompass accredited status in a different manner. Suppose that a registered user who is a non-accredited citizen and resident of an EU member nation may actually transfer a nonzero amount of a token to the validated holder addresses of registered users who are U.S. residents, provided the U.S. residents are also accredited (i.e., the “is accredited” binary attribute is set to true). Note for secondary trading of a regulated security issued under Reg S and Reg D exemptions, within the first year post-issuance, this may not generally be permitted according to U.S. securities laws, but this example is purely for illustrative purposes for this description. Furthermore, assume that only the U.S. and Singapore have restrictions according to the defined ruleset to residents, irrespective of their citizenship, being accredited (or qualified), but in the case of Singapore, a registered user who is a non-accredited citizen and resident of an EU member nation may transfer a nonzero amount of a token to the validated holder addresses of registered users who are residents of Singapore, irrespective of their being accredited (or qualified). Now define four new combination binary attributes, one being “is accredited and U.S. resident”, another being “is not accredited and U.S. resident”, yet another being “is accredited and Singapore resident”, and finally another being “is not accredited and Singapore resident”. Instead of 13 bits in length, the new composite attribute bitmasks would be 6+8+0=14 bits in lengths, wherein the first six bits are still for countries of citizenship, the next eight are for countries of residency, including four new combined binary attributes between residency and accreditation, and the previous simple binary attribute for accreditation is no longer necessary as it has been combined with the applicable jurisdictions of U.S. and Singapore residency.

Continuing with this same extended variant example, the membership attribute bitmask for a registered user who is a non-accredited citizen and resident of an EU member nation could be represented as a single bitmap integer with the binary values of 10000010000000, wherein the first six bits denote country of citizenship, and being a citizen of the EU, the first bit is assigned a “1”, and the next eight bits denote country of residency and accreditation combined binary attributes for this registered user, who since being a (non-accredited) resident of the EU, the seventh bit is assigned a “1”. Similarly, the permissive attribute bitmask for this same registered user including the new set of combined binary attributes, may be a single bitmap integer with binary values as follows: 11101111011011, wherein the first six bits represent the union of the allowed countries of citizenship binary attributes for this registered user, the next eight bits represent the union of the allowed country of residency and accreditation combined binary attributes for this registered user. Note, the fourth bit is zero, because this registered user still cannot transact with validated holder addresses of country “X” citizens regardless of other factors, and the eight bit is “1” because this registered user can transact with the validated holder addresses of an accredited U.S. resident, the ninth bit is “0” because this registered user cannot transact with the validated holder addresses of a non-accredited U.S. resident, the tenth and eleventh bits are “1” because this registered user can transact with the validated holder addresses of both accredited or non-accredited residents Singapore, the twelfth bit is “0” because this registered user cannot transact with validated holder addresses of a country “X” resident regardless of other factors, and the last two bits are set to “1” because this registered user is allowed to transact with the validated holder addresses of residents of Japan or Canada.

Continuing with this same extended variant example, similarly, a restrictive attribute bitmask for this registered user with the new set of combined binary attributes, may be a single bitmap integer with binary values as follows: 00010000100100, wherein the bits that are set to “1” reflect that this registered user cannot transact with validated holder addresses of either country “X” citizens, non-accredited U.S. residents, or country “X” residents, but transactions with the validated holder addresses of accredited or non-accredited Singapore residents are not disallowed (“0” value for bits number 9 and 10 in the bitmap integer). Again, it should be stated that these examples are purely illustrative and should in no way be viewed as interpretations of national securities laws or financial regulations. In this extended variant example, according to one embodiment, the number of bitmap integers that constitute the membership, permissive attribute bitmask, and restrictive attribute bitmasks, could be two based on there being two types of binary attributes: country of citizenship, and country of residency in combination with accreditation.

For example, the membership attribute bitmask of a registered user, who is a non-accredited citizen and resident of an EU member nation, could then be represented by two bitmap integers with values of 100000 (reflecting citizenship attributes) and 10000000 (reflecting combined residency and accredited attributes), of length six and eight bits, respectively. Similarly, according to the same embodiment, the permissive attribute bitmask of this registered user could be represented as two bitmap integers with binary values of 111011 and 11011011, of length six and eight bits, respectively, each corresponding to the same respective attribute types as with the two bitmap integers representing the membership attribute bitmask. Similarly, according to the same embodiment, the restrictive attribute bitmask of this registered user could be represented as two bitmap integers with binary values of 000100 and 00100100, of length six and eight bits, respectively each again corresponding to the same respective attribute types as with the two bitmap integers representing the membership attribute bitmask (or permissive attribute bitmask).

In one embodiment, in which the binary attributes are selected to have regulatory significance for a token, whether for an individual or organization, the binary attributes can represent membership in one or more of the following: country/countries of citizenship, country/countries of residency, country/countries in which the registered user pays taxes, accredited or qualified class(es) for individuals and organizations, such as a status, in one or more particular jurisdictions (including status as accredited, qualified, a broker, or a qualified institutional buyer), fulfillment of one or more regulatory requirements by the registered user, an indication that the validated holder address is owned by the issuer of the token or an individual otherwise affiliated with the issuer of the token, and/or similar or related classes, and/or other categories determined to be relevant or of interest for the transaction as per the defined ruleset.

It will be appreciated, however, that an issuing entity can employ a defined ruleset for use in any of a number of applications, including limiting ownership of tokens to an intended set of potential holders, as might be useful for tokens representing shares of a closely held corporation or similar entity, to enforce contractual terms, or other appropriate applications.

For a registered user, the curation system 140 can generate the user's membership in or assignment to an element of a set of fundamental or composite categories, according to a defined ruleset, represented in the transaction authentication data for the registered user as one or more attribute mappings with associated attribute bitmasks. In one embodiment, the curation system 140 can assign a (first) membership attribute bitmask to a registered user, reflecting membership or assignment of a registered user to an element of a set of categories according to a defined ruleset and derived from registration information. In other embodiments, the curation system 140 can generate and assign additional attribute bitmasks, such as a (second) permissive attribute bitmask, which can characterize or indicate with which categories, according to a defined ruleset, a registered user is allowed to transact, as well as a (third) restrictive attribute bitmask, which can characterize or indicate with which categories, according to a defined ruleset, a registered user is not allowed to transact.

In alternative embodiments, in order to characterize registered users according to a defined ruleset governing the ownership or transfer of a particular security, a curation system 140 employs a directed graph to represent the set of categories, whether fundamental or composite, to which registered users are assigned, derived from each registered user's relevant binary attribute, based on their registration information and according to a defined ruleset. Such a directed graph may comprise a set of category nodes, wherein each category node directly corresponds to a category, whether fundamental or composite, and each directed edge exists between a pair of category nodes if and only if the registered users assigned to the source category node of each directed edge are allowed to transfer a nonzero amount of a token to, or otherwise transact with, registered users assigned to the category node at the destination of the directed edge, according to a defined ruleset.

In one embodiment, the category node at the source of a directed edge represents the associated registered users as senders in a potential transfer or transaction, while the category node at the destination of a directed edge represents the associated registered users as receivers in a potential transfer or transaction. In such a directed graph, a category node may be connected to one or more other category nodes with one or more directed edges, being potentially the source node for some edges or the destination node for others. Furthermore, some category nodes may have a directed edge that loops back on itself (i.e., a “self-edge”), meaning it is both the source node and destination node for the edge, implying that registered users assigned to the category node are able to transfer a nonzero amount of a token to, or otherwise transact with, other registered users, possibly including themselves, assigned to the same category node, according to a defined ruleset. In such a directed graph, one or more category nodes may be disconnected from all other category nodes, meaning that registered users assigned to a disconnected category node cannot transfer a nonzero amount of a token to registered users assigned to other category nodes, according to a defined ruleset. Moreover, some disconnected category nodes may not even have a self-edge, meaning that registered users assigned to such category nodes cannot even transact with other registered users assigned to the same category node, and potentially not even transfer tokens between their own validated holder addresses.

In one embodiment, according to such a directed graph of category nodes, transactions are to be allowed by a transaction rule compliance engine 112, if and only if, according to the defined ruleset, there is a directed edge between the category node to which the sender of the transaction is assigned (sender node) and the category node to which the receiver of the transaction is assigned (receiver node), wherein the sender node is the source node for the directed edge and the receiver node is the destination node for the directed edge. Similarly, if there is no directed edge between the sender node and receiver node, wherein the sender node is the source node for the directed edge and the receiver node is the destination node for the directed edge, then the transaction rule compliance engine 112 prohibits the transaction.

In one embodiment, featuring the use of such a directed edge graph, the curation system 140 constructs the directed edge graph based on the relevant attributes of registered users from their registration information and according to a defined ruleset, and then the transaction rule compliance engine 112 retrieves the transaction authentication data for the sender and for the receiver of the potential transaction, in order to determine the corresponding sender and receiver nodes, which could potentially be one and the same, and then, the operations of the transaction authentication logic are reduced to a simple lookup or other procedure to ascertain if there is the appropriate directed edge between the corresponding sender and receiver nodes for the transaction under scrutiny, including a self-edge if assigned to the same category node, without possibly the need for various bitwise or other logical operations, besides consideration of additional various transaction eligibility criteria, which may still prohibit a transaction even if the appropriate directed edge is found in the directed graph.

In one embodiment, in order for the curation system 140 to construct such a directed graph, the curation system 140 first constructs an initial fundamental directed graph, wherein each category node uniquely corresponds to one fundamental category corresponding to one and only one of the distinct 2^{N} permutations (where N is the number of binary attributes) and wherein directed edges are placed between fundamental category nodes, if and only if registered users assigned to the sender node of a directed edge are allowed to transfer a nonzero amount of a token to, or otherwise transact with, registered users assigned to the receiver node of the same directed edge, according to a defined ruleset. Since the relevant attributes of any registered user can be reduced to a finite number of binary attributes (i.e., N) and there are a finite number of all possible permutations (i.e., 2^{N}) of these N binary attributes, so-called fundamental categories, and, if counting possible self-edges, there at most N², directed edges, then the initial fundamental directed graph is finite. Furthermore, for a given set of N binary attributes associated with a defined ruleset, governing ownership and allowed transactions of a token, there will always be a fundamental directed graph, comprising 2^{N} fundamental category nodes and with a subset, possibly zero, or all of the N² possible directed edges, provided the set of N binary attributes can fully represent registered users according to the stipulations set forth in the defined ruleset.

In another embodiment, the initial fundamental directed graph comprises a subset of the 2^{N} fundamental category nodes, wherein a fundamental category node is only part of the initial fundamental directed graph if there is at least one registered user from the set of registered users that is assigned to the corresponding fundamental category based on the values of their N binary attributes derived from their registration information. Again, this occupied fundamental directed graph is finite and generally of smaller size with fewer fundamental category nodes and fewer directed edges, than its counterpart maximal fundamental directed graph constructed from all possible fundamental categories, wherein the number of associated registered users is not considered.

As an example, consider the prior example of a set of registered users described by thirteen binary attributes, comprising six countries of citizenship, six countries of residency, and one binary attribute for accreditation. In this case the maximal fundamental directed graph would have a total of 8,192 fundamental categories each correspond to one of the 2¹³ possible permutations of the thirteen binary attributes. However, with the added restriction that a registered user must have one and only country of residency and similarly, one and only one country of citizenship, and true or false for accredited, this reduces to at most 72 permutations. Now further suppose that in the set of registered users, there is at least one registered user with a value of “1” for one of the first three citizen binary attributes and with a value of “1” for one of any of the six residency binary attributes that are accredited, and another that is otherwise the same but for non-accredited. Continuing with this example, further suppose that in the set of registered users there is at least one registered user with a value of “1” for one of the fourth, fifth, and sixth citizen binary attributes and with a value of “1” for only the fourth, fifth, and sixth residency binary attributes that is non-accredited. Then the occupied fundamental directed graph would comprise only 3×6×2+3×3×1=45 fundamental category nodes. Clearly, an occupied fundamental graph with 45 fundamental category nodes, and the associated directed edges according to a defined ruleset, will be much smaller in terms of computational footprint for use on a computational system, including a BVM, than its counterpart maximal fundamental directed graph with 8192 fundamental category nodes.

In one embodiment, the fundamental category nodes of a fundamental directed graph, whether occupied or not, can be represented by a data structure such as a list or a map. In another embodiment, the set of directed edges of a fundamental directed graph, can be represented by a K×K connection matrix, C, wherein K is the number of fundamental category nodes, possibly restricting to occupied corresponding fundamental categories, each row is indexed by one of the K fundamental category nodes, the columns are similarly indexed using the same ordering, such that then all possible directed edges from an i^{th} sender node to a j^{th} receiver node (where 1≤i, j≤K), can be represented by the matrix element (i, j) of C (i.e., Cᵢⱼ) and assigned a value of “1”, i.e., Boolean true, if the corresponding directed edge reflects an allowed transaction, and assigned a value of “0”, i.e., Boolean false, if the corresponding directed edge is missing or otherwise reflects a prohibited transaction. In the aforementioned K×K connection matrix, C, matrix element Cᵢⱼ signifies if there is a directed edge between the i^{th} sender node to a i^{th} receiver node, while Cⱼᵢ signifies if there is a directed edge between the j^{th} sender node to a i^{th} receiver node (again where 1≤i, j≤K). If for every i^{th} sender node (where 1≤i≤K) has a self-edge, i.e., Cᵢᵢ=1, meaning the diagonal matrix elements of the connection matrix have a value of “1” or true, then the fundamental directed graph is said to be reflexive in that it obeys the reflexive property. If for every i^{th} sender node and j^{th} receiver node (where 1≤i, j≤K) that has a directed edge, i.e., Cᵢⱼ=1, the transpose matrix elements of Cⱼᵢ=1 also, meaning that the corresponding j^{th} sender node and i^{th} receiver node (where 1≤i, j≤K) have a directed edge between them then the fundamental directed graph is said to be symmetric in that it obeys the symmetric property. Note that for some defined rulesets, the reflexive and/or symmetric properties may not hold. Generally, according to most defined rulesets, the property of transitivity, if Cᵢⱼ=1, and Cⱼₖ=1 then Cᵢₖ=1, does not hold, regardless if reflexivity or symmetry do.

In one embodiment, in order for the curation system 140 to construct a functional directed graph that satisfies the defined ruleset while reducing the computational footprint of the directed graph and/or its corresponding connection matrix, the curation system 140 first constructs an initial fundamental directed graph, possibly the occupied fundamental directed graph previously discussed, and applies a sequence of merge operators to pairs of category nodes of the directed graph, whether fundamental or composite, to form new composite category nodes. In order to comply with a defined ruleset, two category nodes, whether fundamental or composite, can be merged if and only if three conditions are satisfied: (a) the two category nodes have the identical set of directed edges to other category nodes (outside of the two under consideration for merging) in the directed graph, (b) if one of the two category nodes has a self-edge, then the other one must as well, and (c) if the two category nodes both have self-edges then there must be two directed edges, one for each opposing direction, between the two category nodes, or otherwise the two category nodes both do not have self-edges then there must be no directed edge in either direction between the two category nodes.

Effectively the requirement is that if two category nodes can be merged, then the registered users assigned to both category nodes are considered equivalent under the provisions of the defined ruleset, and can be combined into a new composite category node, with the need to preserve only one copy of their edges. In one embodiment, the process can be continued, by testing all possible pairs of category nodes for potential merging until finally no pairs of category nodes, whether fundamental or composite, satisfy all three conditions, and therefore cannot be merged. The result of merging is a new composite directed graph, wherein the new directed graph contains at least one composite category node, since at least one pair of fundamental category nodes were combined to form a new composite category node. If the process is continued until all possible merging of category nodes is completed, the final resultant composite directed graph is considered to be the final reduced directed graph of the initial fundamental directed graph, which presumably has fewer substituent category nodes and directed edges, and thus smaller computational footprint.

The equivalent three conditions in terms of the corresponding K×K connection matrix, C, would be that for two category nodes for rows i and j (where 1≤i, j≤K): (a) the values Cᵢₖ and Cⱼₖ are all equal, as are the values Cₖᵢ and Cₖⱼ, for all possible values of k (where 1≤k≤K) provided that k≠i or j, (b) if Cᵢᵢ=1 then Cⱼᵢ=1 and vice-versa, and (c) if Cᵢᵢ=Cⱼⱼ=1, then Cᵢᵢ=Cⱼᵢ=1, otherwise if Cᵢᵢ=Cⱼⱼ=0, then Cᵢⱼ=Cⱼᵢ=0. In one embodiment, after merging nodes i and j, the j^{th} row and j^{th} column can be all zeroed out in order to remove redundant information, leaving the i^{th} row and i^{th} column unchanged. In another embodiment, after merging nodes i and j, the j^{th} row and j^{th} column can be removed altogether, resulting in new reduced (K−1)×(K−1) connection matrix.

In another embodiment, the ordering in which potential merging is assessed by the curation system 140, starts from the first category node and attempts to pair it with all other category nodes, merging when possible until the process for the first (perhaps now composite) category node is exhausted, then finding the next available category node and repeating the process merging when possible until that process for the next category node also is exhausted, and continuing in this fashion until all available category nodes have been fully explored for possible merging. In another embodiment, the first category node is chosen at random by the curation system 140 from those available. In yet another embodiment of the curation system 140, the ordering is arbitrary and the assessment for merging operations can be done in any order, so long as the process is terminated only when none of the remaining category nodes can be merged with one another under the provisions/restrictions of the defined ruleset, and thereby the final result is the final reduced directed graph according to the defined ruleset. The corresponding connection matrix of the final reduced directed graph is referred to herein as the reduced connection matrix.

Directed graphs, including the final reduced directed graph, can be represented and implemented in computer code in multiple ways for use in the transaction rule compliance engine 112. In one embodiment, a list or array of category sender nodes is stored, and a map is used to associate for each sender category node a list or array of connected receiver category nodes, each via a directed edge under the defined ruleset. In another embodiment, a pairing of a sender category node and receiver category node involved in a potential transaction is mapped (perhaps using a hash function) to a true (permissive) or false (not allowed) value. In another embodiment, a pairing of a sender category node and receiver category node involved in a potential transaction is mapped (perhaps using a hash function) to a non-Boolean value representing a condition of the transaction, such as a maximum allowed trade size for the pairing, which in turn can be applied by the transaction rule compliance engine 112, by checking the relevant token transaction information as described below. In another embodiment, a set could be pre-constructed containing all permitted pairings of potential sender category nodes and receiver category nodes, for example from the final reduced directed graph, and a potential pairing of a sender category node and receiver category node is searched in the set, and only permitted if a match is found. In a similar embodiment, a set could be pre-constructed containing all prohibited pairings of potential sender category nodes and receiver category nodes, for example from the final reduced directed graph, and a potential pairing of a sender category node and receiver category node is searched in the set, and only permitted if a match is not found.

In another embodiment, the connection matrix, including the reduced variant, is directly put into storage for access by the transaction rule compliance engine 112. In one embodiment, the (reduced) connection matrix is represented by a two-dimensional array including matrix elements with both “1”s and “0”s. In yet another embodiment, similar data structures used to represent the (reduced) directed graph are used instead for the rows and columns of the (reduced) connection matrix.

The (reduced) directed graph could instead be constructed and utilized by reversing the meaning of a directed edge between a sender category node and a receiver category node from an allowed transaction to a prohibited transaction. In yet another embodiment, the connection matrix could instead of Boolean values, assign a “1” for an allowed edge, a “−1” for a prohibited edge, and a “0” to represent no information available, to be used appropriately according the defined ruleset.

Another aspect of the curation system 140 employing a directed graph to represent the set of categories, whether fundamental or composite, to which registered users are assigned, derived from each registered user's relevant binary attribute, based on their registration information and according to a defined ruleset, is how such a directed graph could be updated when certain information changes, various requests are made, or triggers occur. In one embodiment, if a registered user's registration information changes in such a way that their binary attributes are altered and their assigned category is now different, or alternatively some other associated condition has been met (e.g., a vesting period has ended), then either the curation system 150 assigns the registered user to an another existing category represented by an another appropriate existing category node in the directed graph, or to a new category which is represented by a new category node that the curation system 140 inserts into the directed graph, recognizing that the new category node may be disconnected, with or without a self-edge. If assigned to another existing category node, there are no changes to the directed graph in terms of nodes and directed edges. However, if assigned to a new category node, then new directed edges are added to the graph (unless the new category node is disconnected with no self-edge), connecting to and from the new category node according to the defined ruleset in relation to other existing category nodes in the directed graph.

In one embodiment, if instead a new registered user is to be added, then this parallels the above scenario when an existing registered user's registration information changes in such a way that their binary attributes are altered and their assigned category is changed so that the new registered user is either assigned to an existing category node or a new category node must be inserted, along with new directed edges to and from the new category node.

In one embodiment, if instead a registered user's registration information has expired, then the registered user is placed into an existing (or new, if no applicable one exists) disconnected node with no self-edge, reflecting their inability to participate in any token transaction until such a time as their registration information is renewed, wherein the registered user is potentially restored to their original category node (if it still exists) or assigned to a new category node, if the renewal of their registration information either precipitated a change in their assigned category or their original category node was removed (perhaps due to zero occupancy). In a specific (and potentially rare) embodiment, if a registered user is to be removed from the system, then potentially a category node and its associated directed edges may be removed, provided there are no other registered users assigned to that category node.

In most embodiments involving a directed graph, it would likely be easier to reassign such registered users to a new or existing disconnected category node with no self-edge until such a time as their status may change. An example of this may be when a registered user reports that their private key is reported missing, stolen, or forgotten, in which case they can be reassigned to their original category node in the directed graph, when their private key is recovered. Another example of this may be if a registered user requests that their validate holder addresses be locked from participating in transaction for a time.

In another embodiment, if there is a change to applicable securities regulations occurring in one or more relevant jurisdictions and hence changing the defined ruleset, there could be changes to the binary attributes of some (or all) of the set of registered users and hence for some (or all) of the assigned categories and hence their corresponding category nodes, as well as the addition or removal of directed edges for existing nodes. In some embodiments, if a category node corresponds to a category, whether fundamental or composite, to which no registered user is assigned (i.e., unoccupied) the category node and its connected directed edges are removed from the directed graph. In some embodiments, if the number of alterations of the directed graph is significant in terms of nodes or directed edges, the curation system 140 can update the directed graph by reinitiating a process of merging category nodes until completion to form a new reduced graph. In another embodiment, such a large scale change of the directed graph is triggered when certain time periods associated with token transactions have passed, such as, for example, the end of the one-year moratorium on secondary trading back to non-accredited residents of the U.S. for a security issued under a Reg S exemption.

In a preferred embodiment, the curation system 140 assigns each registered user to a category node of an initial fundamental directed graph based on the registered user's binary attributes via their registration information and according to the defined ruleset governing ownership and allowed transactions of a token. Then a final reduced directed graph is then constructed according to the defined ruleset by iteratively merging category nodes in order to reduce the computational footprint, and then using a one or more suitable data representations (of the directed graph or its corresponding connection matrix) is encoded by a set of instructions and data, as part of the token contract 110, the set of compliance contracts 111, or a combination thereof, and accessible to the transaction rule compliance engine 112 executing on a BVM. In a preferred embodiment, the data representing the final reduced graph (or its connection matrix) may include a mapping of each sender category node to a set of allowed receiver categories nodes. In some variants of the preferred embodiment, the data representing the final reduced graph (or its connection matrix) may contain a set of category pairings of allowed senders and receivers. In some variants of the preferred embodiment, the data representing the final reduced graph (or its connection matrix) may contain a mapping of each allowed pair of senders and receivers to an additional data field, which could contain auxiliary data such as a maximum allowed amount of a token transfer or other type of restriction.

In some embodiments, the relevant transaction authentication data generated by the curation system 140 for a registered user and written to the blockchain ledger as part of the token contract 110, the set of compliance contracts 111, or a combination thereof, comprises an association between the validated holder addresses of the registered user and the category node in the final reduced graph to which they are assigned. In some embodiments, for the purposes of authenticating a potential transaction, the transaction rule compliance engine 112, contains the necessary execution instructions and data to access and make use of the encoded data representation(s) of the final reduced directed graph, accesses the transaction authentication data for each of the transaction participants, based on the sender holder address and the receiver holder address, and uses the existence (or non-existence) of a directed edge in the final reduced directed graph between the associated sender and receiver category nodes (along with various transaction eligibility criteria) to determine if, according to the defined ruleset, the transaction is to be allowed (or prohibited). In such an embodiment, category nodes can be connected to themselves (i.e., have a self-edge) signifying that the subset of registered users assigned to the same category node in the final reduced directed graph can transact with other registered users of the same subset, including with themselves, making it possible to transfer from one holder address of the sender to another holder address of the same sender.

In one embodiment, for each transaction provided to the token contract 110, the transaction rule compliance engine 112 can retrieve transaction authentication data from the distributed ledger of blockchain system 105 for each participant in a transaction. Then the transaction rule compliance engine 112 can apply transaction authentication logic to the retrieved transaction authentication data to determine if a transaction is permitted pursuant to a defined ruleset governing token ownership and allowed transactions for the token contract 110. The transaction rule compliance engine 112 can then take steps to allow (or deny) a transaction based on this determination.

As used herein, transaction authentication logic refers to a sequence of logical operations executed on the transaction authentication data of each transaction participant by a component of the BVM. For example, the logical operations can be bitwise operations applied to operands that are sets of bits or Boolean operators or combinations thereof. It will be appreciated that, unlike transaction authentication data, transaction authentication logic programmed for a token contract (or set of compliance contracts) cannot be changed without replacing the token contract (or a set of one or more compliance contracts) with an alternate token contract (or a set of one or more compliance contracts) on the BVM. It will also be appreciated that efficient execution of transaction authentication logic is important on many BVMs so as to minimize transaction processing costs and reduce computational footprint.

As an example of transaction authentication logic, the transaction rule compliance engine 112 can retrieve a (first) membership attribute bitmask representing membership or assignment, for a registered user who is the requested recipient of a nonzero amount of tokens, to an element of a set of fundamental or composite categories, according to a defined ruleset, to which the potential receiver belongs. Similarly, the transaction rule compliance engine 112 can retrieve a (second) permissive (or restrictive) attribute bitmask, for a registered user who is the requested sender of a nonzero amount of tokens, that indicates with which categories, according to a defined ruleset, the potential sender is allowed (or not allowed) to transact. In one embodiment, the first and second attribute bitmasks can be cryptographically encoded. It will be appreciated that the curation system 140 can generate the first and second attribute bitmasks in such a way that the first (membership) attribute bitmask aligns with the second (permissive/restrictive) attribute bitmask, wherein the term “aligns” means that both attribute bitmasks have the same ordering of attribute bits and the same length. In one embodiment, the transaction rule compliance engine 112 can apply transaction authentication logic in the form of a bitwise AND operation between the first (membership) attribute bitmask and the second (permissive/restrictive) attribute bitmask to determine a correspondence between the category membership of the receiver to the transaction permissions (or restrictions) of the sender.

In another embodiment, the curation system 140 can generate the first and second attribute bitmasks in such a way that the first (membership) attribute bitmask is comprised of a plurality of bitmap integers, each of which aligns with counterparts from a second plurality of bitmap integers, with the same number as for the first plurality for the first (membership) attribute bitmask, that constitute a second (permissive/restrictive) attribute bitmask. In yet another embodiment, the transaction rule compliance engine 112 can apply transaction authentication logic in the form of a bitwise AND operation applied to each constituent bitmap integer of the first (membership) attribute bitmask and an associated aligned counterpart constituent bitmap integer of the second (permissive/restrictive) attribute bitmask, and then performing a logical AND on each of the results of the bitwise AND operations (themselves bitmap integers) to achieve a final result. In some embodiments, the determination of an associated aligned counterpart constituent bitmap integer of the second (permissive/restrictive) attribute bitmask, for a constituent bitmap integer of the first (membership) attribute bitmask, is predicated on being for the same type of binary attribute, whether simple or combined.

In one embodiment, the first attribute bitmask and the second attribute bitmask can be cryptographically encoded.

It will be appreciated that the curation system 140 can generate the first and second attribute bitmasks in such a way that the first (membership) attribute bitmask aligns with the second (permissive/restrictive) attribute bitmask, in that both attribute bitmasks have the same ordering of attribute bits and the same length. In one embodiment, the transaction rule compliance engine 112 can apply transaction authentication logic in the form of a bitwise AND operation between the first (membership) attribute bitmask and the second (permissive/restrictive) attribute bitmask to determine a correspondence between the category membership of the receiver to the transaction permissions (or restrictions) of the sender.

In one exemplary embodiment, the curation system 140 can generate the first and second attribute bitmasks such that if the receiver is a member of any category with which the sender is permitted to engage in a transaction, then the transaction authentication logic results in the transaction being permitted. For example, the transaction authentication logic might comprise a bitwise AND operation between the first (membership) and second (permissive) attribute bitmasks, and the transaction is permitted for any nonzero result of the bitwise AND operation.

In another exemplary implementation, the curation system 140 can generate the first and second attribute bitmasks such that if the receiver is a member of any category with which the sender is not permitted to transact, then the transaction authentication logic can result in the transaction not being permitted. For example, the transaction authentication logic can comprise a bitwise AND operation between the first (membership) and second (restrictive) attribute bitmasks, followed by a Boolean NOT operation on the result. In this example, if the bitwise AND produces any nonzero result, then the transaction is rejected.

It will be appreciated, however, that the transaction rule compliance engine 112 can employ different transaction authentication logic to encode more complex rules for evaluating the correspondence between transaction authentication data for each of the participants in a token transaction. In other embodiments, the transaction authentication data for each the participant in a token transaction can include multiple pairs of attribute bitmasks, where one attribute bitmask of each pair can represent membership of or assignment of the receiver to an element of a set of categories, according to a defined ruleset and derived from the receiver's registration information, and the other attribute bitmask of each pair can indicate with which categories (and hence a subset of registered users as receivers), the curation system 140 determines the sender is permitted (or not permitted) to engage in a transaction according to the defined ruleset. Each pair of aligned attribute bits between two aligned attribute bitmasks, represented by one or more bitmap integers, can correspond separately to one of a collection of different attribute types associated with the stipulation of a defined ruleset, including, for example, for individuals, attribute bits representing country/countries of citizenship, country/countries of residence, accreditation class(es) for various jurisdictions (including status as accredited, qualified, a broker, or a qualified institutional buyer), and/or country/countries in which the registered user pays taxes. As part of the transaction authentication logic, the transaction rule compliance engine can then perform a bitwise AND operation on each pair of attribute bitmasks, followed by additional digital logic involving various combinations of logical AND, logical OR, logical NOT, or logical XOR, Boolean AND, Boolean OR, Boolean NOT, and bitwise shift operations of each intermediate bitwise AND result in order to generate a final result that determines if a transaction is allowed or prohibited.

In yet another exemplary embodiment, there can be three attribute bitmasks, wherein the first attribute bitmask, referred to herein as the “membership attribute bitmask”, can represent, for a receiver, membership of or assignment to an element of a set of categories that the curation system 140 determines based on the receiver's registration information and according to a defined ruleset. The second attribute bitmask, referred to herein as the “permissive attribute bitmask”, can indicate with which categories (and hence a subset of registered users as receivers), the curation system 140, according to the defined ruleset, determines the sender is permitted to transact, and the third, referred to herein as the “forbidden mask” can indicate with which categories (and hence a subset of registered users as receivers), the curation system 140, again according to the defined ruleset, determines the sender is not permitted to transact. Moreover, in some embodiments, each of the three attribute bitmasks can incorporate various and different arrangements or orderings of attribute bits of the transaction authentication data for each registered user associated with binary attributes according to a defined ruleset, including, for example, for individuals, attribute bits representing country/countries of citizenship, country/countries of residence, accreditation class(es) for various jurisdictions (including status as accredited, qualified, a broker, or a qualified institutional buyer), and/or country/countries in which the registered user pays taxes. In other embodiments, the three attribute bitmasks can employ the same ordering of attribute bits of the transaction authentication data for each registered user and are therefore aligned attribute bitmasks.

In another embodiment, the curation system 140 can generate the three attribute bitmasks in such a way that the first (membership) attribute bitmask comprises a first plurality of bitmap integers, each of which aligns with counterparts from a second plurality of bitmap integers, with the same number as for the first plurality for the first (membership) attribute bitmask, that constitute the second (permissive) attribute bitmask and with counterparts from a third plurality of bitmap integers, with again the same number as for the first plurality for the first (membership) attribute bitmask, that constitute the third (restrictive) attribute bitmask. In yet another embodiment, the transaction rule compliance engine 112 can apply transaction authentication logic in the form of a bitwise AND operation applied to each constituent bitmap integer of the first (member) attribute bitmask and an associated aligned counterpart constituent bitmap integer of the second (permissive) attribute bitmask, and then performing a logical AND on each of the results of the bitwise AND operations (themselves bitmap integers) to arrive at a first intermediate result.

In the same embodiment, the transaction rule compliance engine 112 can apply transaction authentication logic in the form of a bitwise AND operation applied to each constituent bitmap integer of the first (member) attribute bitmask and an associated aligned counterpart constituent bitmap integer of the third (restrictive) attribute bitmask, and then performing a logical AND on each of the results of the bitwise AND operations (themselves bitmap integers) to arrive at an another second intermediate result, and then apply a final logical AND between the first intermediate result and the NOT of the second intermediate result, in order to achieve a final result. In some embodiments, the determination of an aligned counterpart bitmap integer of the second (permissive) and third (restrictive) attribute bitmasks, for a constituent bitmap integer of to the first (member) attribute bitmask, is predicated on being for the same type of binary attribute, whether simple or combined.

As an example, reconsider the previous extended example, involving citizens and residents of EU member nations, the US, Singapore, country “X”, Japan and Canada. Revisiting this extended example, there were six simple binary attributes for country of citizenship and eight binary attributes reflecting country of residency in combination with accredited status, four of which were new combination binary attributes, along with the requirement that a registered user must be a citizen of one and only one country, a resident of one and only one country, and either accredited or non-accredited. However, being accredited only had relevance for residents of the U.S. or Singapore. In this extended example the membership attribute bitmask, permissive attribute bitmask, and restrictive attribute bitmask of a non-accredited citizen and resident of an EU member nation (denoted in this example as registered user “A”) could each be represented by two bitmap integers of respectively length six and eight bits, reflecting citizenship attributes and combined residency and accredited attributes, respectively, as follows: (a) membership attribute bitmask={100000, 10000000}, (b) permissive attribute bitmask={111011, 11011011}, and (c) restrictive attribute bitmask={000100, 00100100}.

Continuing this example, consider for illustrative purposes another registered user “B” who is a citizen of Canada and an accredited resident of the U.S. In this example, their membership attribute bitmask would likewise comprise two bitmap integers of respectively length six and eight bits, respectively reflecting citizenship attributes and combined residency and accredited attributes, and could be represented as {000001, 01000000}. If there is a transaction with registered user “A” as a sender and registered user “B” as a receiver, the transaction rule compliance engine could apply the following sequence of logical operations from the transaction authentication logic to the permissive attribute bitmask of registered user “A” and the membership attribute bitmask of registered user “B”: (a) bitwise AND of the first bitmap integer of the permissive attribute bitmask of “A” and the first bitmap integer of membership attribute bitmask of “B” to generate a first intermediate results bitmap integer, (b) bitwise AND of the second bitmap integer of the permissive attribute bitmask of “A” and the second bitmap integer of the membership attribute bitmask of “B” to generate a second intermediate results bitmap integer, and (c) checking if the final result of the logical AND of the first intermediate results bitmap integer of step (a) and the second intermediate results bitmap integer of step (b) is zero (false) or nonzero (true), wherein if the step (c) final result is zero, the transaction is prohibited, and if nonzero, the transaction is allowed.

Continuing with this example, step (a) would be the bitwise AND of 111011 and 000001, which results in 000001, step (b) would be the bitwise AND of 11011011 and 01000000, which results in 01000000, and step (c) would assess that the logical AND of 000001 and 01000000 is true, and therefore the transaction should be allowed, as it involves a non-accredited citizen and resident of a EU member nation sending a nonzero amount of a token to an accredited resident of the US who is also a Canadian citizen, which is allowed according to the defined ruleset of this example.

In a variant of this same example, the transaction rule compliance engine could instead apply a similar sequence of logical operations to the restrictive attribute bitmask of registered user “A” and the membership attribute bitmask of registered user “B” but wherein if the step (c) final result is zero, the transaction is allowed, and if nonzero, the transaction is prohibited. A result of such a variant involving the restrictive attribute bitmask of registered user “A”={000100, 00100100} and the membership attribute bitmask of registered user “B”={000001, 01000000} will again result in a transaction, wherein “A” is the sender and “B” is the receiver, being allowed.

Continuing this example further, consider another registered user “C” who is a non-accredited citizen of country “X” and a resident of the Singapore. In this example, their membership attribute bitmask would likewise comprise two bitmap integers of respectively length six and eight bits, respectively reflecting citizenship attributes and combined residency and accredited attributes, and could be represented as {000100, 00001000}. If there is a transaction with registered user “A” as a sender and registered user “C” as a receiver, the transaction rule compliance engine could, for example, apply the aforementioned sequence of logical operations to the permissive attribute bitmask of registered user “A” and the membership attribute bitmask of registered user “C” outlined above.

Continuing with this example, step (a) would be the bitwise AND of 111011 and 000100, which results in 000000, step (b) would be the bitwise AND of 11011011 and 00001000, which results in 00001000, and step (c) would assess that the logical AND of 000000 and 00001000 is false, and therefore the transaction should be prohibited, as it involves a non-accredited citizen and resident of a EU member nation sending a nonzero amount of a token to a non-accredited citizen of country “X” and a resident of the Singapore, which is not allowed according to the defined ruleset of this example. The restrictive attribute bitmask of registered user “A”={000100, 00100100} and the membership attribute bitmask of registered user “C”={000100, 00001000} would again result in a transaction, wherein “A” is the sender and “C” is the receiver, being prohibited.

In some embodiments, the process of obtaining the “permissive comparison” result (result of step c in above example embodiment) involving the permissive attribute bitmask of the sender and the membership attribute bitmask of the receiver is not necessarily equivalent to the process of obtaining the “restrictive comparison” result (result of step c in example embodiment but with inverted output) involving the restrictive attribute bitmask of the sender and the membership attribute bitmask of the receiver, and therefore in order to be certain of complying with a defined rule set, the transaction rule compliance engine, for example, further performs the logical AND of the “permissive comparison” result and the logical NOT of the second “restrictive comparison” result, as part of the transaction authentication logic, with a transaction being allowed if the final net result is true, and prohibited if the final net result is false.

In yet another exemplary embodiment, there can be a preassigned global bitmask, referred to as the “global stop bitmask”, which can be applied in one or more bitwise AND, OR, NOT, and/or XOR operations with one or more attribute bitmasks associated with a registered user, and if the result of the one or more bitmask operations is nonzero, could be used to indicate that a token transaction should not be allowed. Despite the name “global stop bitmask”, such a preassigned global bitmask could just as easily be used to do the reverse wherein a nonzero result involving various logical operations of the preassigned global bitmask to one or more attribute bitmasks associated with a registered user, instead signifies that the token transaction should be allowed.

In one embodiment, if it becomes necessary to prevent the transfer of a token for senders having a specific binary attribute, such as country of citizenship (e.g., citizens of country wherein token ownership on a blockchain system is not allowed) or accreditation status, independent of the attributes of the receiver, the corresponding bit could be set in a global stop bitmask. For each transaction, a bitwise AND operation could be applied to the membership attribute bitmask associated with the sender and this global stop bitmask, and if that sender has the specified binary attribute, and the result of the operation would be nonzero, provided that independent of the binary attributes associated with the receiver, a nonzero result could be used to indicate that the transfer should not occur. In another embodiment, a similar restriction could be imposed on the attribute bitmask associated with the receiver using a separate global stop bitmask reserved for that purpose.

It should be noted that altering the order of attribute bits in each bitmask does not change the result of the transaction authentication logic so long as the same alteration is applied to all corresponding bitwise AND, OR, NOT, and/or XOR instructions. Thus the order of attribute bits is specific yet arbitrary and need only be decided in advance of the construction of the transaction rule compliance engine 112 and construction of the transaction authentication data for each registered user by curation system 140, and prior to processing requests for authentication of potential transactions.

It should be noted that any bitmask can be divided into multiple bitmasks, and the corresponding bitwise AND, OR, NOT, and/or XOR instructions divided in a similar way. The divided bitmask operations can be applied in sequence to produce the same result as obtained in a single bitmask. Furthermore, it is possible to extend a bitmask by adding “0”s or “1”s, according to the type of bitmask and the defined ruleset, in order to obtain a bitmask of a certain larger size. If the corresponding bitwise AND, OR, NOT, and/or XOR are extended and filled appropriately, the resulting bitmask operations can be applied to produce the same logical result as obtained with the unfilled bitmask. It may be necessary to divide or extend a bitmask if the blockchain system 105 only supports bitwise instructions of certain predetermined sizes. Even if not necessary, it may be more computationally efficient to divide or extend a bitmask, depending on the specific capabilities of blockchain system 105.

In some embodiments, the transaction authentication logic being processed by a node running the transaction rule compliance engine can include logical operations on additional transaction eligibility criteria, for example, to determine if the transaction authentication data for the sender or for the receiver has expired according to a defined ruleset, in which case if it has expired, for either the sender or receiver, the transaction is rejected by the node that is processing the transaction or the smart contract. In another example, transaction authentication logic can examine the lock status variable for the sender to send tokens or for the receiver to receive tokens. If either is set to true, then the transaction would again be rejected by the node.

In some embodiments, wherein the transaction authentication data for each registered user comprises at least one transaction eligibility criterion, the transaction rule compliance engine is configured to authenticate a given transaction by performing at least one bitwise Boolean operation between at least one attribute bitmask of a first registered user and at least one attribute bitmask of a second registered user that is a dual to at least one of the first registered user's attribute bitmask(s) in order to generate a first result intermediate, performing at least one Boolean operation on at least one transaction eligibility criterion of at least one registered user to generate a second result intermediate, and performing at least one Boolean operation on the first result intermediate and the second result intermediate.

The transaction rule compliance engine might be configured to authenticate a given transaction by performing at least one bitwise Boolean operation between at least one attribute bitmask of a first registered user and at least one attribute bitmask of a second registered user that is the dual to at least one of the first registered user's attribute bitmask(s) to generate at least one result intermediate, wherein the at least one result intermediate comprises a results bitmask organized into predefined intervals of sequences of attribute bits, and wherein the transaction rule compliance engine generates a digital result by further performing at least one bitwise Boolean operation on each sequence of attribute bits within each predefined interval of the results bitmask to generate at least one interval result for each interval, and then performing at least one logical operation on at least one interval result.

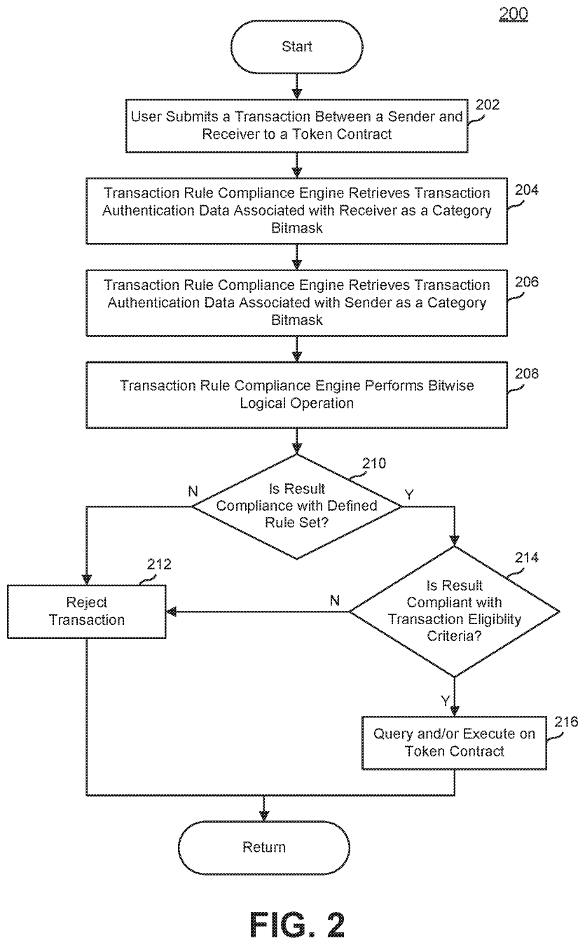

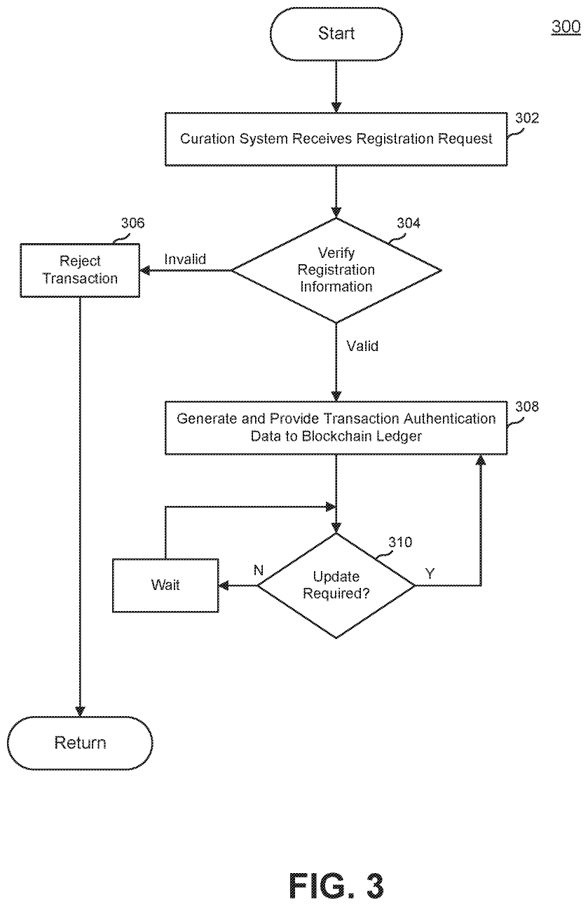

In view of the foregoing structural and functional features described above, exemplary methods in accordance with the present invention will be better appreciated with reference to FIGS. 2 and 3. While, for purposes of simplicity of explanation, the exemplary methods of FIGS. 2 and 3 are shown and described as executing serially, it is to be understood and appreciated that the present examples are not limited by the illustrated order, as some actions can in other examples or embodiments occur in different orders, multiple times, or concurrently from that shown and described herein. Moreover, it is not necessary that all described actions be performed to implement a method. The methods can be implemented by the system 100 of FIG. 1.

FIG. 2 illustrates a method 200 for executing a transaction, such as a transfer or an issuance of a security represented by a token with a corresponding token contract, according to a defined ruleset, implemented via a blockchain system. Such a method might be performed by the apparatus of FIG. 1, or similar apparatus. The method 200 begins at step 202, where a user can submit a transaction, between a validated sender holder address and a validated receiver holder address, to a token contract implemented on the BVM. It will be appreciated that, in this example, each of the sender and the receiver are registered users associated with validated holder addresses capable of sending transactions.

At step 204, a transaction rule compliance engine can retrieve from the distributed ledger of the token contract, one or more compliance contracts, another location on the blockchain system, or a combination thereof, transaction authentication data for each participant of a transaction, including, for example, a membership attribute bitmask representing membership of or assignment of a receiver to an element of a first set of categories. In one embodiment, the first set of categories can represent shared binary attributes of registered users to which the receiver belongs according to the defined ruleset and derived from receiver registration information. In one embodiment, in which the first set of categories can be selected to have regulatory significance for a security represented by a token, whether for individuals or organizations, categories can include country/countries of citizenship or incorporation, country/countries of residency or business operations, country/countries in which the registered user or organization pays taxes, accreditation class(es) within particular jurisdictions for individuals and organizations (including status as accredited, qualified, a broker, or a qualified institutional buyer), fulfillment of various regulatory requirements by the registered user or organization, an indication that the holder address is controlled by the issuer of the token or an individual otherwise affiliated with the issuer of the token, and/or similar or related classes, and/or other categories determined to be relevant or of interest for the transaction. In another embodiment, instead a membership attribute bitmask, the transaction authentication data of a receiver may comprise a category node, to which the receiver is assigned based on their relevant binary attributes according to a defined ruleset, in a directed graph comprised of a plurality of category nodes and directed edges, built according to the defined ruleset.

It will be appreciated that the transaction rule compliance engine 112 can retrieve other transaction authentication data associated with the receiver via a validated holder address of the receiver, such as transaction eligibility criteria for the receiver, as well, including, for example, an expiration date for the receiver's registration information, a maximum allowed transaction size, which can be zero, for the receiver, a hash code or common address used to identify common ownership of the receiver's validated holder addresses, and/or one or more lock status variables for the receiver, representing, for example, if the token contract is not currently available for trading generally or if the receiver is barred from receiving a nonzero quantity of a token. It will be appreciated that a given lock status can be represented, depending on the transaction authentication logic used by the transaction rule compliance engine 112 to evaluate the transaction authentication data associated with one or more validated holder addresses of a receiver, as a bit that is a logical “1” when the receiver is unable to receive a nonzero amount of a token to any of the receiver's validated holder addresses, as opposed to using another bit that is a logical “1” to represent a lock on a particular receiver validated holder address, thereby preventing receipt of a nonzero amount of a token at that particular validated holder address.

At step 206, the transaction rule compliance engine can retrieve from the distributed ledger of the token contract, one or more compliance contracts, another location on the blockchain system, or a combination thereof, transaction authentication data for each participant of a transaction, including, for example, a permissive (restrictive) attribute bitmask, associated with the sender, characterizing or indicating with which categories of receivers, according to a defined ruleset, a sender is permitted (not permitted) to transact, along with any additional transaction eligibility criteria for the sender, as well, including, for example, an expiration date for the sender's registration information, a maximum allowed transaction size, which can be zero, for the sender, a hash code or common address used to identify common ownership of the sender's validated holder addresses, and/or one or more lock status variables for the sender, representing, for example, if the token contract is not currently available for trading generally or if the sender is barred from sending a nonzero amount of a token. It will be appreciated that a given lock status can be represented, depending on the transaction authentication logic used by the transaction rule compliance engine to evaluate the transaction authentication data, as a bit that is a logical “1” when the sender is unable to send a nonzero amount of a token from any of the sender's validated holder addresses, as opposed to using another bit that is a logical “1” to represent a lock on a particular sender validated holder address, thereby preventing transmission of a nonzero amount of a token from that particular validated holder address to all other validated holder addresses not operated by the sender.

In one embodiment, the attribute bitmask, associated with the sender, can indicate with which categories of receivers, according to a defined ruleset, a sender can send a nonzero amount of a token. In another embodiment, the attribute bitmask, associated with the sender, can indicate with which categories of receivers, according to a defined ruleset, a sender cannot send any nonzero quantity of a token.

In another embodiment, instead of a permissive (restrictive) attribute bitmask, the transaction authentication data may comprise a category node, to which the sender is assigned based on their relevant binary attributes according to a defined ruleset, in a directed graph comprised of a plurality of category nodes and directed edges, built according to the defined ruleset.

In embodiments wherein the transaction rule compliance engine 112 is stored as part of one or more of the set of compliance contracts 111, the token contract 110 can call or otherwise communicate to the set of compliance contracts 111, and therefore the transaction rule compliance engine 112, relevant token transaction information. Token transaction information can include but is not limited to at least one receiver holder address, at least one sender holder address, an amount to be transferred between each sender/receiver pair, a total amount being transferred, a time stamp documenting the token contract's receipt of the transaction, and possibly other logistical information regarding the transaction. The transaction rule compliance engine 112 can locate and retrieve the relevant transaction authentication data for each of the transaction participants stored on the token contract, on one or more of the set of compliance contracts 111, in another location on the blockchain system, or any combination thereof.

At step 208, the transaction rule compliance engine can evaluate if the transaction is permitted by applying a sequence of logical operations of the transaction authentication logic to one or more of the components of the transaction authentication logic for each transaction participant. In one embodiment, wherein the transaction authentication data for the receiver (sender) contains one or more attribute bitmasks, the transaction rule compliance engine 112 can perform a bitwise AND operation of the membership attribute bitmask of the receiver (obtained in step 204) and the permissive attribute bitmask of the sender (obtained in step 206), and if the result is nonzero, the transaction is permitted. In other embodiments, wherein the transaction authentication data for the receiver (sender) contains one or more attribute bitmasks, the transaction rule compliance engine 112 can also perform a bitwise AND operation of the membership attribute bitmask of the receiver (obtained in step 204) and the forbidden bitmask of the sender (obtained in step 206), and if the result is nonzero, the transaction is prohibited, independent of any previous bitmask operations. In some embodiments, the transaction rule compliance engine recognizes that the sender and receiver holder addresses are controlled by the same registered user and, according to the defined ruleset, permits the transactions independent of other considerations, including the result of any bitmask operations, provided there are no restrictions on the validated holder addresses involved in the transaction, such as perhaps nonzero values for lock status bits assigned to one or both of the involved validated holder addresses. In other embodiments, though the transaction rule compliance engine recognizes that the sender and receiver holder addresses are controlled by the same registered user, the transaction rule compliance engine may allow or disallow the transaction, depending on applicable restrictions laid out in the defined ruleset. In some embodiments, wherein the transaction authentication data for the sender contains one or more attribute bitmasks, the transaction rule compliance engine performs a bitmask AND of the membership attribute bitmask of the sender with a global stop bitmask and if the result is nonzero, the transaction is not allowed. In some embodiments, wherein the transaction authentication data for the receiver contains one or more attribute bitmasks, the transaction rule compliance engine performs a bitmask AND of the membership attribute bitmask of the receiver with a global stop bitmask and if the result is nonzero, the transaction is not allowed.

In alternative embodiments at step 208, the transaction authentication data for the sender (receiver) contain category nodes for the sender (receiver), to which the sender and receiver are respectively assigned based on their relevant binary attributes according to a defined ruleset, in a directed graph comprised of a plurality of category nodes and directed edges, built according to defined ruleset. In some related embodiments, the transaction authentication logic applied by transaction rule compliance engine is simply to determine if there exists a directed edge from the sender category node to receiver category node in a directed graph in a data representation that the transaction rule compliance engine can access, wherein the existence of such a directed edge signifies that a transaction between a validated holder address of the sender and a validated holder address of the receiver is to be allowed, and not to be allowed if no such specific directed edge exists in the directed graph. In one embodiment, the determination of the existence of a directed edge, is accomplished by the transaction rule compliance engine by looking up a query pairing of the sender category node and receiver category node in a map (perhaps using a hash function) to a to a true (allowed) or false (not allowed) value. In another embodiment, the determination of the existence of a directed edge, is accomplished by the transaction rule compliance engine by looking up a query pairing of the sender category node and receiver category node in a pre-constructed set storing potential permitted pairings of sender category nodes and receiver category nodes, and returning true (allowed) if the query pairing is found and returning false (not allowed) if the query pairing is not found. As previously discussed, there are multiple embodiments involving different methods for determination of the existence (or non-existence) of a directed edge in a data representation of a directed graph comprised of a plurality of category nodes and directed edges, built according to a defined ruleset. The determination of the existence (or non-existence) of a directed edge in a directed graph with an associated data representation is equivalent to a logical operation.

At step 210, the transaction rule compliance engine, using further parts of the transaction authentication logic, can determine, with or without performing additional logical operations similarly executed on the BVM associated with the token contract or on one or more compliance contracts, whether the results of the set of logical operations of step 208 are compliant with a defined ruleset, which can be a representation of legal or regulatory requirements. In one example, wherein the transaction authentication data for each participant of a transaction contains one or more attribute bitmasks, the transaction rule compliance engine can consider a transaction compliant (Y) with the defined ruleset only if further processing by additional logical or Boolean operations determines that at least one of the bits of the resulting output produced by a bitwise AND operation of the first and second attribute bitmasks is a binary “1,” and the transaction rule compliance engine can determine a transaction to be noncompliant (N) with the defined ruleset if the resulting output of the bitwise AND operation is zero. In another embodiment, wherein the transaction authentication data for the sender (receiver) contains category nodes for the sender (receiver), to which the sender and receiver are respectively assigned based on their relevant binary attributes according to a defined ruleset, in a directed graph comprised of a plurality of category nodes and directed edges, the transaction rule compliance engine can consider a transaction compliant (Y) with the defined ruleset only if there is a directed edge from the sender category node to the receiver category node present in the directed graph, otherwise the transaction is considered noncompliant (N). If processing the transaction rule compliance engine results in a determination that a transaction is noncompliant (N) with the defined ruleset, the method advances to step 212 where the transaction rule compliance engine can reject the transaction. If the transaction rule compliance engine determines a transaction to comply (Y) with the defined ruleset, the method advances to step 214. In one embodiment, if there are multiple sender-receiver transaction pairs to consider, then depending on the defined ruleset, the transaction rule compliance engine may need to process each pair to advance each to step 210 and only advance to step 214 if all pairs are determined to comply with the applicable transaction authentication logic (Y). In another embodiment, only one of the sender-receiver transaction pairs needs to advance to step 210 and be determined by the transaction rule compliance engine to comply (Y) in order to advance the overall transaction to step 214. In another embodiment, a certain pre-determined threshold for the number (or percentage) of the sender-receiver transaction pairs needs to be met, meaning advance to step 210 and then be determined by the transaction rule compliance engine to comply (Y), in order to advance the overall transaction to step 214.

In another embodiment, wherein the transaction authentication data for each participant of a transaction contains one or more attribute bitmasks, there may be multiple pairs of aligned first and second attribute bitmasks, each corresponding to a different type of binary attribute (e.g., for individuals, country of citizenship, country of residency, and accreditation status), in which case, the bitwise logical operations of the transaction authentication logic are applied to each pair of aligned first and second attribute masks, resulting in an a collection of intermediate results, which are then subjected to further processing by additional logical or Boolean operations, in order to obtain a final result. In one embodiment, the intermediate results are obtained via a bitwise AND operations applied to each aligned first and second attribute bitmask pair. In another embodiment, the final result is obtained by performing a logical AND of the intermediate results, meaning that the final result is true if and only if all of the intermediate results are nonzero. In another embodiment, the final result is obtained by performing a logical OR of the intermediate results, meaning that the final result is true if any of the intermediate results are nonzero. In another embodiment, the final result is obtained by performing a sequence of logical AND, OR, NOT, or XOR operations to the intermediate results for each pair of aligned first and second attribute bitmasks.

At step 214, the transaction rule compliance engine can further evaluate additional transaction eligibility criteria, as part of the transaction authentication logic, to determine whether a transaction is valid, that is, compliant or noncompliant with the defined ruleset or that the transaction should be allowed to proceed. In one example, a transaction between two parties can only be executed if the token contract and/or the set of compliance contracts are currently allowing tokens to be transferred (in some embodiments implemented as an alphanumeric value or a Boolean flag in the token contact or the one or more compliance contracts that instructs the transaction rule compliance engine whether or not to reject all transactions), and both parties have validated holder addresses with associated transaction authentication data on the distributed ledger of the blockchain system. From the additional transaction eligibility criteria, for example, the transaction rule compliance engine can determine whether both holder addresses involved in the transaction are not locked, i.e., the sender not locked for sending and the receiver not locked for receiving, and whether the registration information for both the sender and receiver have not have passed their respective expiration dates.

In other examples, the transaction rule compliance engine can determine from the additional transaction eligibility criteria whether the amount of tokens involved in a transaction is above a maximum transaction size allowed for the sender or receiver and whether the amount of tokens that will be held by the receiver after the completion of the transaction is less than a maximum allowed amount associated with that receiver, whether in an individual validated holder address or all validated holder addresses of the receiver. If the transaction rule compliance engine determines from its analysis of the additional transaction eligibility criteria that transaction is not valid (N), then the transaction rule compliance engine can reject the transaction at step 212. If instead the transaction rule compliance engine determines the transaction to be valid (Y), the transaction can be queued to the blockchain or can be executed and recorded in the distributed ledger of the blockchain of the token contract at step 216. In one embodiment, if there are multiple sender-receiver transaction pairs to consider, then depending on the defined ruleset, the transaction rule compliance engine may need to process each sender-receiver pair to advance each to step 214 and only advance to step 216 if all pairs are determined to comply via the applicable transaction eligibility criteria (Y). In another embodiment, only one of the sender-receiver transaction pairs needs to advance to step 214 and be determined by the transaction rule compliance engine to comply (Y) in order to advance the overall transaction to step 214. In yet another embodiment, a certain pre-determined number threshold for the (or percentage) of the sender-receiver transaction pairs needs to be met, meaning advance to step 214 and then be determined by the transaction rule compliance engine to comply (Y) in order to advance the overall transaction to step 216.

In embodiments wherein the transaction rule compliance engine is implemented across a set of compliance contracts, each compliance contract reports appropriate instructions which together can be utilized by the transaction rule compliance engine to authorize or reject a transaction to the token contract based on the results of the transaction authentication logic operating on the relevant transaction authentication data of each of the transaction participants.

FIG. 3 illustrates a method 300 for curating a token contract for a security token, running on a blockchain, for a specific registered user. At 302, a curation system 140 can receive a registration request from a user. Registration information can include, but is not limited to, a full legal name of an individual or organization, an e-mail address, a phone number, a mailing address, and/or country of citizenship or incorporation, and/or, in the United States, a social security number, and/or, in the United States, a business registration number. For verification purposes, including, for example, KYC/AML verification, the registration request can also include a copy of a government issued ID, certificate of incorporation, a signed letter from an authorized representative or license form(s) regarding accreditation status (including status as accredited, qualified, a broker, or a qualified institutional buyer), and/or a proof of residency, such as a copy of a recent utility bill, or verification of an identity card or credit card and associated information via an authorized third party verification system. At 304, the curation system 140 can verify the registration information, or another party, such as one or more external entities or human agents, can communicate to the curation system 140 that the registration information has been verified. It will be appreciated that the curation system 140 can automatically verify certain types of registration information; for example, in one embodiment, the curation system 140 can verify that a provided mailing address is a proper mailing address. However, in other embodiments, certain types of data verification, for example, confirming that the same individual is present in a government issued photo ID and a second photo including a contemporaneous and specific message received from the user, may require the use of another authorized third party, such as one or more external entities or human agents, to perform that portion of the verification process and report to the curation system 140 the validity or invalidity of all or a part of the received registration information.

It will be appreciated that the degree of verification necessary for the registration process can vary with the permissions granted to a given registered user to participate in token transactions. For example, the curation system may allow registered users to hold tokens in small accounts, with an aggregate value of less than ten thousand dollars, without performing verification beyond determining whether a given mailing address is a valid mailing address. For larger accounts, the curation system 140 can employ additional verification services, performed by other authorized third parties, to ensure that, for example, the registering user actually resides or does business at the address given, a credit check is performed, and similar measures may be taken to ensure the identity and origin of funds of the registering user. If the curation system 140 determines the registration information to be invalid (INVALID) or if another authorized third party instructs the curation system 140 that the registration information is invalid (INVALID), the curation system 140 can reject the registration at 306.

If the curation system 140 determines that the registration information is valid (VALID) or if another authorized third party instructs the curation system 140 that the registration information is valid (VALID), the curation system 140 can then generate the transaction authentication data for the registered user, as described previously, and can provide it to the blockchain ledger, such as at the token contract, one or more compliance contracts, another location on the blockchain system, or a combination thereof, at 308, along with one or more validated holder addresses for the registered user. At 310, the curation system 140 can determine whether an update to the transaction authentication data is required. An update may be required if there is a change in registration information or status of one or more registered users. In one embodiment, an update is required and processed by the curation system 140 when an existing registered user's registration information expires. In another embodiment, an update is required and processed by the curation system 140 when a registered user's vesting period ends. In yet another embodiment, an update is required and processed by the curation system 140 when certain time periods associated with token transactions generally have passed (such as, for example, a prohibition or moratorium of the ability to trade, or the ability to trade in certain jurisdictions for certain periods of time). In yet another embodiment, an update is required and processed by the curation system 140 when a registered user reports a lost or forgotten private key. In yet another embodiment, an update is required and processed by the curation system 140 after a registered user asks for one or more of their user's validated holder addresses to be locked. In order to process an update, the curation system 140 may be required to update some or all of the transaction authentication data associated with each validated holder address of every registered user when changes in the defined ruleset, governing token ownership and allowed transactions on the token contract, are authorized by the issuing party, such as, for example, when changes in applicable securities regulations occur in one or more relevant jurisdictions. An update of some or all of the transaction authentication data for a set of registered users may include, for example, the reassignment to or redefinition of various binary attributes, categories, attribute mappings, or attribute bitmasks for registered users according to changes in a defined ruleset. An update of some or all of the transaction authentication data for a set of registered users may include, according to changes in a defined ruleset, the rebuilding of a new directed graph with a plurality of category nodes and directed edges.

If no update is necessary, the method can remain at 310 until an update is required. If an update is necessary, the method can return to 308, and the curation system 140 can provide updated transaction authentication data to the blockchain ledger.

In some embodiments, there are multiple authorized curation systems such as instances of curation system 140 in FIG. 1. Different curation authorities can share a shared secret or there may be another mechanism that allows for multiple independent curation authorities to place transactions on a blockchain in their role as curators for a subset or all of registered users. For example, authorized curation systems might be managed and operated by notary services, consular services, tax agencies, or financial custodians or brokers. In one embodiment, one agency would vet the registrations of some subset of the registered users and other agencies would vet the registrations of some other subsets of the registered users. This might be implemented as one initial transaction that is a transfer from an originator of the entire curation process to a plurality of authorized curation subsystem operators and a node processing a smart contract can follow that chain of transactions to determine that a particular posting by a curation subsystem is an authoritative posting.

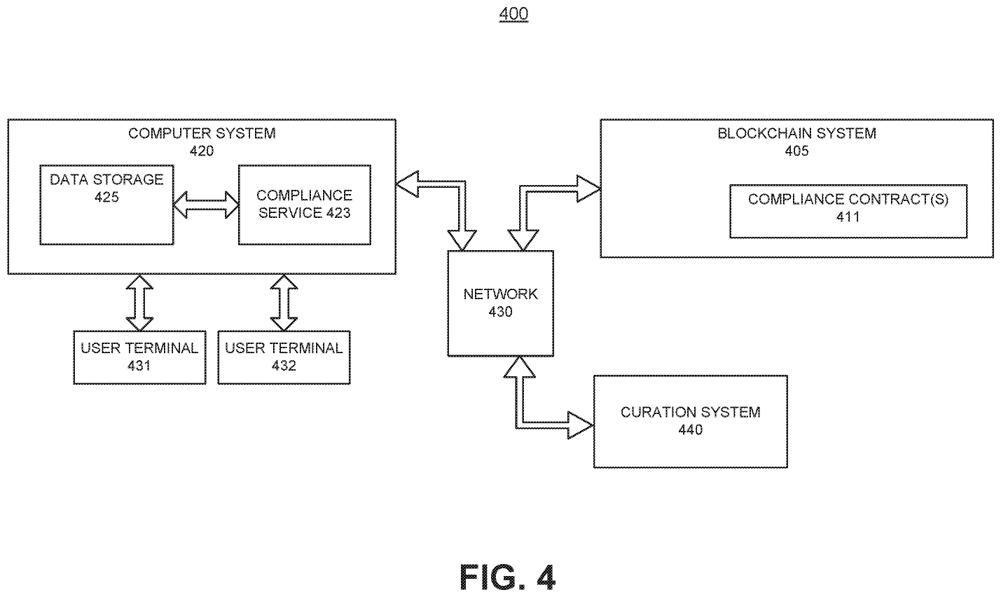

FIG. 4 depicts a block diagram of system 400 for maintaining the functions of the transaction rule compliance engine in a computer system outside of the BVM or on another BVM. The system includes a computer system 420 which receives requests from a plurality of user terminals 431 and 432, a blockchain system 105, a curation system 140, and a network 130. The blockchain system 105, network 130, and curation system 140 operate as depicted in FIG. 1. A compliance service 423, operating on the computer system 420, is capable of replicating the logic employed by the defined ruleset implemented in the set of compliance contracts 111. Data storage 425, maintained on the computer system 420, stores the transaction authentication data for each potential transaction participant according to the defined ruleset implemented as part of the compliance service 423. In one embodiment, the transaction authentication data for each potential transaction participant is obtained from the token contract 110, the set of compliance contracts 111, or a combination thereof as part of the distributed ledger of the blockchain system 105, by interacting with one or more nodes of the blockchain system 105. In another embodiment, the transaction authentication data for each potential transaction participant is obtained directly from the curation system 140, before (such as by being stored ahead of time) the request for authentication of transaction is made. In another embodiment, the transaction authentication data for each participant of a requested transaction is obtained directly from the curation system 140, after the request for authentication of transaction is made (such as by being done upon demand). In another embodiment, the transaction authentication data for each potential transaction participant is obtained from a combination of the token contract 110 and the set of compliance contracts 111 by interacting with one or more nodes of the blockchain system 105 and, in addition, by interacting with the curation system 140. In some embodiments, transaction authentication data for each potential transaction participant is obtained or refreshed at fixed intervals of time or according to a specified schedule. In other embodiments, a subset of transaction authentication data is obtained at regular time intervals or according to a specified schedule, where the subset is chosen in such a manner as to maintain the current state of the transaction authentication data, relative to the correct or current state of a BVM, for each potential transaction participant on the data storage 425. In other embodiments, transaction authentication data is obtained, in total or in part, at the request of an operator.

In a preferred embodiment, the transaction authentication data contained in data storage 425 includes membership and permissive attribute bitmasks, and the compliance service 423 performs a binary AND operation between them. A nonzero result can indicate that the transaction is allowed while a result of zero can indicate that the transaction is noncompliant and that the off-chain system should reject the transaction between the two matched parties. Additionally, the compliance service 423 can consider any additional transaction eligibility criteria for making its determination as previously described.

The computer system 420 responds to queries from the plurality of user terminals 431 and 432. Each query could include the identity of one or more users, where that identity is provided by a user number, user identifier, or one or more holder addresses. In some embodiments, a query could request information on whether a given user is allowed to transfer (sell) a security, represented by a token, to any other user. In some embodiments, a query could request information on whether a given user is allowed to receive (buy) a security, represented by a token, from any other user. In some embodiments, a query could request information on whether a given user (a seller) is allowed to transfer a security, represented by a token, to another given user (a buyer).

The computer system 420 may contain additional services and data storages for other purposes, or may be part of a larger set of computer systems operating together. For example, computer system 420 could also be responsible for maintaining services for securities that use ledgers supported by conventional data systems, other BVMs, or other record keeping services employing a blockchain.

The plurality of user terminals 431 and 432 could be computer systems that translate messages entered by a human operator for transmission to the computer system 420. In some embodiments, the user terminals 431 and 432 are computer systems that receive input from automated systems designed to maintain processes or records associated with financial markets, for example, as part of a stock exchange.

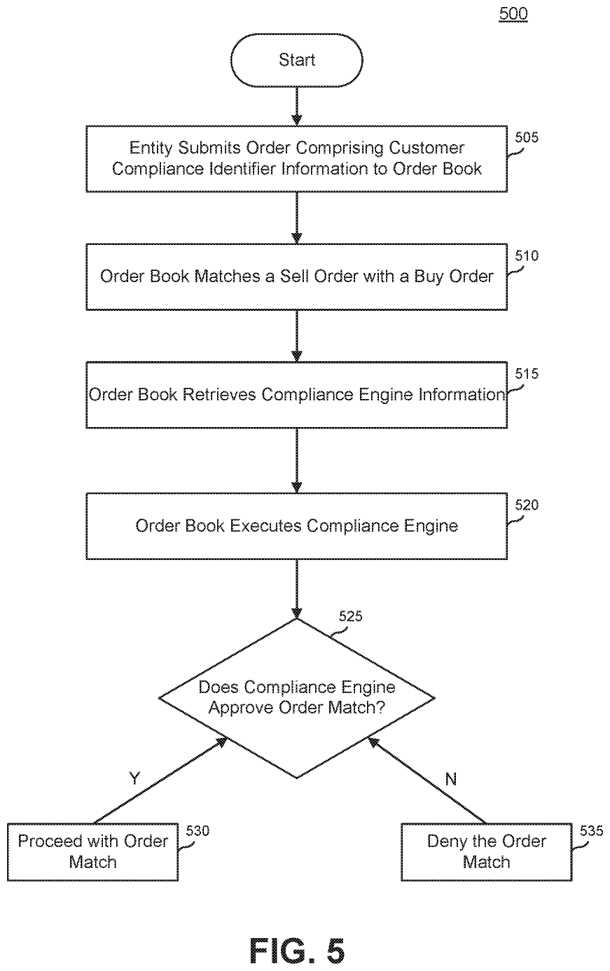

FIG. 5 depicts an exemplary method for matching buy and sell orders on an off-chain computer system (such as on a stock exchange order book system) that integrates the functionality of a transaction rule compliance engine (such as the transaction rule compliance engine 112 of FIG. 1), corresponding to a defined ruleset for a security to be traded. At step 505 an entity such as a broker submits an order as a digital message to the order book computational system, a system that is in communication with a blockchain system implementing one or more compliance contracts and/or a transaction rule compliance engine (such as those of FIG. 2.) This digital message comprises order details that can include, but are not limited to, a nonzero quantity of tokens desired to be purchased or sold, a desired price of the purchasing/selling and for what asset (e.g., national currencies, another token, etc.), and a user identifier or number that specifies the entity requesting the order. In a preferred embodiment, the entity requesting the order and identified by the user identifier is a user already registered with a curation system responsible for generating and storing transaction authentication data for each potential transaction participant on a blockchain system (such as the curation system 140 of FIG. 1). In some embodiments, the user identifier comprises a holder address. In another embodiment, the user identifier element comprises a customer identifier element that indexes registration information to one or more co-owned holder addresses that each can store the same or different tokens subject to the same or different sets of compliance contracts. In still further embodiments wherein the order book system is in communication with more than one set of compliance contracts on one or more blockchain systems, the user identifier comprises a number or value indicating the appropriate and corresponding blockchain system and/or the token contract or set of compliance contracts that is relevant for the given requested transaction.

At step 510, the off-chain system (e.g., order book system) matches a sell order with an appropriate buy order. This procedure can include established computational methods used by various order book systems and protocols. In a preferred embodiment, the order book system additionally can only match orders if both the sell and buy orders include user identifiers that indicate registration on the relevant token contracts and/or one or more sets of compliance contracts. For example, the off-chain system cannot match an order to sell a token (that is governed by a defined ruleset associated with a set of compliance contracts) for a national currency with an order to buy the token with that national currency if the buyer does not have a user identifier that indicates registration with the relevant set of compliance contracts. Similarly, the off-chain system cannot match a buy and sell order between two parties that would result in an exchange of two different tokens each subject to a different set of compliance contracts unless the user identifiers of both parties indicate registration on both sets of compliance contracts.

At step 515, the off-chain system (e.g., order book system) retrieves relevant compliance information (including but not limited to transaction authentication data, additional eligibility criteria, and the necessary transaction authentication logic) from the appropriate one or more on-chain compliance contracts (e.g., the token contract 110, the one or more of the set of compliance contracts 111, the transaction rule compliance engine 112 of FIG. 1, or another location on the blockchain where this information can be stored, or a combination thereof). Using established network protocols, the order book system can access compliance information. In an example wherein the matched buy and sell orders would result in the exchange of two different tokens subject to two different sets of compliance contracts, the off-chain system retrieves compliance information from both sets of compliance contracts, including transaction authentication data for both parties from both sets of contracts. In some embodiments, the off-chain system accesses this information stored on the blockchain system via a network each time the off-chain system matches orders. In another embodiment, the off-chain system locally stores some of the information that is unlikely to frequently change (e.g., the transaction authentication logic) in off-chain storage for more efficient retrieval, thereby only requiring the transaction authentication data and/or other certain information to be sourced from the blockchain system.

At step 520, computer system 420 executes at least a portion of the transaction rule compliance engine necessary to run the buyer's and seller's transaction authentication data through the transaction authentication logic to check whether the transaction is in accordance with the defined ruleset governing token ownership and allowed transactions as described in various embodiments above.

In examples where the matched buy and sell orders would result in the exchange of two different tokens subject to two different sets of compliance contracts, the computer system 420 runs the transaction rule compliance engine of both contracts on transaction authentication data for both parties on both contracts to generate a result for each compliance engine to determine whether both transactions (i.e., the passing of a first token from a first party to a second party and the passing of a second token from the second party to the first party) are each compliant under each set of compliance contracts. The off-chain system then runs additional logic, such as a logical AND operation between both results, to check whether both engines yielded respective affirmation of compliance.

At step 525, the off-chain system (e.g., order book system) reviews the result of the one or compliance engine operations. If the result signifies that the one or more engines approve the matching, the method proceeds to step 530 and the order book system can proceed with the matched orders. If the result signifies that the engine rejects the matching, the order book system similarly rejects the order matching.

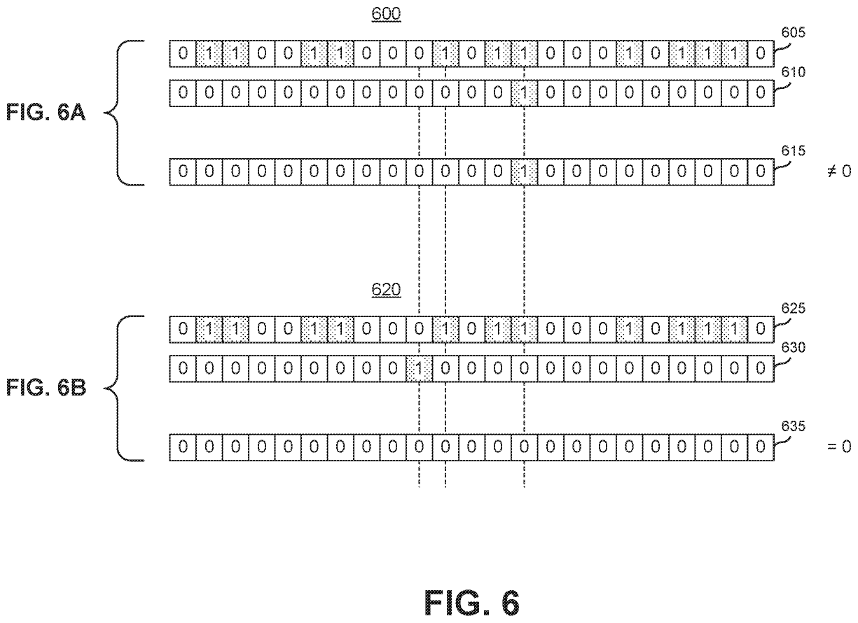

FIG. 6A illustrates an exemplary operation on transaction authentication data of two registered users by the transaction rule compliance engine resulting in an allowed transaction. In some embodiments, components of the system of FIG. 1 can perform this operation. In further embodiments, the exemplary operation illustrates various steps of the method of FIG. 2. For a transaction 600, the transaction rule compliance engine has retrieved a permissive attribute bitmask 605 comprising attribute bits indicating categories to which a requested sender is allowed to send tokens according to the defined ruleset. Additionally, the transaction rule compliance engine has retrieved a membership attribute bitmask 610 comprising attribute bits representing an element of a set of categories to which a requested receiver is assigned according to the defined ruleset. In alternative embodiments, the permissive attribute bitmask 605 and the membership attribute bitmask 610 can be longer or shorter than depicted in FIG. 6A. The permissive attribute bitmask 605 and the membership attribute bitmask 610 are aligned such that ordering of attribute bits is consistent between both bitmasks 605 and 610. The transaction rule compliance engine performs a binary AND operation between the permissive attribute bitmask 605 and the membership attribute bitmask 610 to generate a results bitmask 615. Because the results bitmask 615 is nonzero, the transaction rule compliance engine allows the transaction 600 and communicates appropriate instructions to the token contract. In alternative embodiments, different values of the results bitmask 615 can inform the transaction rule compliance engine to perform alternative actions according the transaction authentication logic.

FIG. 6B illustrates an exemplary operation on transaction authentication data of two registered users by the transaction rule compliance engine resulting in a rejected transaction. In some embodiments, components of the system of FIG. 1 can perform this operation. In some embodiments, components of the system of FIG. 4 can perform this operation. In further embodiments, the exemplary operation illustrates various steps of the method of FIG. 2. For a transaction 620, the transaction rule compliance engine has retrieved a permissive attribute bitmask 625 for a registered user belonging to the same category as the sender associated with permissive attribute bitmask 605 of FIG. 6A. Additionally, the transaction rule compliance engine has retrieved a membership attribute bitmask 630 comprising attribute bits representing an element of a set of categories to which a different requested receiver is assigned according to the defined ruleset. In alternative embodiments, the permissive attribute bitmask 625 and the membership attribute bitmask 630 can be longer or shorter than depicted in FIG. 6B. The permissive attribute bitmask 625 and the membership attribute bitmask 630 are aligned such that ordering of attribute bits is consistent between both permissive attribute bitmask 625 and restrictive attribute bitmask 630. The transaction rule compliance engine performs a binary AND operation between the permissive attribute bitmask 625 and the membership attribute bitmask 630 to generate a results bitmask 635. Because the results bitmask 635 is zero, the transaction rule compliance engine rejects the transaction 620 and communicates appropriate instructions to the token contract. In alternative embodiments, different values of the results bitmask 635 can inform the transaction rule compliance engine to perform alternative actions according to results of the transaction authentication logic.

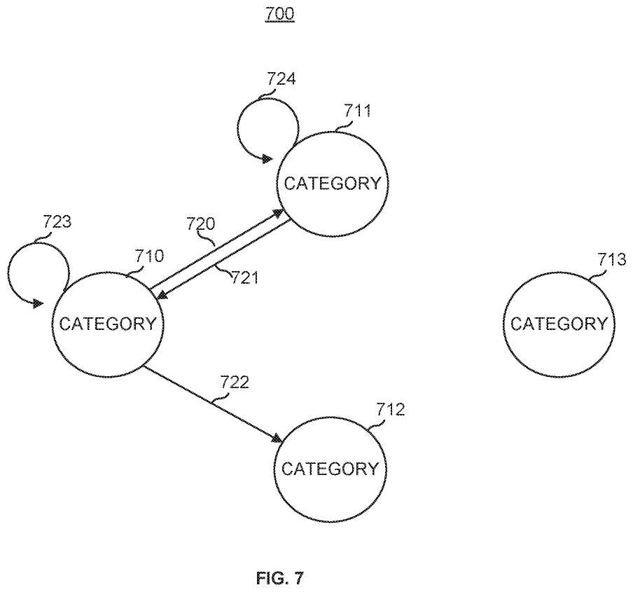

FIG. 7 illustrates an exemplary embodiment of transaction authentication data, generated and maintained by the curation system 140, which represents the set of allowed transactions between registered users by means of a directed graph (or its associated connection matrix). In some embodiments, components of the system of FIG. 1, including, but not limited to the transaction rule compliance engine 112, use one or more data representations of the directed graph to authenticate a transaction as part of a transaction authentication system. In some embodiments, components of the system of FIG. 4 use one or more data representations of the directed graph to authenticate a transaction as part of a computer system outside of a BVM or on another BVM, while maintaining the functions or feature of a transaction rule compliance engine. In further embodiments, the exemplary embodiment of transaction authentication data, generated and maintained by the curation system 140, which represents the set of allowed transactions between registered users by means of a directed graph (or its associated connection matrix) is applied in various steps of the method of FIG. 2.

In FIG. 7, a directed graph 700 comprises a plurality of category nodes, whether fundamental or composite, 710, 711, 712, and 713, each of which is presented as a category node of the directed graph 700, and a plurality of directed edges 720, 721, 722, 723, 724, and 725, each of which connects one of the category nodes 710, 711, 712, or 713 to another category node 710, 711, 712, or 713. The directed edge 723 (724) connects category node 710 (711) with itself, signifying that registered users assigned to category node 710 (711) may transfer a nonzero amount of a token, or otherwise transact, with registered users assigned to the same category node 710 (711). The directed edge 720 connects category node 710 to category node 711, signifying that senders assigned to category node 710 may transfer a nonzero amount of a token, or otherwise transact, with receivers assigned to category node 711. The directed edge 721 connects category node 711 to category node 710, signifying that senders assigned to category node 711 may transfer a nonzero amount of a token, or otherwise transact, with receivers assigned to category node 710. The directed edge 722 connects category node 710 with category node 712, signifying that senders assigned to category node 710 may transfer a nonzero amount of a token, or otherwise transact, with receivers assigned to category node 712. Note that the absence of a directed edge from category node 712 to category node 710 signifies that senders assigned to category node 712 may not transfer a nonzero amount of a token, or otherwise transact, with receivers assigned to category node 710. category Similarly, the absence of a directed edge from category node 711 to category node 712 signifies that senders assigned to category node 711 may not transfer a nonzero amount of a token, or otherwise transact, with receivers assigned to category node 712. Similarly, the absence of a directed edge from category node 712 to both category nodes 710 and 711 signifies that senders assigned to category node 712 may not transfer a nonzero amount of a token, or otherwise transact, with receivers assigned to category nodes 710 or 711. The absence of a self-edge for category node 712 signifies that registered users assigned to category node 712 may not transfer a nonzero amount of a token, or otherwise transact, with other registered users assigned to category node 712. Finally, the absence of a directed edge from category node 713 to any of the other category nodes 710, 711, 712 (as with category node 713, a disconnected node with no self-edge) signifies that registered users assigned to category node 713 may not send or receive a nonzero amount of a token, or otherwise transact, with any other registered users, whether assigned to category nodes 710 711, 712, or even 713.

According to a different defined ruleset, there may be more or fewer categories to which registered users are assigned and as a result more or fewer category nodes in directed graph 700 of FIG. 7. According to a different defined ruleset, there may be more or fewer directed edges, connecting category nodes of directed graph 700 of FIG. 7, even if the number of category nodes remains the same. It should be also noted that the directed graph 700 of FIG. 7 is a reduced directed graph, in that none of the four category nodes can be merged, as no pairs of category nodes satisfies all three of the previously discussed necessary conditions for merging.

The directed graph 700 of FIG. 7 can be used by the transaction rule compliance engine in the following fashion. A transaction is specified that involves transferring tokens from a sender holder address to a receiver holder address. The transaction authentication data associated with the sender holder address is accessed, and the category of the sender is retrieved. The transaction authentication data associated with the receiver holder address is accessed, and the category of the receiver is retrieved. The sender category node corresponding to the category of the sender is located on directed graph 700. The receiver category node corresponding to the category of the receiver is also located on the directed graph 700. If a directed edge from the sender category node to the receiver category node exists in the directed graph 700, then the transfer of a nonzero amount of a token between the sender holder address and receiver holder address is allowed. Otherwise, if no directed edge from the sender category node to the receiver category node exists in directed graph 700, then the transfer of a nonzero amount of a token between the sender holder address and receiver holder address is disallowed. For example, the directed edge 722 implies that a sender assigned to category node 711 is allowed to transfer a nonzero amount of tokens to a receiver assigned to category node 712. In another example, since there no directed edge from category node 712 to category node 711 exists, a sender assigned to category node 712 is not allowed to transfer a nonzero amount of tokens to a receiver assigned to category node 711.

For example, the directed graph 700 of FIG. 7 could represent the allowed transfers for a token that represents a security, which has the following restrictions according to a defined ruleset: only a registered user in either country “A” or country “B” is allowed to hold the security. Furthermore, any registered users in country “A” are allowed to transfer a nonzero amount of the token to any other registered users in country “A”, but only registered users who are accredited and in country “A” are allowed to transfer a nonzero amount of the token to registered users in country “B”. Registered users in country “B” are not allowed to transfer a nonzero amount of tokens to anyone, even to other registered users in country “B”. To impose these restrictions, according to the defined ruleset, the curation system 140 constructs a directed graph wherein accredited registered users in country “A” are assigned to a category that corresponds to category node 710, non-accredited registered users in country “A” are assigned to a category that corresponds to category node 711, registered users in country “B” are assigned to the category that corresponds to category node 712, and all other registered users (i.e., those not living in countries “A” or “B”) are assigned to a category that corresponds to category node 713, wherein the defined ruleset was extended, as described in a previously discussed embodiment, to by default reject transaction participants from outside the intended set of potential holders from countries “A” and “B”. The existence of edges 720, 721, 723, and 724 indicate that all registered users in country “A”, whether accredited or not, are allowed to transfer a nonzero amount of the token to any other registered user in country “A”. The existence of edge 722 indicates that accredited registered users in country “A” are allowed to transfer a nonzero amount of the token to a registered user in country “B”. The lack of a directed edge from category node 711 to category node 712 indicates that non-accredited registered users in country “A” are not allowed to transfer a nonzero amount of the token to registered users in country “B”. The lack of any directed edge (including no self-edge) originating from category node 712 indicates that a registered user in country “B” is not allowed to transfer a nonzero amount of the token to anyone (include another registered user in country “B”). The lack of any edge originating from or terminating on category node 713 indicates that no registered user outside of country “A” or “B” is allowed to participate, as sender or receiver, in a transfer of a nonzero amount of the token, or otherwise transact with anyone, including registered users from countries “A” or “B”.

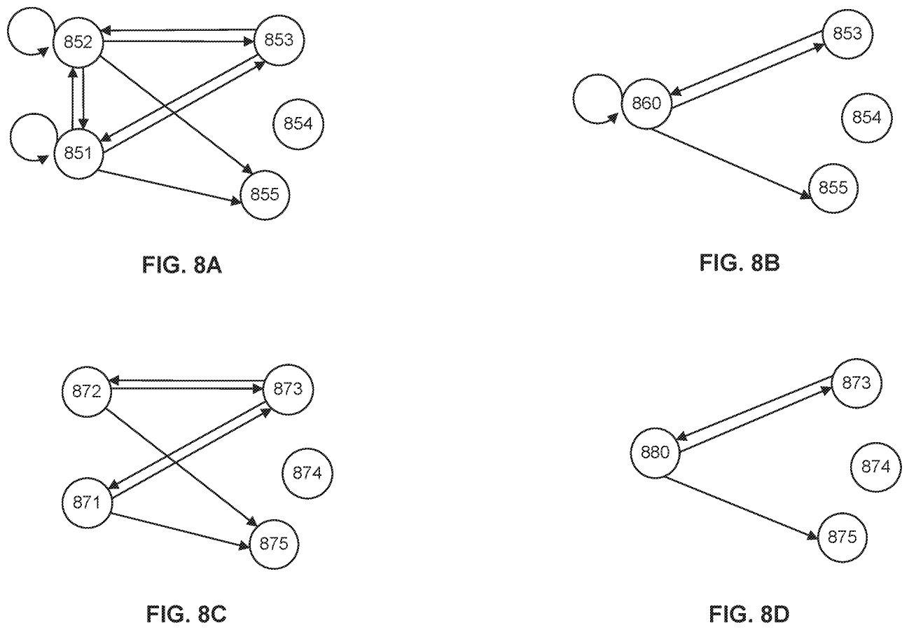

In FIG. 8, an example of directed graph reduction, according to the aforementioned three conditions, is illustrated. Depicted in FIG. 8A is an initial fundamental directed graph associated with a defined ruleset, in which fundamental category nodes 851 and 852 both have the same set of directed edges to and from all other fundamental category nodes (853, 854, 855) in the directed graph, that is, there is a directed edge from each of fundamental category nodes 851 and 852 to fundamental category node 855, a directed edge from each of fundamental category nodes 851 and 852 to fundamental category node 853, a directed edge from fundamental category node 853 to each of fundamental category nodes 851 and 852, and no directed edges involving fundamental category nodes 851 and 852 and fundamental category node 854. In addition, fundamental category nodes 851 and 852 both have self-edges, and the two fundamental category nodes 851 and 852 have directed edges to and from each other. Depicted in FIG. 8B is a reduced directed graph for the same defined ruleset that is functionally equivalent to the directed graph in depicted FIG. 8A, except with fundamental category nodes 851 and 852 combined into a new composite category node 860, such that the new composite category node 860 has the appropriate set of non-redundant directed edges with itself and the remainder of the graph.

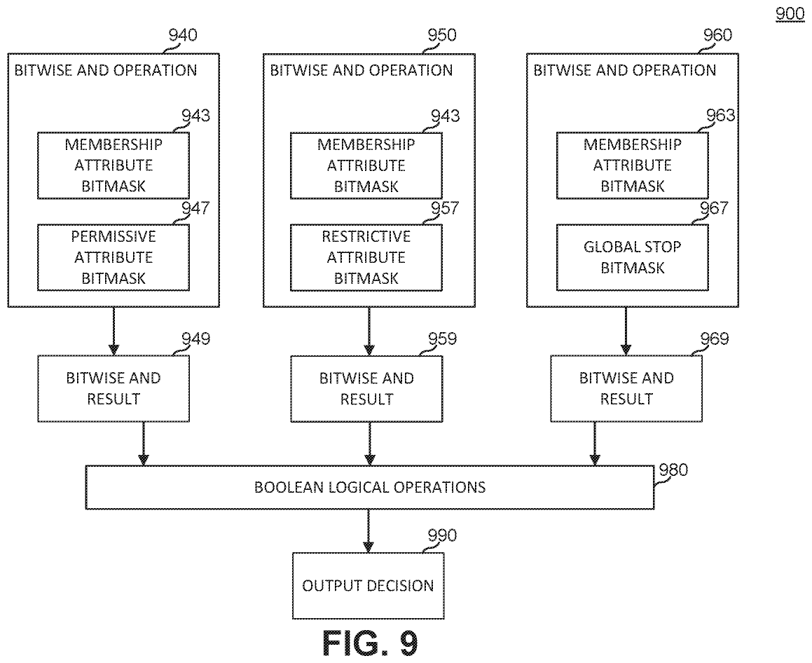

Depicted in FIG. 9 is an example of an embodiment of the transaction authentication logic operations, similar to that of FIGS. 6A and 6B, applied to the transaction authentication data of a sender and of a receiver, as part of a transaction rule compliance engine that authenticates transactions to determine if a transfer of a nonzero amount of a token from a sender to a receiver is allowed. Here in this depicted example, the membership attribute bitmasks 943 and 963, a permissive attribute bitmask 947, a restrictive attribute bitmask 957, a global stop bitmask 967, and the bitwise AND results 949, 959, and 969, may each instead of representing the binary attribute values for a single bitmap integer, be considered a collection of bitmap integers, wherein each collection has the same number and lengths of bitmap integers in the same ordering.

First, in FIG. 9, bitwise AND operation 940 is performed on the membership attribute bitmask 943 of the receiver, as provided by the transaction authentication data associated with the receiver's validated holder address, and the permissive attribute bitmask 947 of the sender, as provided by the transaction authentication data associated with the sender's validated holder address, producing the bitwise AND result 949. Bitwise AND operation 950 is performed on the membership attribute bitmask 943 of the receiver, as provided by the transaction authentication data associated with the receiver's validated holder address, and the restrictive attribute bitmask 957 of the sender, as provided by the transaction authentication data associated with the sender's validated holder address, producing the bitwise AND result 959. Bitwise AND operation 960 is performed on the sender membership attribute bitmask 963, as provided by the transaction authentication data associated with the sender, and the global stop bitmask 967, a preassigned bitmap integer represented by the global stop bitmask 967, producing the bitwise AND result 969. Boolean logical operations 980, applies a sequence of logical operations to the bitwise AND results 949, 959, and 969 as follows: (a) confirms that the bitwise AND result 949 is nonzero, (b) that the bitwise AND result 959 is zero, and (c) that the bitwise AND result 969 is zero, and produces output decision 990 that is true if and only if all of three of these conditions described in (a), (b), and (c) are met, otherwise output decision 990 returns false.

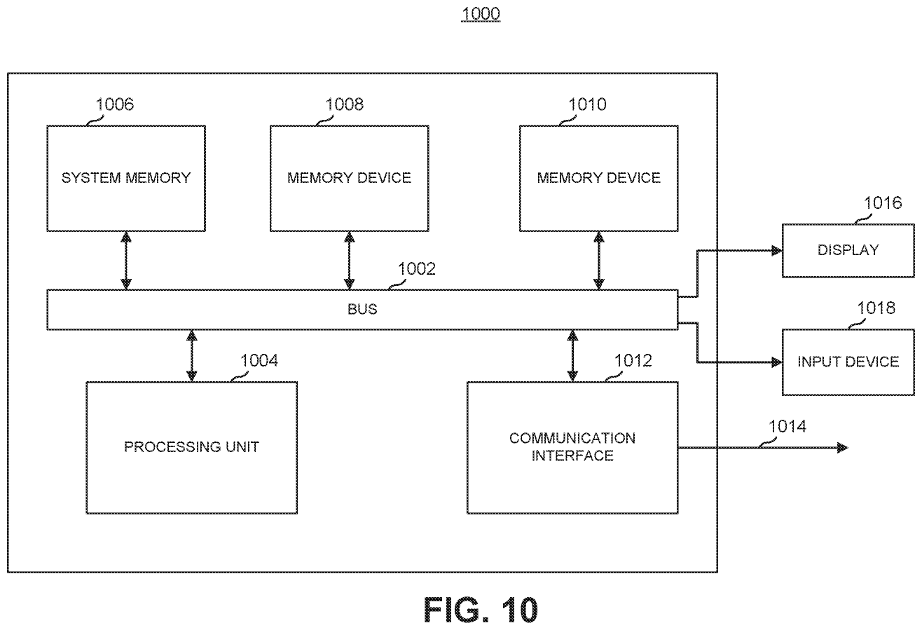

FIG. 10 illustrates an example of a computer system 1000 that can implement examples of the systems and methods disclosed in FIGS. 1-9. For example, computer system 1000 might be used to implement a node or other processor described herein.

The computer system 1000 can utilize on one or more general purpose networked computer systems, embedded computer systems, routers, switches, server devices, client devices, various intermediate devices/nodes and/or stand-alone computer systems. It will be appreciated that, given the distributed nature of the blockchain system 105, the illustrated computer system 1000 can be one of a plurality of computer systems that execute nodes of the blockchain system. Alternatively, the illustrated computer system can represent a user device storing a digital wallet or the curation system 140 for a token trading system.

The computer system 1000 can include a system bus 1002, a processing unit 1004, a system memory 1006, memory devices 1008 and 1010, a communication interface 1012 (e.g., a network interface), a communication link 1014, a display 1016 (e.g., a video screen), and an input device 1018 (e.g., a keyboard and/or a mouse). The system bus 1002 can be in communication with the processing unit 1004 and the system memory 1006. The memory devices 1008 and 1010, such as a hard disk drive, server, stand-alone database, or other non-volatile memory, can also be in communication with the system bus 1002. The system bus 1002 interconnects the processing unit 1004, the memory devices 1006-810, the communication interface 1012, the display 1016, and the input device 1018. In some examples, the system bus 1002 also interconnects an additional port (not shown), such as a universal serial bus (USB) port.

The processing unit 1004 can be a computing device and can include an application-specific integrated circuit (ASIC). The processing unit 1004 executes a set of instructions to implement the operations of examples disclosed herein. The processing unit can include a processing core.

The memory devices 1006, 1008 and 1010 can store data, programs, instructions, database queries in text or compiled form, and any other information that can be needed to operate a computer. The computer system 1000 can implement the memory devices 1006, 1008 and 1010 can be implemented as computer-readable media (integrated or removable) such as a memory card, disk drive, compact disk (CD), or server accessible over a network. In certain examples, the data stored in the memory devices 1006, 1008 and 1010 can comprise text, images, video, and/or audio, portions of which can be available in formats comprehensible to human beings. Additionally, or alternatively, the computer system 1000 can access an external data source or query source through the communication interface 1012, which can communicate with the system bus 1002 and the communication link 1014.

In operation, the computer system 1000 can implement one or more parts of a system for trading tokens in accordance with the present invention. Computer executable logic for implementing various components of the system reside on one or more of the system memory 1006, and the memory devices 1008, 1010 in accordance with certain examples. The processing unit 1004 executes one or more computer executable instructions originating from the system memory 1006 and the memory devices 1008 and 1010. The term “computer readable medium” as used herein refers to any medium that participates in providing instructions to the processing unit 1004 for execution, and it will be appreciated that a computer readable medium can include multiple computer readable media each operatively connected to the processing unit.

Embodiments of the disclosure can be described in view of the following clauses:

1. For use with a distributed computing system that performs computational processes to validate blockchain transactions at a plurality of nodes of the distributed computing system, a transaction authentication system comprising:
a transaction rule compliance engine comprising program code, implemented on the distributed computing system that interacts with a distributed ledger and one or more token contracts, for authenticating one or more requested transactions, wherein the one or more requested transactions comprise a given transaction between a sender holder address and a receiver holder address, wherein authentication of the given transaction is determined on the distributed computing system in accordance with a defined ruleset, wherein the defined ruleset comprises at least one rule governing token ownership and allowed token transactions, and wherein for each sender holder address of a set of sender holder addresses there is an associated sender and for each receiver holder address of a set of receiver holder addresses there is an associated receiver; and
a curation system, comprising one or more curation computing systems, that is configured to receive registration information for a subset of users of the distributed computing system, identify registered users and corresponding holder addresses, generate transaction authentication data associated with holder addresses of registered users, and store the transaction authentication data on the distributed ledger by submitting the transaction authentication data to the distributed ledger as one or more curation data transactions, wherein the program code of the transaction rule compliance engine includes transaction authentication logic that operates on the transaction authentication data associated with each participating registered user of the given transaction, stored on the distributed ledger, and queryable by one or more token contracts that reference the transaction rule compliance engine, to authenticate the given transaction.
2. The transaction authentication system of clause 1, wherein the transaction rule compliance engine is implemented on the distributed computing system as part of the program code residing in one or more compliance contracts.
3. The transaction authentication system of clause 1 or 2, wherein transactions are queryable by associated compliance contracts.
4. The transaction authentication system of any of clause 1-3, wherein the transaction rule compliance engine is implemented on the distributed computing system as part of program code implementing a token contract.
5. The transaction authentication system of any of clauses 1-4, wherein the given transaction between the sender holder address and the receiver holder address is a subtransaction of a larger transaction having more than one sender holder address and/or more than one receiver holder address with the larger transaction comprising a plurality of pairwise sender-receiver transactions, and wherein determining if the larger transaction is permitted includes testing each of the plurality of pairwise sender-receiver transactions to determine if they are permitted.
6. The transaction authentication system of any of clauses 1-5, wherein the transaction rule compliance engine is configured to, based on a result of the transaction authentication logic operating on the transaction authentication data, associated with each participant of the given transaction and stored on the distributed ledger, reject the given transaction or allow the given transaction.
7. The transaction authentication system of clause 6, wherein the transaction rule compliance engine is configured to, based on a rejection or allowance of the given transaction, record the rejection or allowance on the distributed ledger.
8. The transaction authentication system of clause 6 or 7, wherein the transaction authentication data comprises at least one transaction eligibility criterion for each registered user.
9. The transaction authentication system of any of clauses 1-8, wherein the transaction authentication data for each registered user comprises at least one attribute bitmask for the registered user, wherein the attribute bitmask comprises a sequence of at least one bitmap integer that characterizes, for a given registered user, according to the defined ruleset, a set of at least one categories.
10. The transaction authentication system of clause 9, wherein the sequence of at least one bitmap integer comprises at least one binary attribute bit.
11. The transaction authentication system of clause 9 or 10, wherein the set of at least one categories characterized, for the given registered user, according to the defined ruleset, by the at least one attribute bitmask, comprises a single category to which the registered user is assigned, based on one or more binary attributes derived from registration information, again according to the defined ruleset.
12. The transaction authentication system of any of clauses 9-11, wherein the set of at least one categories characterized, for the given registered user, according to the defined ruleset, by the at least one attribute bitmask, comprises a first subset of categories with which the registered user is permitted to transact, according to the defined ruleset.
13. The transaction authentication system of any of clauses 9-12, wherein the set of at least one categories characterized, for the given registered user, according to the defined ruleset, by the at least one attribute bitmask, comprises a second subset of categories with which the registered user is not permitted to transact, according to the defined ruleset.
14. The transaction authentication system of any of clauses 9-13, wherein the transaction rule compliance engine is configured to authenticate the given transaction by performing at least one bitwise logical operation between at least one attribute bitmask of a first registered user and at least one attribute bitmask of a second registered user.
15. The transaction authentication system of clause 14, wherein the attribute bitmask of the first registered user represents a first category to which the first registered user is assigned, based on one or more binary attributes derived from registration information and according to the defined ruleset, and the attribute bitmask of the second registered user characterizes, according to the defined ruleset, a second subset of categories with which the second registered user is permitted, or alternatively not permitted, to transact.
16. The transaction authentication system of clause 14 or 15, wherein the bitwise logical operation is a bitwise AND operation.
17. The transaction authentication system of clause 16, wherein the bitwise AND operation has as operands at least one attribute bitmask of the first registered user and at least two attribute bitmasks of the second registered user.
18. The transaction authentication system of clause 17, wherein a first bitwise AND operation comprises at least one bitwise Boolean AND operation between a first attribute bitmask of the first registered user and a first attribute bitmask of the second registered user to generate a first results bitmask, a second bitwise AND operation comprises at least one bitwise Boolean AND operation between a first attribute bitmask of the first registered user and a second attribute bitmask of the second registered user to generate a second results bitmask, and performing at least one bitwise Boolean operation between the first results bitmask and the second results bitmask,
wherein the first attribute bitmask of the first registered user represents a first category to which the first registered user is assigned, based on one or more binary attributes derived from registration information and according to the defined ruleset,
wherein the first attribute bitmask of the second registered user characterizes, according to the defined ruleset, a first subset of categories with which the second registered user is permitted to transact, and
wherein the second attribute bitmask of the second registered user characterizes, according to the defined ruleset, a second subset of categories with which the second registered user is not permitted to transact.
19. The transaction authentication system of any of clauses 9-18, wherein the transaction authentication data comprises at least one transaction eligibility criterion for each registered user, and wherein the transaction rule compliance engine is configured to authenticate the given transaction by performing at least one bitwise logical operation between at least one attribute bitmask of a first registered user and at least one attribute bitmask of a second registered user to generate a first result intermediate, performing at least one logical operation on at least one transaction eligibility criterion of at least on registered user to generate a second result intermediate, and performing at least one logical operation on the first result intermediate and the second result intermediate.
20. The transaction authentication system of any of clauses 9-19, wherein the transaction rule compliance engine is configured to authenticate the given transaction by performing at least one bitwise logical operation between at least one attribute bitmask of a first registered user and at least one attribute bitmask of a second registered user to generate at least one result intermediate, wherein the at least one result intermediate comprises a results bitmask organized as a sequence of one or more bitmap integers, each comprising of a sequence of one or more binary attribute bits, and wherein the transaction rule compliance engine generates a digital result by further performing at least one bitwise logical operation on each sequence of binary attribute bits within each bitmap integer of the results bitmask to generate at least one result for each bitmap integer, and then performing at least one digital operation on at least one result for each bitmap integer.
21. The transaction authentication system of any of clauses 1-20, wherein the curation system is configured to update transaction authentication data by generating new transaction authentication data and submitting a new curation data transaction to the distributed ledger.
22. The transaction authentication system of any of clauses 1-21 wherein the curation system is configured to update transaction authentication data in response to one or more user requests.
23. The transaction authentication system of any of clauses 1-22 wherein the curation system is configured to update transaction authentication data in response to changes to the defined ruleset.
24. A method of processing transactions, for use with a distributed computing system that performs computational processes to validate one or more transactions at a plurality of nodes of the distributed computing system, the method comprising:
validating a set of sender holder addresses for one or more sender of the transaction;
validating a set of receiver holder addresses for one or more receiver of the transaction;
generating transaction authentication data for each registered user of the distributed computing system in accordance with a defined ruleset and associated with validated holder addresses of the registered user, wherein the defined ruleset includes at least one rule governing token ownership and allowed token transactions;
storing the transaction authentication data in a curation data transaction on a distributed ledger of the distributed computing system; and
operating on the transaction authentication data stored on the distributed ledger with program code for transaction authentication logic stored on the distributed computing system to authenticate a requested transaction.
25. The method of clause 24, wherein the transaction authentication data is in part represented by a first blockchain executable program code sequence, wherein a plurality of token contracts are stored as part of the distributed ledger and each of some of the plurality of token contracts reference one or more compliance contracts incorporating or referencing the transaction authentication data, and wherein validating a particular token contract of the plurality of token contracts would comprise validating the one or more compliance contracts associated with the particular token contract, which would in turn comprise validating the transaction authentication data of the particular token contract.
26. The method of clause 24 or 25, wherein the transaction authentication data comprises at least one transaction eligibility criterion for each registered user.
27. The method of any of clauses 24-26, wherein the transaction authentication data comprises at least one attribute bitmask for each registered user, wherein the attribute bitmask comprises a sequence of at least one bitmap integers, each comprising at least one binary attribute bits, that characterizes, for a given registered user, according to the defined ruleset, a set of at least one categories.
28. The method of clause 27, wherein the set of at least one categories is characterized, for the given registered user, according to the defined ruleset, by the at least one attribute bitmask, comprises a single category to which the registered user is assigned, based on one or more binary attributes derived from registration information, again according to the defined ruleset.
29. The method of clause 27 and 28, wherein the set of at least one categories is characterized, for the given registered user, according to the defined ruleset, by the at least one attribute bitmask, comprises a first subset of categories with which the registered user is permitted to transact, according to the defined ruleset.
30. The method of any of clauses 27-29, wherein the set of at least one categories is characterized, for the given registered user, according to the defined ruleset, by the at least one attribute bitmask, comprises a second subset of categories with which the registered user is not permitted to transact, according to the defined ruleset.
31. The method of any of clauses 27-30, further comprising:
performing at least one bitwise Boolean AND operation between a first attribute bitmask of a first registered user and a first attribute bitmask of a second registered user to generate a first results bitmask;
performing at least one bitwise Boolean AND operation between the first attribute bitmask of the first registered user and a second attribute bitmask of the second registered user to generate a second results bitmask; and
performing at least one bitwise Boolean operation between the first results bitmask and the second results bitmask,
wherein the first attribute bitmask of the first registered user represents a first category to which the first registered user is assigned, based on one or more binary attributes derived from registration information and according to the defined ruleset,
wherein the first attribute bitmask of the second registered user characterizes, according to the defined ruleset, a first subset of categories with which the second registered user is permitted to transact, and
wherein the second attribute bitmask of the second registered user characterizes, according to the defined ruleset, a second subset of categories with which the second registered user is not permitted to transact.

According to one embodiment, the techniques described herein are implemented by one or generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

The term “storage media” as used herein can refer to any non-transitory media that store data and/or instructions that cause a machine to operation in a specific fashion. Such storage media may comprise non-volatile media and/or volatile media. Non-volatile media includes, for example, optical or magnetic disks. Volatile media includes dynamic memory.

Storage media is distinct from but may be used in conjunction with transmission media. Transmission media participates in transferring information between storage media. For example, transmission media includes coaxial cables, copper wire and fiber optics. Transmission media can also take the form of acoustic or light waves, such as those generated during radio-wave and infra-red data communications.

Various forms of media may be involved in carrying one or more sequences of one or more instructions to a processor for execution. For example, the instructions may initially be carried on a magnetic disk or solid state drive of a remote computer. The remote computer can load the instructions into its dynamic memory and send the instructions over a network connection. A network interface local to a computer system can receive the data. A bus might carry the data to a main memory, from which the processor retrieves and executes the instructions. The instructions received by the main memory may optionally be stored on a storage device either before or after execution by the processor.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

What have been described above are examples. It is, of course, not possible to describe every conceivable combination of components or methodologies, but one of ordinary skill in the art, upon reading this disclosure, should recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. For use with a distributed computing system that performs computational processes to validate blockchain transactions at a plurality of nodes of the distributed computing system, a transaction authentication system comprising:
a transaction rule compliance engine comprising program code, implemented on the distributed computing system that interacts with a distributed ledger and one or more token contracts, for authenticating one or more requested transactions, wherein the one or more requested transactions comprise a given transaction between a sender holder address and a receiver holder address, wherein authentication of the given transaction is determined on the distributed computing system in accordance with a defined ruleset, wherein the defined ruleset comprises at least one rule governing token ownership and allowed token transactions, and wherein for each sender holder address of a set of sender holder addresses there is an associated sender and for each receiver holder address of a set of receiver holder addresses there is an associated receiver; and
a curation system, comprising one or more curation computing systems, that is configured to receive registration information for a subset of users of the distributed computing system, identify registered users and corresponding holder addresses, generate transaction authentication data associated with holder addresses of registered users, and store the transaction authentication data on the distributed ledger by submitting the transaction authentication data to the distributed ledger as one or more curation data transactions,
wherein the program code of the transaction rule compliance engine includes transaction authentication logic that operates on the transaction authentication data associated with each participating registered user of the given transaction, stored on the distributed ledger, and queryable by one or more token contracts that reference the transaction rule compliance engine, to authenticate the given transaction.

2. The transaction authentication system of claim 1, wherein the transaction rule compliance engine is implemented on the distributed computing system as part of the program code residing in one or more compliance contracts.

3. The transaction authentication system of claim 1, wherein transactions are queryable by associated compliance contracts.

4. The transaction authentication system of claim 1, wherein the transaction rule compliance engine is implemented on the distributed computing system as part of program code implementing a token contract.

5. The transaction authentication system of claim 1, wherein the given transaction between the sender holder address and the receiver holder address is a subtransaction of a larger transaction having more than one sender holder address and/or more than one receiver holder address with the larger transaction comprising a plurality of pairwise sender-receiver transactions, and wherein determining if the larger transaction is permitted includes testing each of the plurality of pairwise sender-receiver transactions to determine if they are permitted.

6. The transaction authentication system of claim 1, wherein the transaction rule compliance engine is configured to, based on a result of the transaction authentication logic operating on the transaction authentication data, associated with each participant of the given transaction and stored on the distributed ledger, reject the given transaction or allow the given transaction.

7. The transaction authentication system of claim 6, wherein the transaction rule compliance engine is configured to, based on a rejection or allowance of the given transaction, record the rejection or allowance on the distributed ledger.

8. The transaction authentication system of claim 6, wherein the transaction authentication data comprises at least one transaction eligibility criterion for each registered user.

9. The transaction authentication system of claim 1, wherein the transaction authentication data for each registered user comprises at least one attribute bitmask for the registered user, wherein the attribute bitmask comprises a sequence of at least one bitmap integer that characterizes, for a given registered user, according to the defined ruleset, a set of at least one categories.

10. The transaction authentication system of claim 9, wherein the sequence of at least one bitmap integer comprises at least one binary attribute bit.

11. The transaction authentication system of claim 9, wherein the set of at least one categories characterized, for the given registered user, according to the defined ruleset, by the at least one attribute bitmask, comprises a single category to which the registered user is assigned, based on one or more binary attributes derived from registration information, again according to the defined ruleset.

12. The transaction authentication system of claim 9, wherein the set of at least one categories characterized, for the given registered user, according to the defined ruleset, by the at least one attribute bitmask, comprises a first subset of categories with which the registered user is permitted to transact, according to the defined ruleset.

13. The transaction authentication system of claim 9, wherein the set of at least one categories characterized, for the given registered user, according to the defined ruleset, by the at least one attribute bitmask, comprises a second subset of categories with which the registered user is not permitted to transact, according to the defined ruleset.

14. The transaction authentication system of claim 9, wherein the transaction rule compliance engine is configured to authenticate the given transaction by performing at least one bitwise logical operation between at least one attribute bitmask of a first registered user and at least one attribute bitmask of a second registered user.

15. The transaction authentication system of claim 14, wherein the attribute bitmask of the first registered user represents a first category to which the first registered user is assigned, based on one or more binary attributes derived from registration information and according to the defined ruleset, and the attribute bitmask of the second registered user characterizes, according to the defined ruleset, a second subset of categories with which the second registered user is permitted, or alternatively not permitted, to transact.

16. The transaction authentication system of claim 14, wherein the bitwise logical operation is a bitwise AND operation.

17. The transaction authentication system of claim 16, wherein the bitwise AND operation has as operands at least one attribute bitmask of the first registered user and at least two attribute bitmasks of the second registered user.

18. The transaction authentication system of claim 17, wherein a first bitwise AND operation comprises at least one bitwise Boolean AND operation between a first attribute bitmask of the first registered user and a first attribute bitmask of the second registered user to generate a first results bitmask, a second bitwise AND operation comprises at least one bitwise Boolean AND operation between a first attribute bitmask of the first registered user and a second attribute bitmask of the second registered user to generate a second results bitmask, and performing at least one bitwise Boolean operation between the first results bitmask and the second results bitmask,
wherein the first attribute bitmask of the first registered user represents a first category to which the first registered user is assigned, based on one or more binary attributes derived from registration information and according to the defined ruleset,
wherein the first attribute bitmask of the second registered user characterizes, according to the defined ruleset, a first subset of categories with which the second registered user is permitted to transact, and
wherein the second attribute bitmask of the second registered user characterizes, according to the defined ruleset, a second subset of categories with which the second registered user is not permitted to transact.

19. The transaction authentication system of claim 9, wherein the transaction authentication data comprises at least one transaction eligibility criterion for each registered user, and wherein the transaction rule compliance engine is configured to authenticate the given transaction by performing at least one bitwise logical operation between at least one attribute bitmask of a first registered user and at least one attribute bitmask of a second registered user to generate a first result intermediate, performing at least one logical operation on at least one transaction eligibility criterion of at least on registered user to generate a second result intermediate, and performing at least one logical operation on the first result intermediate and the second result intermediate.

20. The transaction authentication system of claim 9, wherein the transaction rule compliance engine is configured to authenticate the given transaction by performing at least one bitwise logical operation between at least one attribute bitmask of a first registered user and at least one attribute bitmask of a second registered user to generate at least one result intermediate, wherein the at least one result intermediate comprises a results bitmask organized as a sequence of one or more bitmap integers, each comprising of a sequence of one or more binary attribute bits, and wherein the transaction rule compliance engine generates a digital result by further performing at least one bitwise logical operation on each sequence of binary attribute bits within each bitmap integer of the results bitmask to generate at least one result for each bitmap integer, and then performing at least one digital operation on at least one result for each bitmap integer.

21. The transaction authentication system of claim 1, wherein the curation system is configured to update transaction authentication data by generating new transaction authentication data and submitting a new curation data transaction to the distributed ledger.

22. The transaction authentication system of claim 1 wherein the curation system is configured to update transaction authentication data in response to one or more user requests.

23. The transaction authentication system of claim 1 wherein the curation system is configured to update transaction authentication data in response to changes to the defined ruleset.

24. A method of processing transactions, for use with a distributed computing system that performs computational processes to validate one or more transactions at a plurality of nodes of the distributed computing system, the method comprising:
validating a set of sender holder addresses for one or more sender of the transaction;
validating a set of receiver holder addresses for one or more receiver of the transaction;
generating transaction authentication data for each registered user of the distributed computing system in accordance with a defined ruleset and associated with validated holder addresses of the registered user, wherein the defined ruleset includes at least one rule governing token ownership and allowed token transactions;
storing the transaction authentication data in a curation data transaction on a distributed ledger of the distributed computing system; and
operating on the transaction authentication data stored on the distributed ledger with program code for transaction authentication logic stored on the distributed computing system to authenticate a requested transaction.

25. The method of claim 24, wherein the transaction authentication data is in part represented by a first blockchain executable program code sequence, wherein a plurality of token contracts are stored as part of the distributed ledger and each of some of the plurality of token contracts reference one or more compliance contracts incorporating or referencing the transaction authentication data, and wherein validating a particular token contract of the plurality of token contracts would comprise validating the one or more compliance contracts associated with the particular token contract, which would in turn comprise validating the transaction authentication data of the particular token contract.

26. The method of claim 24, wherein the transaction authentication data comprises at least one transaction eligibility criterion for each registered user.

27. The method of claim 24, wherein the transaction authentication data comprises at least one attribute bitmask for each registered user, wherein the attribute bitmask comprises a sequence of at least one bitmap integers, each comprising at least one binary attribute bits, that characterizes, for a given registered user, according to the defined ruleset, a set of at least one categories.

28. The method of claim 27, wherein the set of at least one categories is characterized, for the given registered user, according to the defined ruleset, by the at least one attribute bitmask, comprises a single category to which the registered user is assigned, based on one or more binary attributes derived from registration information, again according to the defined ruleset.

29. The method of claim 27, wherein the set of at least one categories is characterized, for the given registered user, according to the defined ruleset, by the at least one attribute bitmask, comprises a first subset of categories with which the registered user is permitted to transact, according to the defined ruleset.

30. The method of claim 27, wherein the set of at least one categories is characterized, for the given registered user, according to the defined ruleset, by the at least one attribute bitmask, comprises a second subset of categories with which the registered user is not permitted to transact, according to the defined ruleset.

31. The method of claim 27, further comprising:
performing at least one bitwise Boolean AND operation between a first attribute bitmask of a first registered user and a first attribute bitmask of a second registered user to generate a first results bitmask;
performing at least one bitwise Boolean AND operation between the first attribute bitmask of the first registered user and a second attribute bitmask of the second registered user to generate a second results bitmask; and
performing at least one bitwise Boolean operation between the first results bitmask and the second results bitmask,
wherein the first attribute bitmask of the first registered user represents a first category to which the first registered user is assigned, based on one or more binary attributes derived from registration information and according to the defined ruleset,
wherein the first attribute bitmask of the second registered user characterizes, according to the defined ruleset, a first subset of categories with which the second registered user is permitted to transact, and
wherein the second attribute bitmask of the second registered user characterizes, according to the defined ruleset, a second subset of categories with which the second registered user is not permitted to transact.
